(19) United States
(12) Patent Application Publication
(10) Pub. No.: US 2017/0037315 A1
(43) Pub. Date: Feb. 9, 2017

(54) LIQUID-CRYSTALLINE MEDIUM

(71) Applicant: Merck Patent GmbH, Darmstadt (DE)

(72) Inventors: Harald HIRSCHMANN, Darmstadt (DE); Michael WITTEK, Erzhausen (DE); Renate SEEGER, Riedstadt (DE); Brigitte SCHULER, Grossostheim (DE); Martina WINDHORST, Muenster (DE); Christian HOCK, Mainaschaff (DE); Volker REIFFENRATH, Rossdorf (DE)

(73) Assignee: Merck Patent GmbH, Darmstadt (DE)

(21) Appl. No.: 15/229,656

(22) Filed: Aug. 5, 2016

(30) Foreign Application Priority Data
Aug. 7, 2015 (DE) 102015010197.8

(51) Int. Cl. C09K 19/34; G02B 27/22; G02F 1/137; C09K 19/30; C09K 19/54

(52) U.S. Cl. CPC C09K 19/3402; C09K 19/3066; C09K 19/54; C09K 19/542; G02F 1/137; G02B 27/2264; C09K 2019/3422; C09K 2019/548

(57) ABSTRACT

The present invention relates to a liquid-crystalline medium (LC medium), to the use thereof for electrooptical purposes and to LC displays comprising this medium.

The present invention relates to a liquid-crystalline medium (LC medium), to the use thereof for electrooptical purposes and to LC displays comprising this medium.

Liquid crystals are used particularly as dielectrics in display devices, since the optical properties of such substances can be affected by an applied voltage. Electrooptical devices based on liquid crystals are very familiar to the person skilled in the art and can be based on various effects. Devices of this kind are, for example, cells with dynamic scattering, DAP cells (deformation-aligned phases), guest/host cells, TN cells with twisted nematic structure, STN cells (“super-twisted nematic”), SBE cells (“superbirefringence effect”) and OMI cells (“optical mode interference”). The most commonly used display devices are based on the Schadt-Helfrich effect and have a twisted nematic structure.

The liquid-crystal materials must have good chemical and thermal stability and good stability with respect to electrical fields and electromagnetic radiation. Moreover, the liquid-crystal materials should have relatively low viscosity and give rise to short response times, low threshold voltages and high contrast in the cells.

In addition, at standard operating temperatures, i.e. in a very broad window below and above room temperature, the liquid-crystal materials should have a suitable mesophase, for example a nematic or cholesteric mesophase for the abovementioned cells. Since liquid crystals are generally employed in the form of mixtures of several components, it is important that the components have good miscibility with one another. Further properties, such as electrical conductivity, dielectric anisotropy and optical anisotropy, have to meet different requirements according to the cell type and field of use. For example, materials for cells with a twisted nematic structure were to have positive dielectric anisotropy and low electrical conductivity.

For example, for matrix liquid-crystal displays with integrated non-linear elements for switching of individual pixels (MLC displays), media with high positive dielectric anisotropy, broad nematic phases, relatively low birefringence, very high specific resistivity, good UV and thermal stability and low vapor pressure are desired.

Matrix liquid-crystal displays of this kind are known. Non-linear elements used for individual switching of the individual pixels may, for example, be active elements (i.e. transistors). In that case, reference is made to an “active matrix”, in which case a distinction can be made between two types:
1. MOS (metal oxide semiconductor) or other diodes on silicon wafer as substrate.
2. Thin-film transistors (TFTs) on a glass plate as substrate.

The use of single-crystalline silicon as substrate material restricts the display size, since the modular composition of different sub-displays at the joints also leads to problems.

In the more promising type 2, which is preferred, the electrooptical effect used is typically the TN effect. A distinction is made between two technologies: TFTs made from compound semiconductors, for example CdSe, or TFTs based on polycrystalline or amorphous silicon. The latter technology is the subject of high-intensity global research.

The TFT matrix has been applied to the inside of one glass plate of the display, while the other glass plate bears the transparent counterelectrode on its inside. Compared to the size of the pixel electrode, the TFT is very small and effectively does not disrupt the image. This technology can also be extended for full color-capable image displays, wherein a mosaic of red, green and blue filters is arranged such that one filter element is opposite each switchable image element.

The TFT displays typically work as TN cells with crossed polarizers in transmission and are backlit.

The term “MLC displays” here encompasses any matrix display having integrated non-linear elements, i.e. having not only the active matrix but also displays with passive elements such as varistors or diodes (MIM=metal-insulator-metal).

MLC displays of this kind are especially suitable for TV applications (e.g. pocket televisions) or for displays with a high information content for computer applications (laptops) and in automobile or aircraft construction. As well as problems with regard to the angle dependence of contrast and the switching times, difficulties arise in the case of MLC displays that are caused by insufficiently high specific resistivity of liquid-crystal mixtures [TOGASHI, S., SEKIGUCHI, K., TANABE, H., YAMAMOTO, E., SORIMACHI, K., TAJIMA, E., WATANABE, H., SHIMIZU, H., Proc. Eurodisplay 84, September 1984: A 210-288 Matrix LCD Controlled by Double Stage Diode Rings, p. 141 ff, Paris; STROMER, M., Proc. Eurodisplay 84, September 1984: Design of Thin Film Transistors for Matrix Addressing of Television Liquid Crystal Displays, p. 145 ff, Paris]. With decreasing resistivity, there is a deterioration in the contrast of an MLC display, and the problem of “after-image elimination” can occur. Since the specific resistivity of the liquid-crystal mixture generally decreases through interaction with the inner surfaces of the display over the lifetime of an MLC display, a high (initial) resistivity is very important in order to obtain acceptable service lives. Especially in the case of low-voltage mixtures, it has not been possible to date to achieve very high specific resistivities. In addition, it is important that the specific resistivity shows a minimum increase with rising temperature and after thermal stress and/or UV exposure. Another particular disadvantage is the low-temperature properties of the mixtures from the prior art. What is required is that no crystallization and/or smectic phases occur even at low temperatures, and the temperature dependence of the viscosity is at a minimum. The MLC displays from the prior art thus do not meet current demands.

As well as liquid-crystal displays which use backlighting, i.e. are operated in a transmissive and possibly transflective manner, reflective liquid-crystal displays are also of particular interest. These reflective liquid-crystal displays use ambient light to present information. Thus, they consume significantly less energy than backlit liquid-crystal displays with corresponding size and resolution. Since the TN effect is characterized by very good contrast, reflective displays of this kind still have very good readability even under bright ambient conditions. This is already known from simple reflective TN displays as used, for example, in wristwatches and pocket calculators. However, the principle can also be applied to high-quality, higher-resolution, active matrix-driven displays, for example TFT displays. Here, as is already the case for the generally standard transmissive TFT-TN displays, the use of liquid crystals having a low birefringence (Δn) is necessary in order to achieve low optical retardation (d·Δn). This low optical retardation leads to a usually acceptable low viewing angle dependence of contrast (cf. DE 30 22 818). In reflective displays, the use of liquid crystals having low birefringence is even more important than in transmissive displays, since the effective layer thickness that the light traverses in reflective displays is about twice as high as in transmissive displays having the same layer thickness.

For realization of 3D effects by means of shutter glasses, fast-switching mixtures having low rotational viscosities and a correspondingly high optical anisotropy (Δn) in particular are used. Electrooptical lens systems with which a 2-dimensional representation of a display can be switched into a 3-dimensional autostereoscopic representation can be achieved using mixtures having high optical anisotropy (Δn).

There is thus still a great need for MLC displays having very high specific resistivity with a simultaneously large working temperature range, short switching times even at low temperatures, and low threshold voltage, which exhibit these disadvantages only to a lesser degree, if at all.

In the case of TN (Schadt-Helfrich) cells, media are desirable that enable the following advantages in the cells:
extended nematic phase range (especially at low temperatures)
switchability at extremely low temperatures (outdoor use, automobile, avionics)
elevated resistance to UV radiation (longer lifetime)
low threshold voltage.

With the media available from the prior art, it is not possible to achieve these advantages while simultaneously maintaining the other parameters. Modern flat LCD screens require ever faster switching times in order to be able to realistically represent multimedia content, for example films and video games. This in turn requires nematic liquid-crystal mixtures having a very low rotational viscosity γ₁ with a high optical anisotropy Δn. In order to obtain the rotational viscosities required, substances are being sought that have a particularly advantageous γ₁/clearing point ratio coupled with simultaneously high Δn with high polarity.

In the case of more highly twisted cells (STNs), media are desired that enable higher multiplexability and/or lower threshold voltages and/or broader nematic phase ranges (especially at low temperatures). For this purpose, a further extension in the parameter space available (clearing point, smectic-nematic transition, or melting point, viscosity, dielectric parameters, elastic parameters) is urgently desired.

Especially in the case of LC displays for TV and video applications (e.g. LCD TVs, monitors, PDAs, notebooks, games consoles), a distinct reduction in switching times is desired. This requires LC mixtures having low rotational viscosities and high dielectric anisotropies. At the same time, the LC media should have high clearing points.

The problem on which the invention is based is that of providing media, especially for MLC, TN, PS-TN, STN, ECB (electrically controlled birefringence), OCB (optically compensated bend), IPS (in-plane switching), PS-IPS, FFS (fringe field switching), PS-FFS or positive-VA displays, which exhibit the above-specified disadvantages only to a lesser degree, if at all, and preferably have fast switching times and low rotational viscosities with a simultaneously high clearing point, and a high dielectric anisotropy and a low threshold voltage.

It has now been found that this problem can be solved when LC media as described hereinafter are used.

The invention provides a liquid-crystalline medium, characterized in that it comprises

one or more compounds of the formula 1

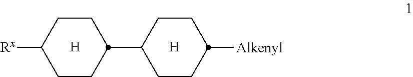

and one or more compounds of the formula 2

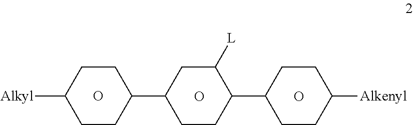

and one or more compounds selected from formulae 3, 4 and 5

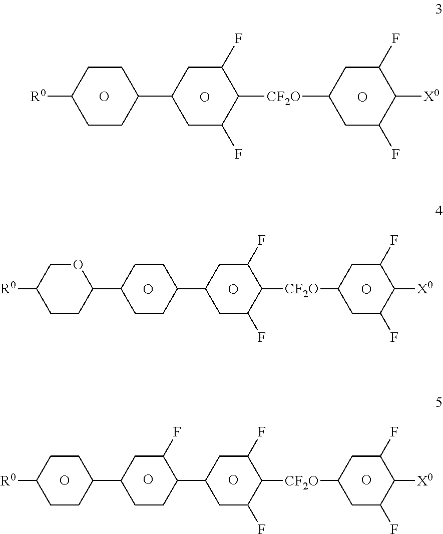

and one or more compounds selected from formulae 6 and 7

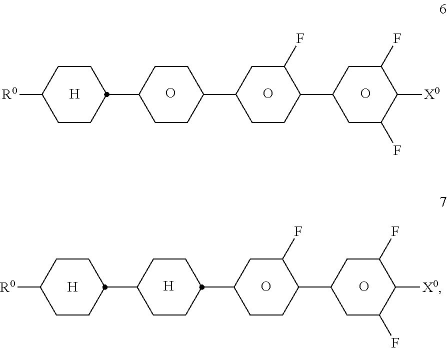

in which the individual radicals are the same or different at each instance and are each independently defined as follows:
“Alkenyl” is alkenyl having 2 to 6 carbon atoms,
R^{x} is alkyl having 1 to 6 carbon atoms or alkenyl having 2 to 6 carbon atoms,
“Alkyl” is alkyl having 1 to 6 carbon atoms,
L is H or F, preferably F,
R⁰ is unsubstituted or halogenated alkyl or alkoxy having 1 to 15 carbon atoms, where one or more CH₂ groups in these radicals may each independently also be replaced by —C≡C—, —CF₂O—, —CH═CH—,

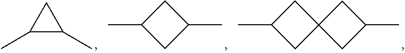

—O—, —CO—O— or —O—CO—, such that no oxygen atoms are bonded directly to one another,
X⁰ is F, Cl, halogenated alkyl, halogenated alkoxy, halogenated alkenyl or halogenated alkenyloxy each having up to 6 carbon atoms.

It has been found that, surprisingly, LC media comprising one or more compounds of the formulae 1 to 7 have a high dielectric anisotropy Δ∈, a high birefringence Δn and simultaneously a low rotational viscosity γ₁. They are therefore particularly suitable for realization of liquid-crystal mixtures having low γ₁ and high Δn. Furthermore, the compounds of the formulae 1 to 7 have a good solubility and very good phase characteristics in LC media.

Inventive LC media comprising compounds of the formulae 1 to 7 have a low rotational viscosity, fast switching times, a high clearing point, a very high positive dielectric anisotropy, a relatively high birefringence and a broad nematic phase range. They are therefore of particularly good suitability for mobile phones and TV and video applications.

The compounds of the formulae 1 to 7 have a broad range of use. Depending on the selection of the substituents, they may serve as base materials of which liquid-crystalline media are predominantly composed, but it is also possible to add liquid-crystalline base materials from other compound classes to the compounds of the formulae 1 to 7, in order, for example, to influence the dielectric and/or optical anisotropy of such a dielectric and/or to optimize the threshold voltage and/or viscosity thereof.

The compounds of the formulae 1 to 7 have relatively low melting points, exhibit good phase characteristics, are colorless in the pure state and form liquid-crystalline mesophases within a favorable temperature range for electrooptical use. They are stable chemically, thermally and towards light.

In the formulae above and below, an alkyl radical or alkoxy radical may be straight-chain or branched. It is preferably straight-chain, has 2, 3, 4, 5, 6 or 7 carbon atoms and is accordingly preferably ethyl, propyl, butyl, pentyl, hexyl, heptyl, ethoxy, propoxy, butoxy, pentoxy, hexoxy or heptoxy, and additionally methyl, octyl, nonyl, decyl, undecyl, dodecyl, tridecyl, tetradecyl, pentadecyl, methoxy, octoxy, nonoxy, decoxy, undecoxy, dodecoxy, tridecoxy or tetradecoxy.

Oxaalkyl is preferably straight-chain 2-oxapropyl (=methoxymethyl), 2- (=ethoxymethyl) or 3-oxabutyl (=2-methoxyethyl), 2-, 3- or 4-oxapentyl, 2-, 3-, 4- or 5-oxahexyl, 2-, 3-, 4-, 5- or 6-oxaheptyl, 2-, 3-, 4-, 5-, 6- or 7-oxaoctyl, 2-, 3-, 4-, 5-, 6-, 7- or 8-oxanonyl, 2-, 3-, 4-, 5-, 6-, 7-, 8- or 9-oxadecyl.

Δn alkenyl radical may be straight-chain or branched. It is preferably straight-chain and has 2 to 10 carbon atoms. It is accordingly preferably vinyl, prop-1- or prop-2-enyl, but-1-, 2- or but-3-enyl, pent-1-, 2-, 3- or pent-4-enyl, hex-1-, 2-, 3-, 4- or hex-5-enyl, hept-1-, 2-, 3-, 4-, 5- or hept-6-enyl, oct-1-, 2-, 3-, 4-, 5-, 6- or oct-7-enyl, non-1-, 2-, 3-, 4-, 5-, 6-, 7- or non-8-enyl, dec-1-, 2-, 3-, 4-, 5-, 6-, 7-, 8- or dec-9-enyl.

If an alkyl or alkenyl radical is at least monosubstituted by halogen, this radical is preferably straight-chain, and halogen is preferably F or Cl. In the case of polysubstitution, halogen is preferably F. The resulting radicals also include perfluorinated radicals. In the case of monosubstitution, the fluorine or chlorine substituent may be in any position, but is preferably in the co position.

In the formulae above and below, X⁰ is preferably F, Cl or a mono- or polyfluorinated alkyl or alkoxy radical having 1, 2 or 3 carbon atoms or a mono- or polyfluorinated alkenyl radical having 2 or 3 carbon atoms. X⁰ is more preferably F, Cl, CF₃, CHF₂, OCF₃, OCHF₂, OCFHCF₃, OCFHCHF₂, OCFHCHF₂, OCF₂CH₃, OCF₂CHF₂, OCF₂CHF₂, OCF₂CF₂CHF₂, OCF₂CF₂CHF₂, OCFHCF₂CF₃, OCFHCF₂CHF₂, OCF₂CF₂CF₃, OCF₂CF₂CClF₂, OCClFCF₂CF₃, OCH═CF₂ or CH═CF₂, most preferably F or OCF₃, and also CF₃, OCF═CF₂, OCHF₂ and OCH═CF₂.

Particular preference is given to compounds of the formula 1 in which “Alkenyl” is vinyl, prop-1-enyl, prop-2-enyl or but-3-enyl.

Preference is further given to compounds of the formula 1 in which R^{x} is methyl, ethyl, n-propyl, n-butyl or n-pentyl.

Particular preference is given to compounds of the formula 2 in which L is F.

Preference is further given to compounds of the formula 2 in which “Alkyl” is methyl, ethyl, n-propyl, n-butyl or n-pentyl.

Preference is further given to compounds of the formula 2 in which “Alkenyl” is vinyl, prop-1-enyl, prop-2-enyl or but-3-enyl, more preferably but-3-enyl.

Particular preference is given to compounds of the formulae 3, 4, 5, 6 and 7 in which X⁰ is F or OCF₃, preferably F.

Preference is further given to compounds of the formulae 6 and 7 in which X⁰ is OCF₃.

Preference is further given to compounds of the formulae 3, 4, 5, 6 and 7 in which R⁰ is methyl, ethyl, n-propyl, n-butyl or n-pentyl.

The compounds of the formula 1 are preferably selected from the following formulae:

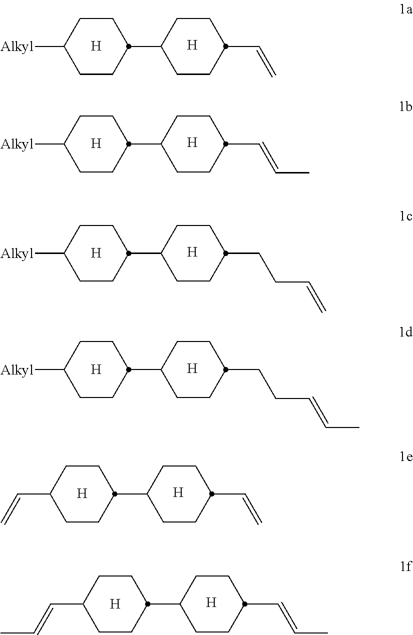

in which “Alkyl” has the definition given in formula 1 and is more preferably methyl, ethyl, n-propyl, n-butyl or n-pentyl.

Particular preference is given to compounds of the formula 1a and 1b, especially those in which “Alkyl” is n-propyl.

The compounds of the formula 2 are preferably selected from the following formulae:

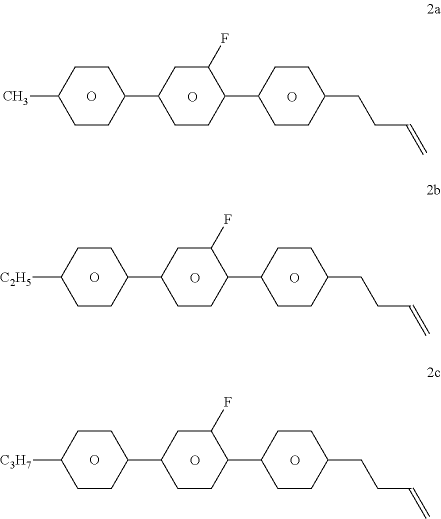

Particular preference is given to compounds of the formula 2b.

The compounds of the formula 3 are preferably selected from the following formulae:

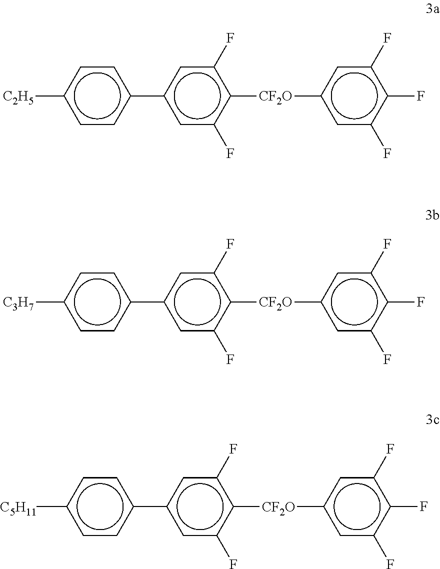

Particular preference is given to compounds of the formulae 3a and 3b.

The compounds of the formula 4 are preferably selected from the following formulae:

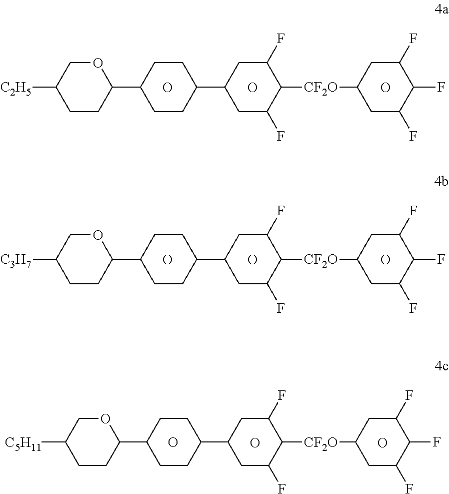

Particular preference is given to compounds of the formulae 4a and 4b.

The compounds of the formula 5 are preferably selected from the following formulae:

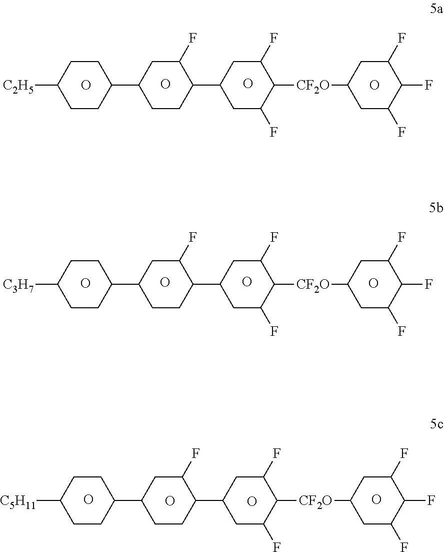

Particular preference is given to compounds of the formulae 5a and 5b.

The compounds of the formula 6 are preferably selected from the following formulae:

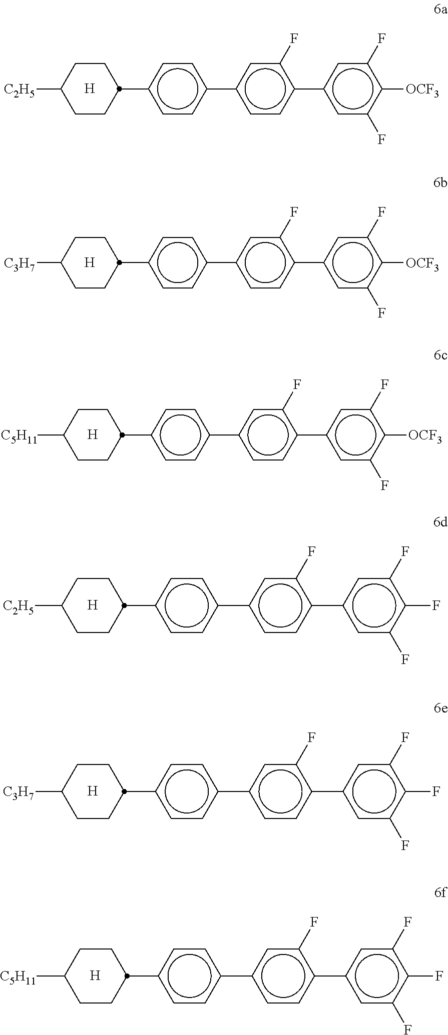

Particular preference is given to compounds of the formulae 6a and 6b, and compounds of the formulae 6e and 6f.

The compounds of the formula 7 are preferably selected from the following formulae:

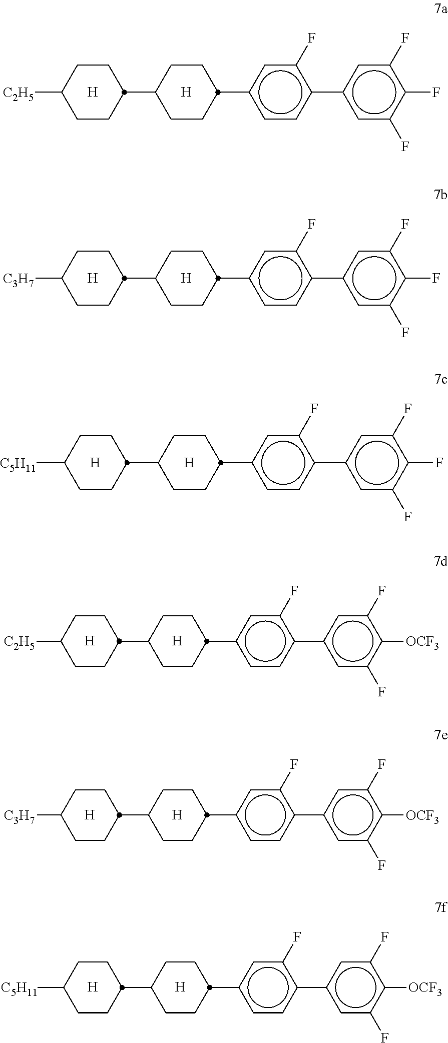

Particular preference is given to compounds of the formulae 7a and 7b, and compounds of the formulae 7e and 7f.

Particularly preferred media are described hereinafter.

Medium comprising one or more compounds each of the formulae 1, 2 and 3 and one or more compounds selected from formulae 6 and 7.

Medium comprising one or more compounds each of the formulae 1, 2 and 4 and one or more compounds selected from formulae 6 and 7.

Medium comprising one or more compounds each of the formulae 1, 2 and 5 and one or more compounds selected from formulae 6 and 7.

Medium comprising one or more compounds each of the formulae 1, 2, 3 and 4 and one or more compounds selected from formulae 6 and 7.

Medium comprising one or more compounds each of the formulae 1, 2, 3 and 5 and one or more compounds selected from formulae 6 and 7.

Medium comprising one or more compounds each of the formulae 1, 2, 4 and 5 and one or more compounds selected from formulae 6 and 7.

Medium comprising one or more compounds each of the formulae 1, 2 and 6 and one or more compounds selected from formulae 3, 4 and 5.

Medium comprising one or more compounds each of the formulae 1, 2 and 7 and one or more compounds selected from formulae 3, 4 and 5.

Medium comprising one or more compounds each of the formulae 1, 2, 3 and 6.

Medium comprising one or more compounds each of the formulae 1, 2, 4 and 6.

Medium comprising one or more compounds each of the formulae 1, 2, 5 and 6.

Medium comprising one or more compounds each of the formulae 1, 2, 3 and 7.

Medium comprising one or more compounds each of the formulae 1, 2, 4 and 7.

Medium comprising one or more compounds each of the formulae 1, 2, 5 and 7.

Medium comprising one or more compounds each of the formulae 1, 2, 3, 4 and 6.

Medium comprising one or more compounds each of the formulae 1, 2, 3, 4 and 7.

Medium comprising one or more compounds each of the formulae 1, 2, 3, 5 and 6.

Medium comprising one or more compounds each of the formulae 1, 2, 3, 5 and 7.

The proportion of compounds of the formula 1 in the overall mixture is preferably 20% to 65% by weight, more preferably 25% to 60% by weight.

The proportion of compounds of the formula 2 in the overall mixture is preferably 2% to 15% by weight, more preferably 3% to 10% by weight.

The proportion of compounds of the formula 3 in the overall mixture is preferably 2% to 30% by weight, more preferably 3% to 20% by weight.

The proportion of compounds of the formula 4 in the overall mixture is preferably 2% to 25% by weight, more preferably 3% to 15% by weight.

The proportion of compounds of the formula 5 in the overall mixture is preferably 2% to 20% by weight, more preferably 3% to 15% by weight.

The proportion of compounds of the formulae 3, 4 and 5 in the overall mixture is preferably 5% to 30% by weight, more preferably 5% to 25% by weight.

The proportion of compounds of the formula 6 in the overall mixture is preferably 2% to 20% by weight, more preferably 2% to 15% by weight.

The proportion of compounds of the formula 7 in the overall mixture is preferably 2% to 20% by weight, more preferably 2% to 15% by weight.

The proportion of compounds of the formulae 6 and 7 in the overall mixture is preferably 2% to 20% by weight, more preferably 2% to 15% by weight.

Particular preference is given to media comprising
20% to 65% by weight of one or more compounds of the formula 1, preferably selected from the formulae 1a and 1b, and
2% to 15% by weight of one or more compounds of the formula 2, preferably selected from the formulae 2a, 2b and 2c, and
5% to 30% by weight of one or more compounds selected from the formulae 3, 4 and 5, preferably selected from the formulae 3a, 3b, 4a, 4b, 5a and 5b, and
2% to 20% by weight of one or more compounds selected from the formulae 6 and 7, preferably selected from the formulae 6a, 6b, 7a and 7b.

The compounds of the formulae 1 to 7 are prepared by methods known per se, as described in the literature (for example in the standard works such as Houben-Weyl, Methoden der Organischen Chemie [Methods of Organic Chemistry], Georg-Thieme-Verlag, Stuttgart), under the reaction conditions which are known and suitable for the reactions mentioned. It is also possible to make use of variants that are known per se but are not mentioned in detail here.

Preferred embodiments of the mixtures according to the invention are specified hereinafter:
The medium additionally comprises one or more compounds other than the formulae 1 to 7 that are of the formula II and/or III

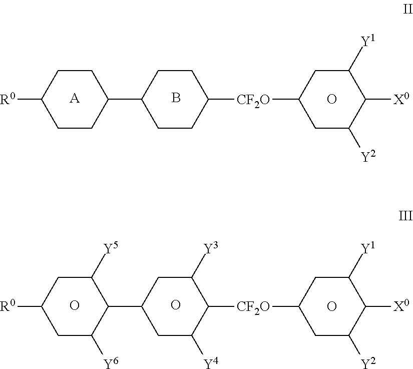

in which R⁰ and X⁰ have the definition given in formula 3,
Y¹ to Y⁶ are each independently H or F

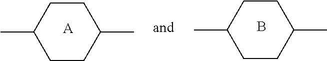

are each independently

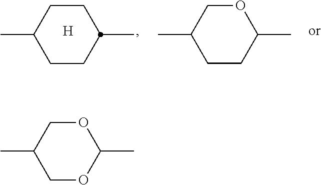

and with exclusion of the compounds of the formula 3 from the compounds of the formula III.
The compounds of the formula II are preferably selected from the following formulae:

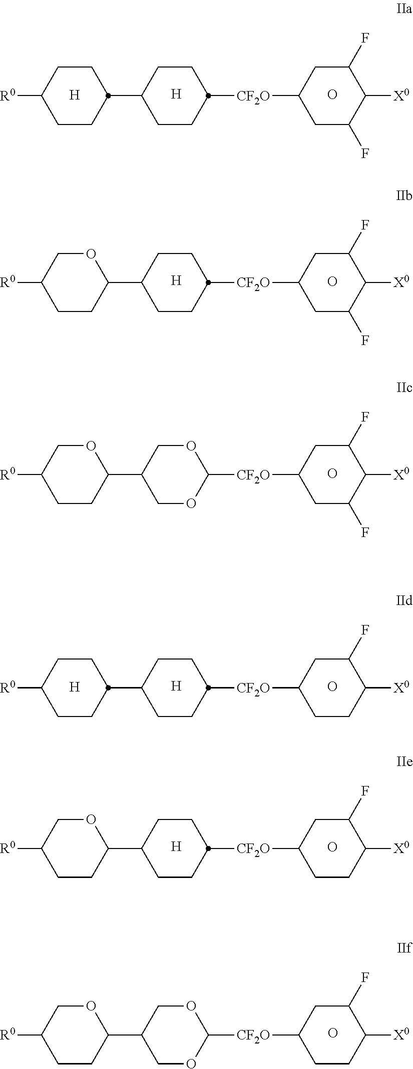

in which R⁰ and X⁰ have the definitions given above.
Preferably, R⁰ is alkyl having 1 to 6 carbon atoms. X⁰ is preferably F. Particular preference is given to compounds of the formula IIa and IIb, especially compounds of the formulae IIa and IIb in which X⁰ is F.
The compounds of the formula III are preferably selected from the following formulae:

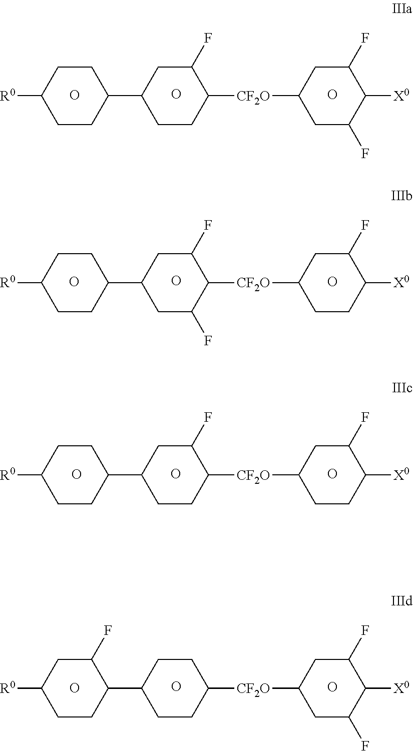

in which R⁰ and X⁰ have the definitions given above.
Preferably, R⁰ is alkyl having 1 to 6 carbon atoms. X⁰ is preferably F. Particular preference is given to compounds of the formula IIId;
The medium additionally comprises one or more compounds other than the formulae 1 to 7 that are selected from the following formulae:

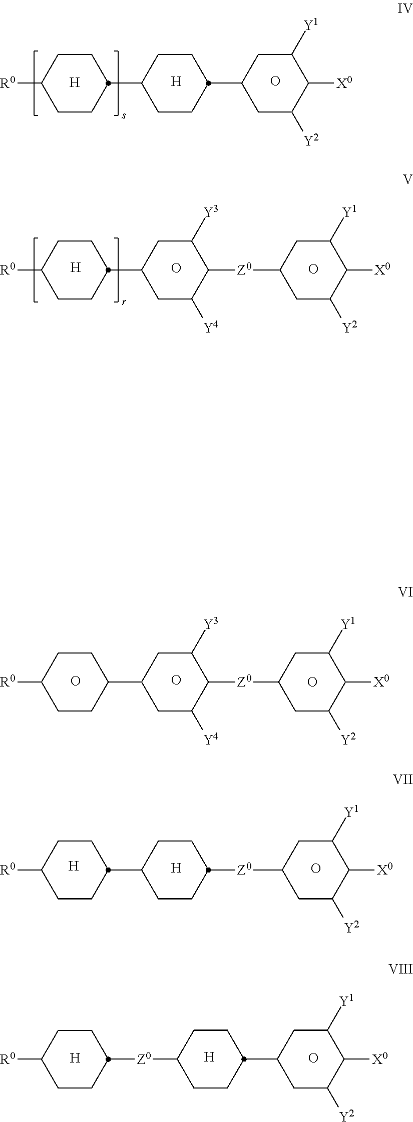

in which R⁰, X⁰ and Y¹ to Y⁴ have the definitions given above in formulae II and III, and
Z⁰ is —C₂H₄—, —(CH₂)₄—, —CH═CH—, —CF═CF—, —C₂F₄—, —CH₂CF₂—, —CF₂CH₂—, —CH₂O—, —OCH₂—, —COO— or —OCF₂—, and in formulae V and VI a single bond as well, and in formulae V and VIII —CF₂O— as well,
r is 0 or 1, and
s is 0 or 1;
The compounds of the formula IV are preferably selected from the following formulae:

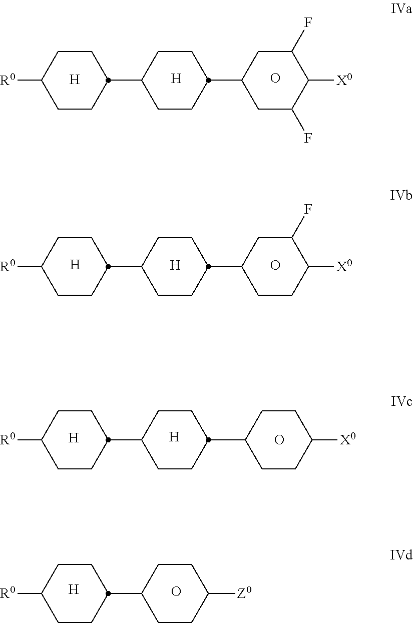

in which R⁰ and X⁰ have the definitions given above under formulae II and III.
Preferably, R⁰ is alkyl having 1 to 6 carbon atoms. X⁰ is preferably F or OCF₃, or else OCF═CF₂, CF₃ and Cl;
The compounds of the formula V are preferably selected from the following formulae:

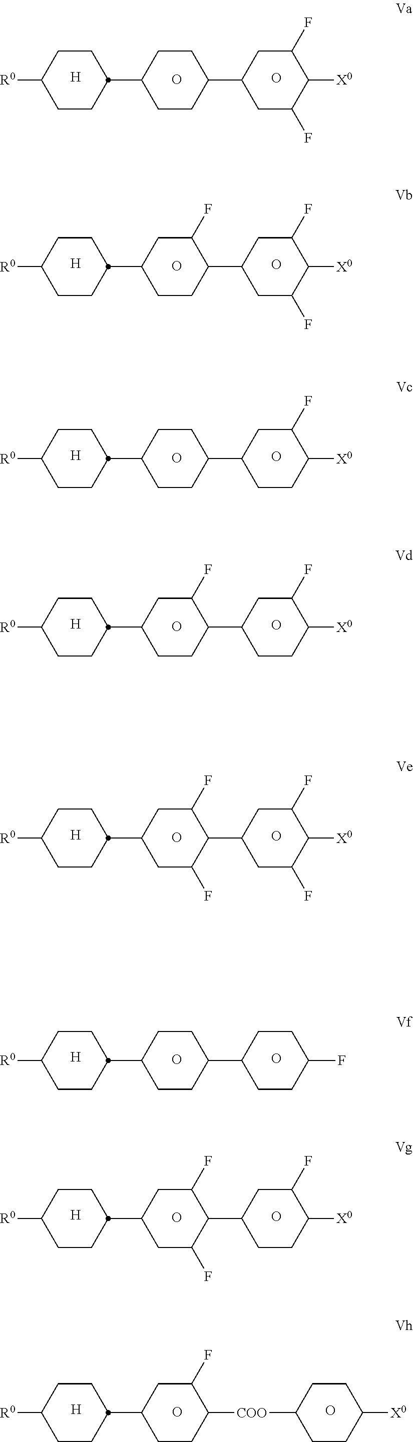

in which R⁰ and X⁰ have the definitions given above.
Preferably, R⁰ is alkyl having 1 to 6 carbon atoms. X⁰ is preferably F and OCF₃, or else OCHF₂, CF₃, OCF═CF₂ and OCH═CF₂;
The compounds of the formula VI are preferably selected from the following formulae:

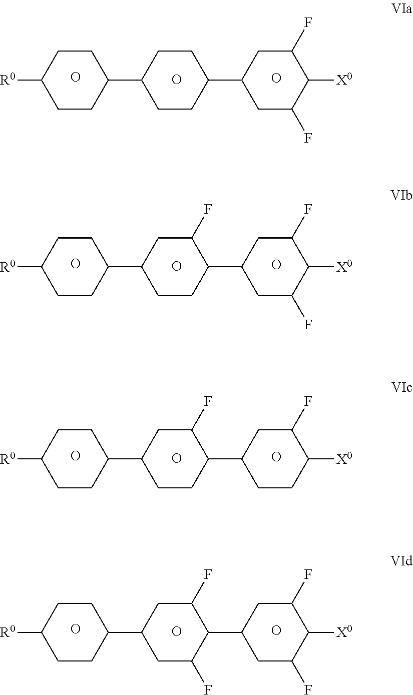

in which R⁰ and X⁰ have the definitions given above.
Preferably, R⁰ is alkyl having 1 to 6 carbon atoms. X⁰ is preferably F, or else OCF₃, CF₃, CF═CF₂, OCHF₂ and OCH═CF₂.
The compounds of the formula VII are preferably selected from the following formulae:

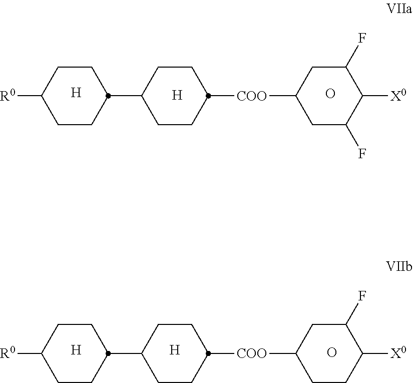

in which R⁰ and X⁰ have the definitions given above.
Preferably, R⁰ is alkyl having 1 to 6 carbon atoms. X⁰ is preferably F, or else OCF₃, CF₃, OCHF₂ and OCH═CF₂.
The medium additionally comprises one or more compounds other than the formulae 1 to 7 that are selected from the following formulae:

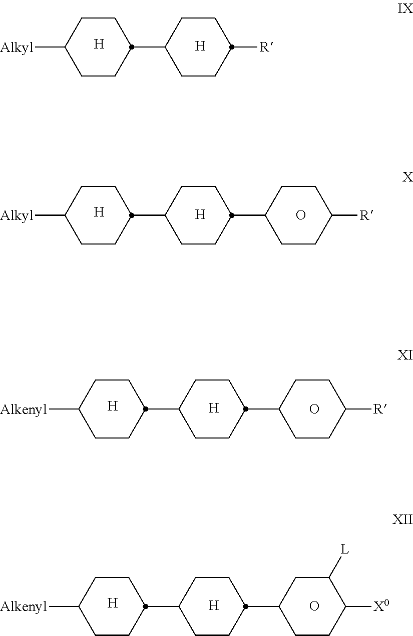

in which X⁰ has the definitions given above, and
L is H or F, preferably F,
“Alkyl” is alkyl having 1 to 6 carbon atoms,
R′ is alkyl having 1 to 6 carbon atoms, alkoxy having 1 to 6 carbon atoms or alkenyl having 2 to 6 carbon atoms, and
“Alkenyl” is alkenyl having 2 to 6 carbon atoms.
The compounds of the formulae IX to XII are preferably selected from the following formulae:

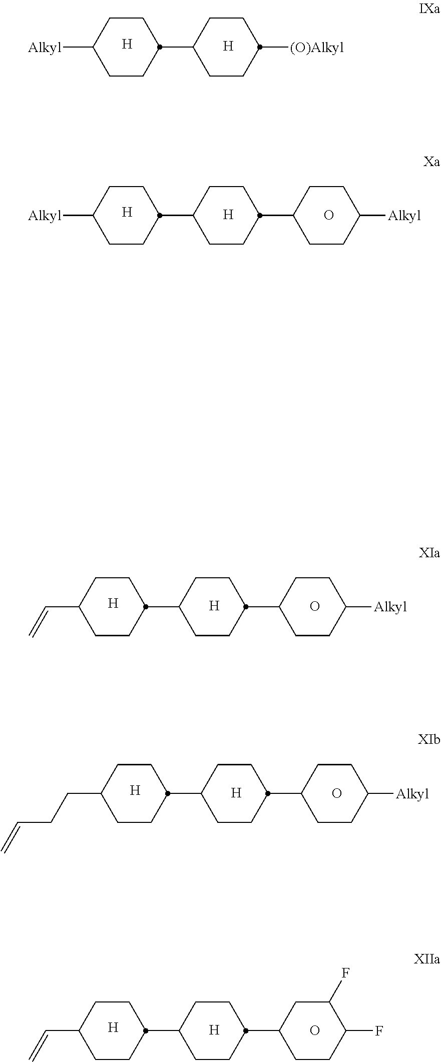

in which “Alkyl” has the definition given above. (O)Alkyl means “Alkyl” or “OAlkyl” (=alkoxy having 1 to 6 carbon atoms)
The medium additionally comprises one or more compounds selected from the following formulae:

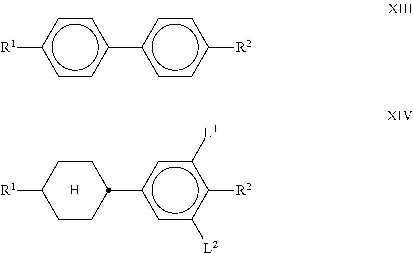

in which L¹ and L² are, independently of each other, H or F, preferably L¹ is F and most preferably both L¹ and L² are F, and R¹ and R² are each independently n-alkyl, alkoxy, oxaalkyl, fluoroalkyl or alkenyl each having up to 6 carbon atoms, and preferably are each independently alkyl having 1 to 6 carbon atoms; in the compound of the formula XIII, preferably at least one of the R¹ and R² radicals is alkenyl having 2 to 6 carbon atoms.
The medium contains one or more compounds of the formula XIII in which at least one of the R¹ and R² radicals is alkenyl having 2 to 6 carbon atoms, preferably those selected from the following formulae:

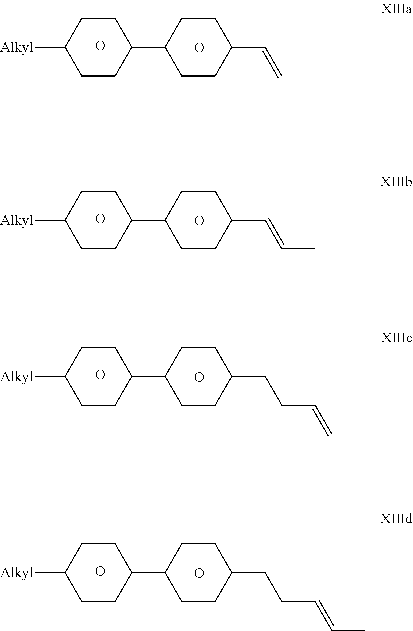

in which “Alkyl” has the definition given above, and is preferably methyl or ethyl. Particular preference is given to compounds of the formula XIIId.
The medium comprises one or more compounds other than the formulae 1 to 7 that are of the following formulae:

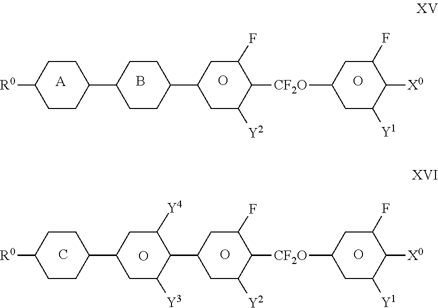

in which R⁰, X⁰ and Y¹ to Y⁴ have the definitions given above in formulae II and III, and

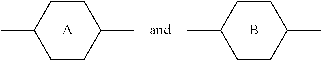

are each independently

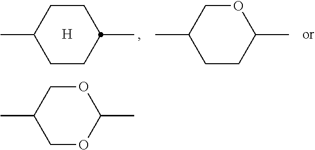

and

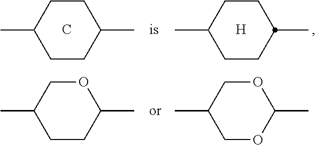

with exclusion of the compounds of the formula 4 from the compounds of the formula XVI.
The compounds of the formulae XV and XVI are preferably selected from the following formulae:

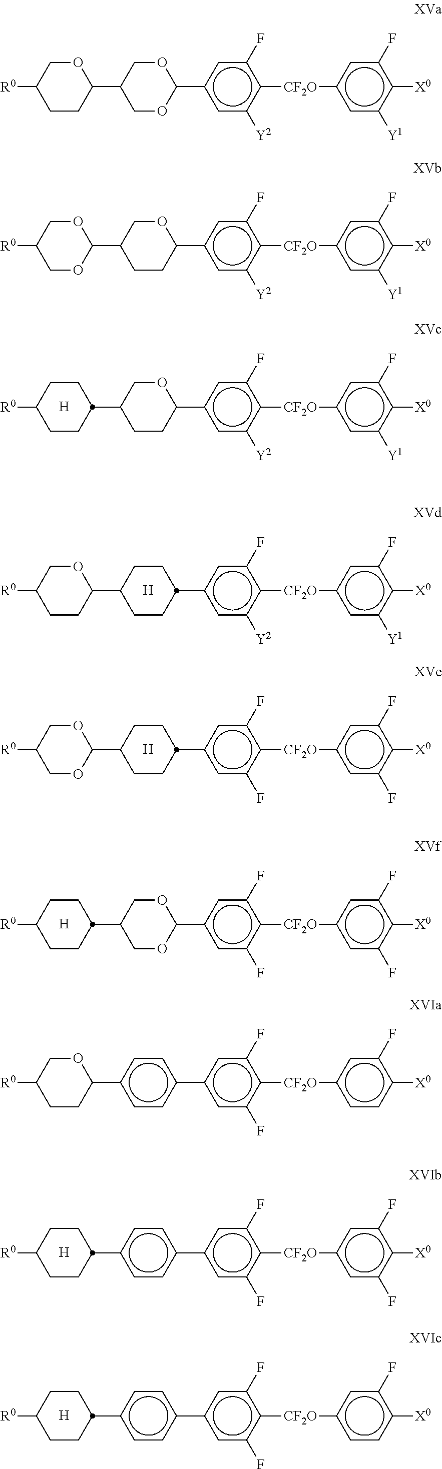

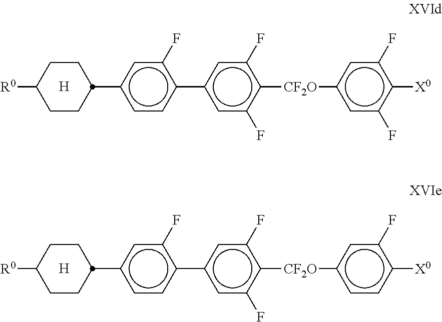

in which R⁰ and X⁰ have the definitions given above.
Preferably, R⁰ is alkyl having 1 to 6 carbon atoms. X⁰ is preferably F, or else OCF₃. Particularly preferred compounds of the formulae XV and XVI and the sub-formulae thereof are those in which Y¹ is F and Y² is H or F, preferably F.
The medium comprises one or more compounds other than the formulae 1 to 7 that are of the formula XVII

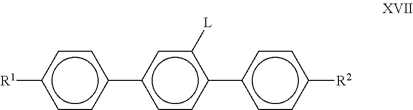

in which R¹ and R² have the definitions given above under formula XIII, and are preferably each independently alkyl having 1 to 6 carbon atoms, and L is H or F, preferably F, with exclusion of the compounds of the formula 2 from these compounds.
Particularly preferred compounds of the formula XVII are those of the sub-formulae

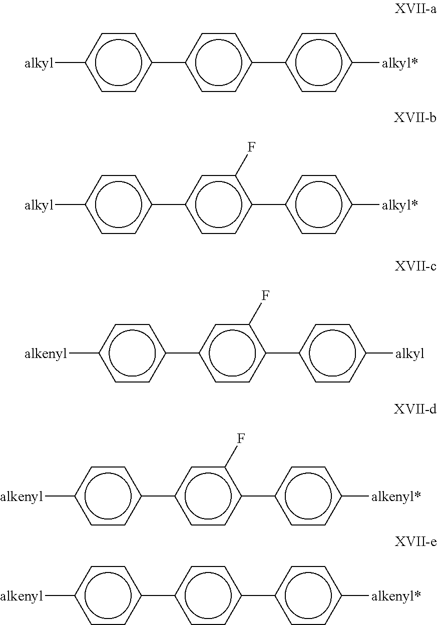

in which
alkyl and alkyl* are each independently straight-chain alkyl radical having 1 to 6 carbon atoms, especially ethyl, propyl and pentyl,
alkenyl
and alkenyl* are each independently straight-chain alkenyl radical having 2 to 6 carbon atoms, especially CH₂═CHC₂H₄, CH₃CH═CHC₂H₄, CH₂═CH and CH₃CH═CH.
Particular preference is given to the compounds of the formulae XVII-b and XVII-c. Very particular preference is given to the compounds of the formulae

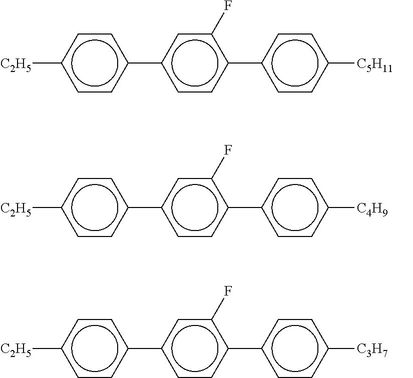

The medium comprises one or more compounds of the following formulae:

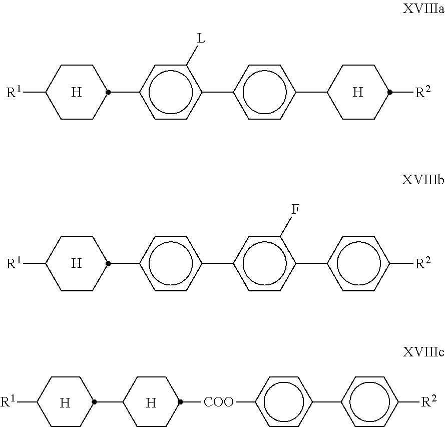

in which R¹ and R² have the definitions given above, and are preferably each independently an alkyl having 1 to 6 carbon atoms. L is H or F, preferably F.
The medium additionally comprises one or more compounds other than the formulae 1 to 7 that are selected from the following formulae:

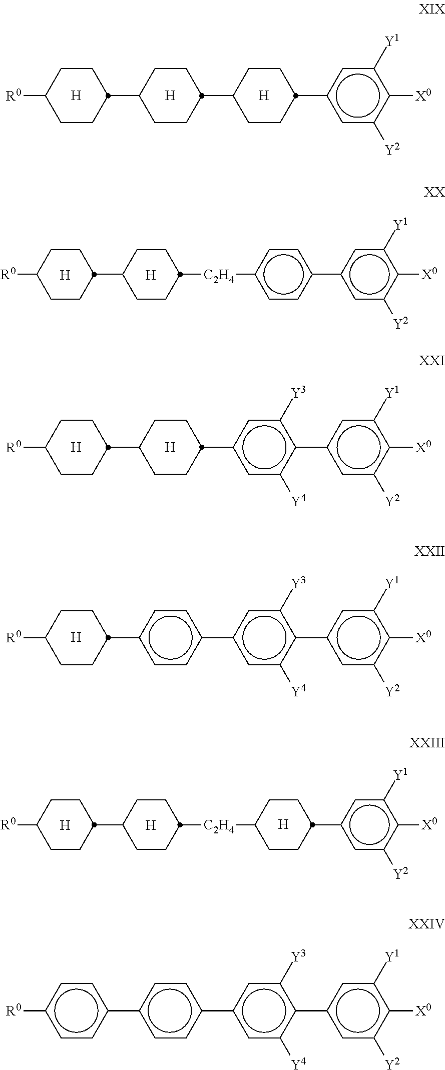

in which R⁰ and X⁰ each independently have one of the definitions given above and Y¹ to Y⁴ are each independently H or F, with exclusion of the compounds of the formulae 6 and 7 from the compounds of the formulae XXI and XXII. X⁰ is preferably F, Cl, CF₃, OCF₃ or OCHF₂. R⁰ is preferably alkyl, alkoxy, oxaalkyl, fluoroalkyl or alkenyl each having up to 6 carbon atoms.
More preferably, the mixture according to the invention comprises one or more compounds of the formula XXIV-a

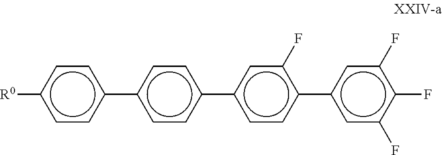

in which R⁰ has the definitions given above. Preferably, R⁰ is straight-chain alkyl, especially ethyl, n-propyl, n-butyl and n-pentyl, and most preferably n-propyl. The compound(s) of the formula XXIV, especially of the formula XXIV-a, are preferably used in the mixtures according to the invention in amounts of 0.5% to 20% by weight, more preferably 1% to 15% by weight.
The medium additionally comprises one or more compounds of the formula XXV

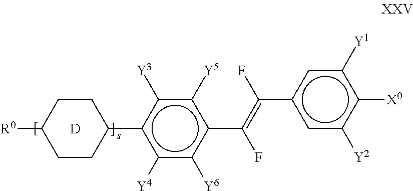

in which R⁰, X⁰ and Y¹ to Y⁶ have the definitions given above in formulae II and III, s is 0 or 1, and

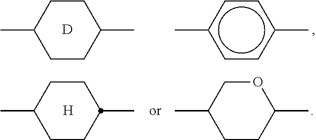

In the formula XXV, X⁰ may alternatively also be an alkyl radical having 1 to 6 carbon atoms or an alkoxy radical having 1 to 6 carbon atoms. Preferably, the alkyl or alkoxy radical is straight-chain.

Preferably, R⁰ is alkyl having 1 to 6 carbon atoms. X⁰ is preferably F;
The compounds of the formula XXV are preferably selected from the following formulae:

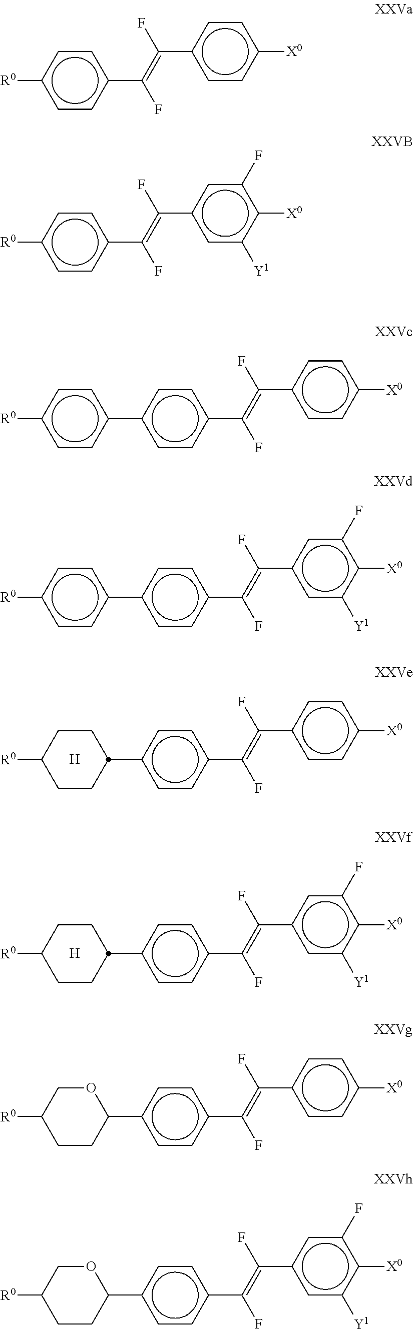

in which R⁰, X⁰ and Y¹ have the definitions given under formula XXV. Preferably, R⁰ is alkyl having 1 to 6 carbon atoms. X⁰ is preferably F and Y¹ is preferably F;

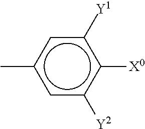

is preferably.

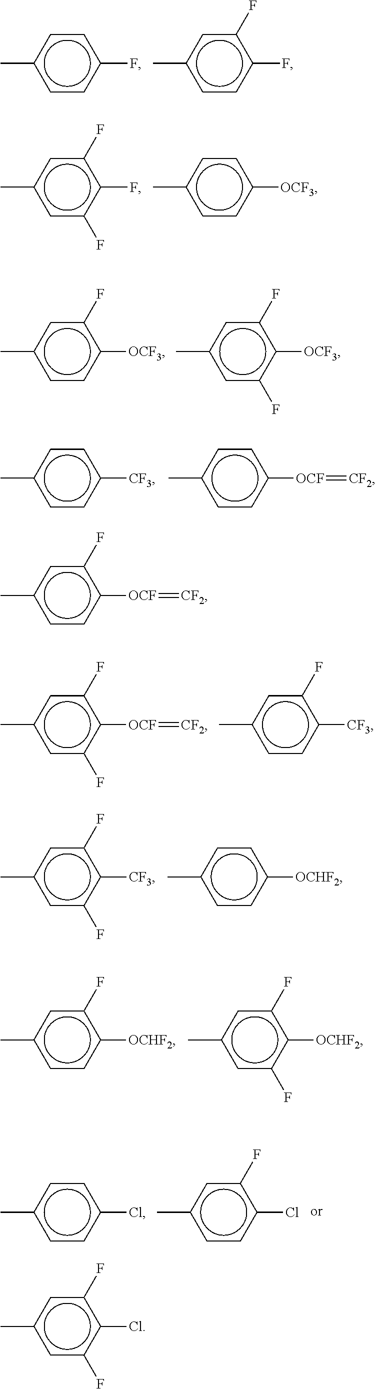

R⁰ is straight-chain alkyl or alkenyl having 2 to 6 carbon atoms;
The medium comprises one or more compounds of the following formulae:

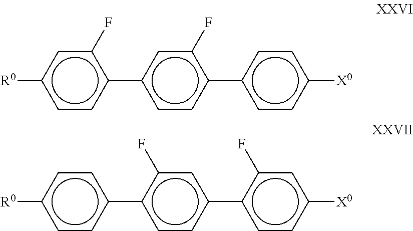

in which R⁰ and X⁰ have the definitions given above in formulae II and III. R⁰ is preferably alkyl having 1 to 6 carbon atoms. X⁰ is preferably F or Cl. In the formula XXVI, X⁰ is most preferably Cl.
The medium comprises one or more compounds other than the formulae 1 to 7 that are of the following formulae:

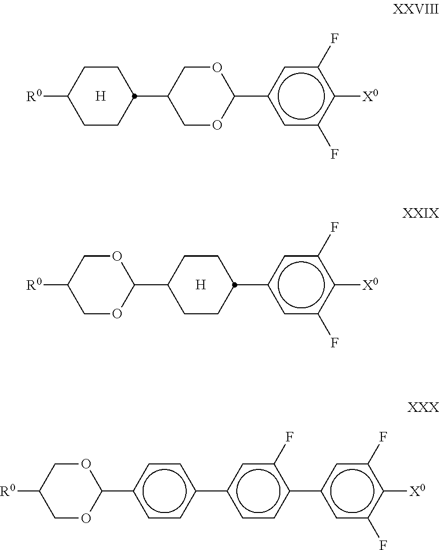

in which R⁰ and X⁰ have the definition given above in formulae II and III. R⁰ is preferably alkyl having 1 to 6 carbon atoms. X⁰ is preferably F; especially preferably, the medium according to the invention comprises one or more compounds of the formula XXX in which X⁰ is preferably F. The compound(s) of the formulae XXVIII-XXX are preferably used in the mixtures according to the invention in amounts of 1% to 20% by weight, more preferably 1% to 15% by weight. Particularly preferred mixtures comprise at least one compound of the formula XXX.

Further preferred embodiments are specified hereinafter:
The proportion of compounds of the formulae II, III, IX to XIII, XVII, XVIIIa, XVIIIb, and XVIIIc in the overall mixture is 40% to 95% by weight;
The medium comprises 10% to 50% by weight, more preferably 12% to 40% by weight, of compounds of the formula II and/or III;
The medium comprises 20% to 70% by weight, more preferably 25% to 65% by weight, of compounds of the formulae IX to XIII;
The medium comprises 4% to 30% by weight, more preferably 5% to 20% by weight, of compounds of the formula XVII;
The medium comprises 1% to 20% by weight, more preferably 2% to 15% by weight, of compounds of the formula XVIIIa, XVIIIb, and XVIIIc.
The medium comprises ≧20% by weight, preferably ≧24% by weight, preferably 25% to 60% by weight, of compounds of the formula 1, especially the compound of the formula 1a1

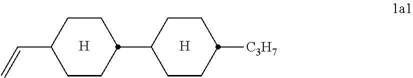

The medium comprises at least one compound of the formula 1a or 1a1 and at least one compound of the formula 1b1.

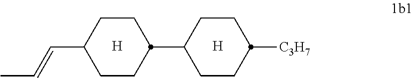

The medium comprises at least one compound of the formula PPGU-n-F (described below) in which n is 2 or 3.
The medium comprises at least one compound, preferably two or three compounds, of the formula PGP-n-m (described below), in which n and m are each independently 2, 3, 4 or 5.

It has been found that the use of compounds of the formulae 1 to 7 as described above, in a mixture with standard liquid-crystal materials, but especially with one or more compounds of the formulae II to XVII, XVIIIa to XVIIIc, XXIX, and XXX, leads to a considerable increase in light stability and to relatively high values for birefringence, with simultaneous observation of broad nematic phases with low smectic-nematic transition temperatures, as a result of which storage stability is improved. At the same time, the mixtures exhibit very low threshold voltages and very good values for VHR under UV exposure and very high clearing points.

The expression “alkyl” or “alkyl*” in this application encompasses straight-chain and branched alkyl groups having 1 to 6 carbon atoms, especially the straight-chain methyl, ethyl, propyl, butyl, pentyl and hexyl groups. Groups having 2 to 5 carbon atoms are generally preferred.

The expression “alkenyl” or “alkenyl*” encompasses straight-chain and branched alkenyl groups having 2 to 6 carbon atoms, especially the straight-chain groups. Preferred alkenyl groups are C₂ to C₇-1E-alkenyl, C₄ to C₆-3E-alkenyl, especially C₂ to C₆-1E-alkenyl. Examples of particularly preferred alkenyl groups are vinyl, 1E-propenyl, 1E-butenyl, 1E-pentenyl, 1E-hexenyl, 3-butenyl, 3E-pentenyl, 3E-hexenyl, 4-pentenyl, 4Z-hexenyl, 4E-hexenyl and 5-hexenyl. Groups having up to 5 carbon atoms are generally preferred, especially CH₂═CH and CH₃CH═CH.

The expression “fluoroalkyl” preferably encompasses straight-chain groups having terminal fluorine, i.e. fluoromethyl, 2-fluoroethyl, 3-fluoropropyl, 4-fluorobutyl, 5-fluoropentyl, 6-fluorohexyl and 7-fluoroheptyl. However, other positions for the fluorine are not ruled out.

The expression “oxaalkyl” or “alkoxy” preferably encompasses straight-chain radicals of the formula CₙH₂ₙ₊₁—O—(CH₂)ₘ in which n and m are each independently an integer from 1 to 6. m may also be 0. Preferably, n=1 and m is 1 to 6 or m=0 and n=1 to 3.

Through suitable choice of the definitions of R⁰ and X⁰, it is possible to modify the response times, the threshold voltage, the steepness of the transmission characteristics, etc. in the desired manner. For example, 1E-alkenyl radicals, 3E-alkenyl radicals, 2E-alkenyloxy radicals and the like generally lead to shorter response times, improved nematic tendencies and a higher ratio of the elastic constants k₃₃ (bend) and k₁₁ (splay) compared to alkyl or alkoxy radicals. 4-Alkenyl radicals, 3-alkenyl radicals and the like give rise to generally lower threshold voltages and lower values of k₃₃/k₁₁ compared to alkyl and alkoxy radicals. The mixtures according to the invention are especially notable for high Δ∈ values and hence have much faster switching times than the mixtures according to the prior art.

The optimal ratio of the compounds of the abovementioned formulae depends substantially on the desired properties, on the choice of components of the abovementioned formulae and the choice of any further components present.

Suitable ratios within the above-specified range can be determined easily from case to case.

The total amount of compounds of the abovementioned formulae in the mixtures according to the invention is not critical. The mixtures may therefore comprise one or more further components for the purpose of optimization of various properties. However, in general, the higher the total concentration of compounds of the abovementioned formulae, the greater the observed effect on the desired improvement in the properties of the mixture.

In a particularly preferred embodiment, the media according to the invention comprise compounds of the formula II to VIII (preferably II, III, IV and V, especially IIa and IIIa), in which X⁰ is F, OCF₃, OCHF₂, OCH═CF₂, OCF═CF₂ or OCF₂—CF₂H.

The individual compounds of the abovementioned formulae and the sub-formulae thereof which can be used in the media according to the invention are either known or can be prepared analogously to the known compounds.

The invention also provides electrooptical displays, for example STN or MLC displays having two plane-parallel carrier plates which, together with a border, form a cell, integrated non-linear elements for switching of individual pixels on the carrier plates, and a nematic liquid-crystal mixture having positive dielectric anisotropy and high specific resistivity within the cell, which comprise such media and also the use of these media for electrooptical purposes.

The liquid-crystal mixtures according to the invention enable a significant extension of the parameter space available. The achievable combinations of clearing point, viscosity at low temperature, thermal and UV stability and high optical anisotropy far surpass existing materials from the prior art.

The mixtures according to the invention are especially suitable for mobile applications and TFT applications, for example mobile phones and PDAs. In addition, the mixtures according to the invention may find use in FFS, VA-IPS (vertically-aligned in-plane switching), OCB and IPS displays.

The liquid-crystal mixtures according to the invention enable, with retention of the nematic phase down to −20° C. and preferably down to −30° C., more preferably down to −40° C., and of the clearing point of ≧75° C., preferably ≧80° C., simultaneous attainment of rotational viscosities γ₁ of ≦110 mPa·s, more preferably ≦100 mPa·s, as a result of which it is possible to achieve excellent MLC displays with fast switching times. The rotational viscosities are determined at 20° C.

The dielectric anisotropy of the inventive liquid-crystal mixtures Δ∈ at 20° C. is preferably ≧+7, more preferably ≧+8, especially preferably ≧10. The mixtures are also characterized by small operating voltages. The threshold voltage of the liquid-crystal mixtures according to the invention is preferably ≦2.0 V. The birefringence Δn of the liquid-crystal mixtures according to the invention at 20° C. is preferably ≧0.09, more preferably ≧0.10.

The breadth of the nematic phase range of the liquid-crystal mixtures according to the invention is preferably at least 90°, especially at least 100°. This range preferably extends at least from −25° to +70° C.

It will be apparent that, through suitable choice of the components of the mixtures according to the invention, it is also possible to achieve higher clearing points (for example above 100° C.) at higher threshold voltages or lower clearing points at lower threshold voltages with retention of the other advantageous properties. It is likewise possible to obtain, with a correspondingly small increase in viscosities, mixtures having greater Δ∈ and hence low thresholds. The MLC displays according to the invention preferably work in the first transmission minimum according to Gooch and Tarry [C. H. Gooch and H. A. Tarry, Electron. Lett. 10, 2-4, 1974; C. H. Gooch and H. A. Tarry, Appl. Phys., Vol. 8, 1575-1584, 1975]; in addition to particularly favorable electrooptical properties, for example high steepness of the characteristic and low angular dependence of contrast (DE-C 30 22 818), at the same threshold voltage, a smaller dielectric anisotropy is sufficient here than in an analogous display in the second minimum. This makes it possible to achieve much higher specific resistivities in the first minimum using the mixtures according to the invention than in the case of mixtures with cyano compounds. The person skilled in the art will be able, through suitable choice of individual components and the proportions by weight thereof, by simple routine methods, to establish the birefringence required for a given layer thickness of the MLC display.

Measurements of the voltage holding ratio (HR) [S. Matsumoto et al., Liquid Crystals 5, 1320 (1989); K. Niwa et al., Proc. SID Conference, San Francisco, June 1984, p. 304 (1984); G. Weber et al., Liquid Crystals 5, 1381 (1989)] have shown that mixtures according to the invention comprising one or more compounds of the formula 1, one or more compounds of the formula 2, and one or more compounds of the formulae 3 to 5 and one or more compounds of the formulae 6 and/or 7 have a much smaller decrease in HR under UV exposure than analogous mixtures comprising cyanophenylcyclohexanes of the formula

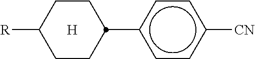

or esters of the formula

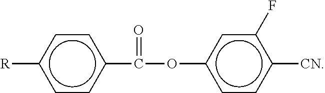

The light stability and UV stability of the mixtures according to the invention is considerably better, meaning that they exhibit a distinctly smaller decrease in the HR under exposure to light or UV.

The construction of the MLC display according to the invention, composed of polarizers, electrode base plates and electrodes with surface treatment, corresponds to the customary design for such displays. The expression “customary design” is interpreted broadly here and also encompasses all derivations and modifications of the MLC display, especially also matrix display elements based on poly-Si TFT or MIM.

However, an essential difference in the displays according to the invention from those which have been customary to date, based on the twisted nematic cell, is the choice of liquid-crystal parameters of the liquid-crystal layer.

The liquid-crystal mixtures usable in accordance with the invention are produced in a customary manner, for example by mixing one or more compounds of the formula 1 and one or more compounds of the formula 2, with one or more compounds of the formulae 3 to 5 and one or more compounds of the formulae 6 and/or 7 and optionally one or more II to XXVIII or with further liquid-crystalline compounds and/or additives. In general, the desired amount of the components used in a smaller amount is dissolved in the components that make up the main constituent, appropriately at elevated temperature. It is also possible to mix solutions of the components in an organic solvent, for example in acetone, chloroform or methanol, and to remove the solvent again after mixing, for example by distillation.

The dielectrics may also comprise further additions which are known to those skilled in the art and are described in the literature, for example UV stabilizers such as Tinuvin®, e.g. Tinuvin® 770, from Ciba Chemicals, antioxidants, e.g. TEMPOL, microparticles, free-radical scavengers, nanoparticles, etc. For example, it is possible to add 0% to 15% pleochroic dyes or chiral dopants. Suitable stabilizers and dopants are specified hereinafter in Tables C and D.

It is additionally possible to add polymerizable compounds, called reactive mesogens (RMs), for example as disclosed in U.S. Pat. No. 6,861,107, to the mixtures according to the invention, in concentrations of preferably 0.12%-5% by weight, more preferably 0.2%-2%, based on the mixture. Optionally, these mixtures may also comprise an initiator as described, for example, in U.S. Pat. No. 6,781,665. The initiator, e.g. Irganox 1076 from Ciba, is preferably added to the mixture comprising polymerizable compounds in amounts of 0% to 1%. Mixtures of this kind can be used for what are called polymer-stabilized (PS) modes, in which polymerization of the reactive mesogens in the liquid-crystalline mixture is to be effected, for example for PS-IPS, PS-FFS, PS-TN, PS-VA-IPS. A prerequisite for this is that the liquid-crystal mixture itself does not contain any polymerizable components.

In a preferred embodiment of the invention, the polymerizable compounds are selected from the compounds of the formula M

R^{Ma}-A^{M1}-(Z^{M1}-A^{M2})ₘ₁-R^{Mb} M

in which the individual radicals are defined as follows:
R^{Ma} and R^{Mb} are each independently P, P-Sp-, H, F, Cl, Br, I, —CN, —NO₂, —NCO, —NCS, —OCN, —SCN, SF₅ or straight-chain or branched alkyl having 1 to 25 carbon atoms, in which one or more non-adjacent CH₂ groups may each independently also be replaced by —C(R⁰)═C(R⁰⁰)—, —C≡C—, —N(R⁰⁰)—, —O—, —S—, —CO—, —CO—O—, —O—CO—, or —O—CO—O—, in such a way that no oxygen and/or sulphur atoms are joined directly to one another, and in which one or more hydrogen atoms may also be replaced by F, Cl, Br, I, CN, P or P-Sp-, where preferably at least one of the R^{Ma} and R^{Mb} radicals is or contains a P or P-Sp- group, where preferably at least one of the R^{Ma} and R^{Mb} radicals is or contains a P or P-Sp- group,
   R^{Ma} and R^{Mb} are preferably each independently P, P-Sp-, H, halogen, SF₅, NO₂, an alkyl, alkenyl or alkynyl group, where preferably at least one of the R^{Ma} and R^{Mb} radicals is or contains a P or P-Sp- group,
P is a polymerizable group,
Sp is a spacer group or a single bond,
A^{M1} and A^{M2} are each independently an aromatic, heteroaromatic, alicyclic or heterocyclic group, preferably having 4 to 25 ring atoms, preferably carbon atoms, which also comprises or may contain fused rings, and which may optionally be mono- or polysubstituted by L,
L is P, P-Sp-, OH, CH₂OH, F, Cl, Br, I, —CN, —NO₂, —NCO, —NCS, —OCN, —SCN, —C(═O)N(R^{x})₂, —C(═O)Y¹, —C(═O)R^{x}, —N(R^{x})₂, optionally substituted silyl, optionally substituted aryl having 6 to 20 carbon atoms, or straight-chain or branched alkyl, alkenyl, alkynyl, alkoxy, alkylcarbonyl, alkoxycarbonyl, alkylcarbonyloxy or alkoxycarbonyloxy having up to 25 carbon atoms, in which one or more hydrogen atoms may also be replaced by F, Cl, P or P-Sp-, preferably L is P, P-Sp-, OH, CH₂OH, F, Cl, Br, I, NO₂, an alkyl, alkenyl or alkynyl group,
Y¹ is halogen, preferably F,
Z^{M1} is —O—, —S—, —CO—, —CO—O—, —OCO—, —O—CO—O—, —OCH₂—, —CH₂O—, —SCH₂—, —CH₂S—, —CF₂O—, —OCF₂—, —CF₂S—, —SCF₂—, —(CH₂)ₙ₁—, —CF₂CH₂—, —CH₂CF₂—, —(CF₂)ₙ₁—, —CH═CH—, —CF═CF—, —C≡C—, —CH═CH—, —COO—, —OCO—CH═CH—, CR⁰R⁰⁰ or a single bond,
R⁰ and R⁰⁰ are each independently H or alkyl having 1 to 12 carbon atoms,
R^{x} is P, P-Sp-, H, halogen, straight-chain, branched or cyclic alkyl having 1 to 25 carbon atoms, in which one or more non-adjacent CH₂ groups may also be replaced by —O—, —S—, —CO—, —CO—O—, —O—CO—, or —O—CO—O—, in such a way that no oxygen and/or sulphur atoms are joined directly to one another, and in which one or more hydrogen atoms may also be replaced by F, Cl, P or P-Sp-, an optionally substituted aryl or aryloxy group having 6 to 40 carbon atoms, or an optionally substituted heteroaryl or heteroaryloxy group having 2 to 40 carbon atoms,
m1 is 0, 1, 2, 3 or 4, and
n1 is 1, 2, 3 or 4,
   where at least one substituent, preferably one, two or three substituents and more preferably one or two substituents from the group of R^{Ma}, R^{Mb} and the substituent L present is a P or P-Sp- group or contains at least one P or P-Sp- group.

Particularly preferred compounds of the formula M are those in which
R^{Ma} and R^{Mb} are each independently P, P-Sp-, H, F, Cl, Br, I, —CN, —NO₂, —NCO, —NCS, —OCN, —SCN, SF₅ or straight-chain or branched alkyl having 1 to 25 carbon atoms, in which one or more non-adjacent CH₂ groups may each independently also be replaced by —C(R⁰)═C(R⁰⁰)—, —C≡C—, —N(R⁰⁰)—, —O—, —S—, —CO—, —CO—O—, —O—CO—, or —O—CO—O—, in such a way that no oxygen and/or sulphur atoms are joined directly to one another, and in which one or more hydrogen atoms may also be replaced by F, Cl, Br, I, CN, P or P-Sp-, where preferably at least one of the R^{Ma} and R^{Mb} radicals is or contains a P or P-Sp- group,
   R^{Ma} and R^{Mb} are preferably each independently P, P-Sp-, H, halogen, SF₅, NO₂, an alkyl, alkenyl or alkynyl group, where preferably at least one of the R^{Ma} and R^{Mb} radicals is or contains a P or P-Sp- group,
A^{M1} and A^{M2} are each independently 1,4-phenylene, naphthalene-1,4-diyl, naphthalene-2,6-diyl, phenanthrene-2,7-diyl, anthracene-2,7-diyl, fluorene-2,7-diyl, coumarin, flavone, where one or more CH groups in these groups may also be replaced by N, cyclohexane-1,4-diyl, in which one or more non-adjacent CH₂ groups may also each be replaced by O or S, 1,4-cyclohexenylene, bicyclo[1.1.1]pentane-1,3-diyl, bicyclo[2.2.2]octane-1,4-diyl, spiro[3.3]heptane-2,6-diyl, piperidine-1,4-diyl, decahydronaphthalene-2,6-diyl, 1,2,3,4-tetrahydronaphthalene-2,6-diyl, indane-2,5-diyl or octahydro-4,7-methanoindane-2,5-diyl, where all these groups may be unsubstituted or mono- or polysubstituted by L,
L is P, P-Sp-, OH, CH₂OH, F, Cl, Br, I, —CN, —NO₂, —NCO, —NCS, —OCN, —SCN, —C(═O)N(R^{x})₂, —C(═O)Y¹, —C(═O)R^{x}, —N(R^{x})₂, optionally substituted silyl, optionally substituted aryl having 6 to 20 carbon atoms, or straight-chain or branched alkyl, alkenyl, alkynyl, alkoxy, alkylcarbonyl, alkoxycarbonyl, alkylcarbonyloxy or alkoxycarbonyloxy having up to 25 carbon atoms, in which one or more hydrogen atoms may also be replaced by F, Cl, P or P-Sp-,
P is a polymerizable group,
Y¹ is halogen, preferably F,
R^{x} is P, P-Sp-, H, halogen, straight-chain, branched or cyclic alkyl having 1 to 25 carbon atoms, in which one or more non-adjacent CH₂ groups may also each be replaced by —O—, —S—, —CO—, —CO—O—, —O—CO—, or —O—CO—O—, in such a way that no oxygen and/or sulphur atoms are joined directly to one another, and in which one or more hydrogen atoms may also be replaced by F, Cl, P or P-Sp-, an optionally substituted aryl or aryloxy group having 6 to 40 carbon atoms, or an optionally substituted heteroaryl or heteroaryloxy group having 2 to 40 carbon atoms.

Very particular preference is given to compounds of the formula M in which one of R^{MA} and R^{Mb} or both are P or P-Sp-.

Suitable and preferred RMs for use in liquid-crystalline media according to the invention and PS mode displays are, for example, selected from the following formulae:

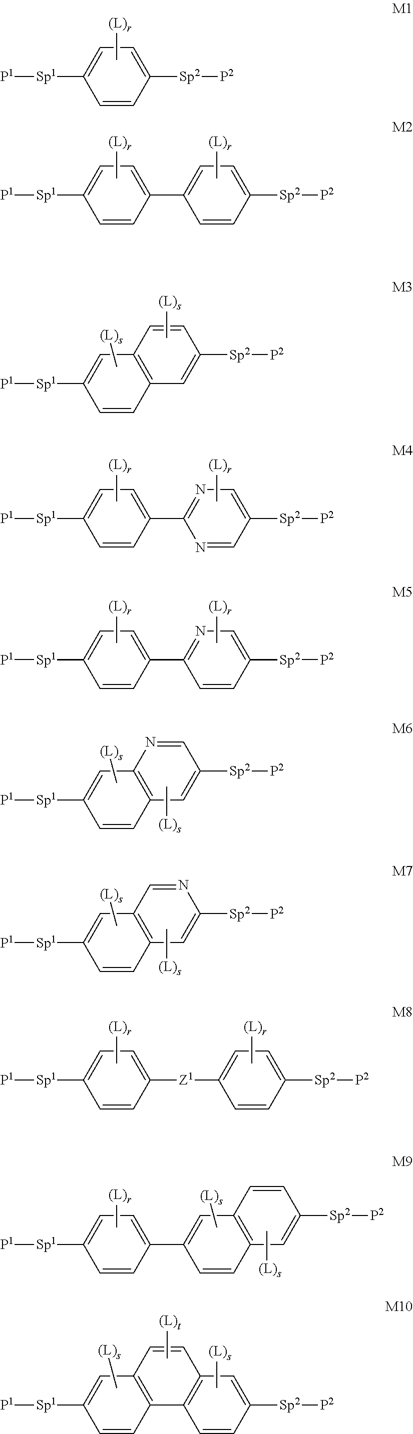

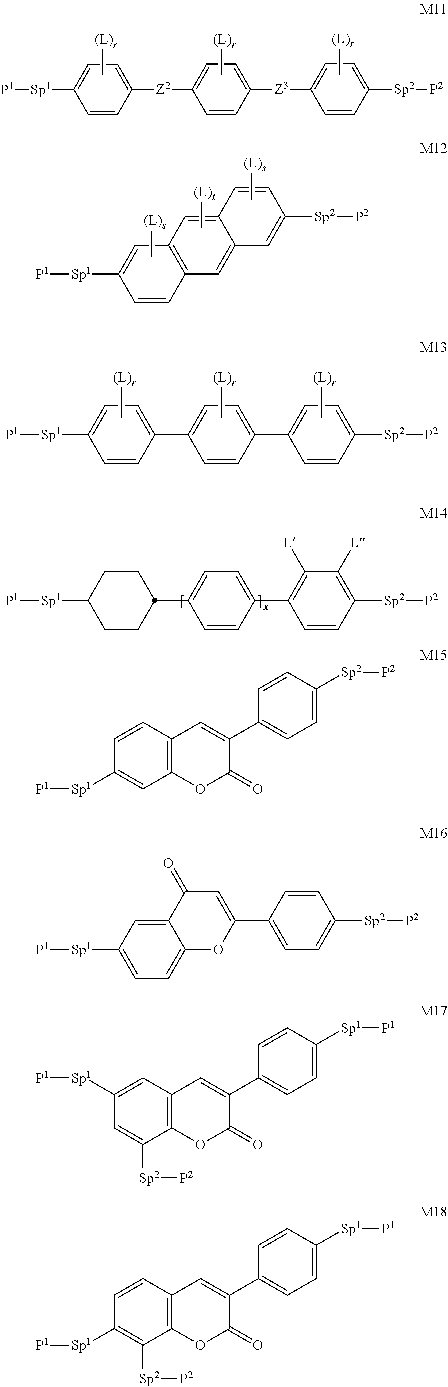

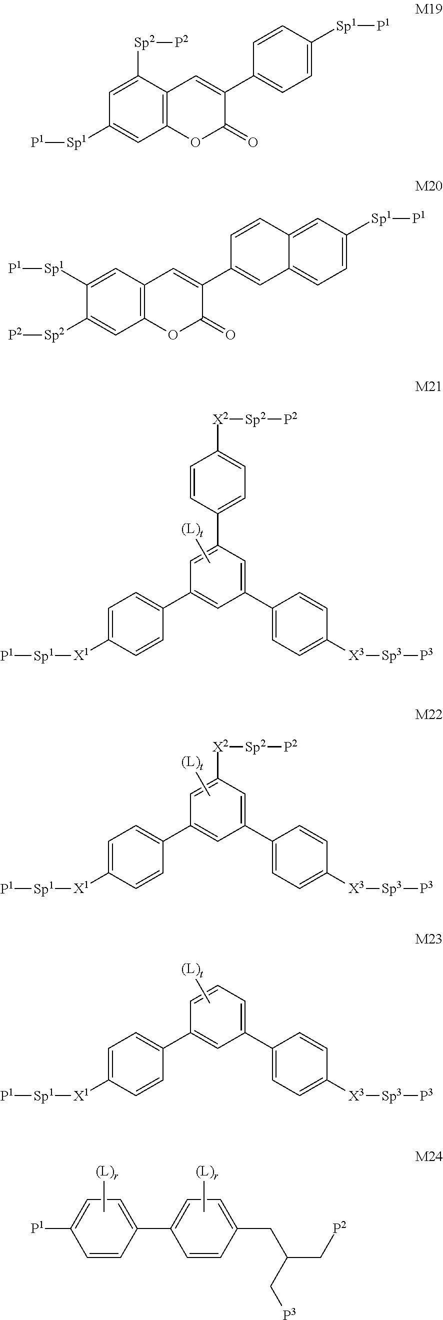

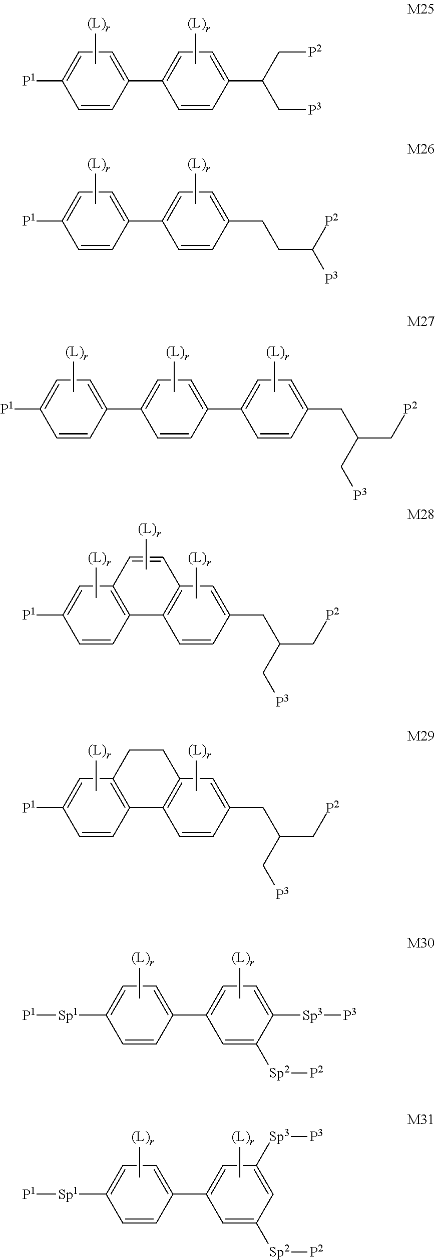

in which the individual radicals are defined as follows:
P¹ to P³ are each independently a polymerizable group, preferably having one of the definitions specified above and below for P, more preferably an acrylate, methacrylate, fluoroacrylate, oxetane, vinyloxy or epoxy group,
Sp¹ to Sp³ are each independently a single bond or a spacer group, preferably having one of the definitions of Sp given above and below, and more preferably —(CH₂)ₚ₁—, —(CH₂)ₚ₁—O—, —(CH₂)ₚ₁—CO—O— or —(CH₂)ₚ₁—O—CO—O—, in which p1 is an integer from 1 to 12, and where the bond to the adjacent ring in the latter groups is via the oxygen atom, where one of the P¹-Sp¹-, P²-Sp²- and P³-Sp³- radicals may also be R^{aa},
X¹, X² and X³ each, independently of one another, denote —CO—O—, O—CO— or a single bond,
R^{aa} is H, F, Cl, CN or straight-chain or branched alkyl having 1 to 25 carbon atoms, in which one or more non-adjacent CH₂ groups may each independently also be replaced by C(R⁰)═C(R⁰⁰)—, —C≡C—, —N(R⁰⁰)—, —O—, —S—, —CO—, —CO—O—, —O—CO—, or —O—CO—O—, in such a way that no oxygen and/or sulphur atoms are joined directly to one another, and in which one or more hydrogen atoms may also be replaced by F, Cl, CN or P¹-Sp¹-, more preferably straight-chain or branched, optionally mono- or polyfluorinated alkyl, alkoxy, alkenyl, alkynyl, alkylcarbonyl, alkoxycarbonyl, or alkylcarbonyloxy having 1 to 12 carbon atoms (where the alkenyl and alkynyl radicals have at least two carbon atoms and the branched radicals at least three carbon atoms),
R⁰ and R⁰⁰ are the same or different at each instance and are each independently H or alkyl having 1 to 12 carbon atoms,
Z¹ is —O—, —CO—, —C(R^{y}R^{z})— or —CF₂CF₂—,
R^{y} and R^{z} are each independently H, F, CH₃ or CF₃,
Z² and Z³ are each independently —CO—O—, —O—CO—, —CH₂O—, —OCH₂—, —CF₂O—, —OCF₂— or —(CH₂)ₙ—, where n is 2, 3 or 4,
L is the same or different at each instance and has the meaning under formula M above, preferably L is F, Cl, CN, or straight-chain or branched, optionally mono- or polyfluorinated alkyl, alkoxy, alkenyl, alkynyl, alkylcarbonyl, alkoxycarbonyl or alkylcarbonyloxy having 1 to 12 carbon atoms, preferably F,
L′ and L″ are each independently H, F or Cl,
r is 0, 1, 2, 3 or 4,
s is 0, 1, 2 or 3,
t is 0, 1 or 2, and
x is 0 or 1.

Suitable polymerizable compounds are listed, for example, in Table E.

Preferably, the liquid-crystalline media according to the present application contain a total of 0.01% to 3%, preferably 0.1% to 1.0%, more preferably 0.1% to 0.5%, of polymerizable compounds.

Especially preferred are the polymerizable compounds of the formulae M2, M13, M17, M22, M23, M24 and M30.

Additionally preferred are the polymerizable compounds of the formulae M15 to M31, especially M17, M18, M19, M22, M23, M24, M25, M26, M30 and M31.

The present invention thus also provides for the use of the mixtures according to the invention in electrooptical displays and for the use of the mixtures according to the invention in shutter glasses, especially for 3D applications, and in TN, PS-TN, STN, TN-TFT, OCB, IPS, PS-IPS, FFS, PS-FFS and PS-VA-IPS displays.

In the present application and in the examples which follow, the structures of the liquid-crystal compounds are stated in the form of acronyms that are transformed into chemical formulae according to Table A. All CₙH₂ₙ₊₁ and CₘH₂ₘ₊₁ radicals are straight-chain alkyl radicals having n or m carbon atoms; n, m and k are integers and are preferably 0, 1, 2, 3, 4, 5, 6, 7, 8, 9, 10, 11 or 12, and more preferably 1, 2, 3, 4, 5, 6, or 7. The coding according to Table B is self-evident. Table A states the acronym for the base skeleton only. In some specific cases there follows, separated from the acronym for the base skeleton by a dash, a code for the R^{1*}, R^{2*}, L^{1*} and L^{2*} substituents:

| Code for R¹*, | | | | |
|---|---|---|---|---|
| R²*, L¹*, L²* | R¹* | R²* | L¹* | L²*. |
| nm | CₙH₂ₙ₊₁ | CₘH₂ₘ₊₁ | H | H |
| nOm | CₙH₂ₙ₊₁ | OCₘH₂ₘ₊₁ | H | H |
| nO.m | OCₙH₂ₙ₊₁ | CₘH₂ₘ₊₁ | H | H |
| n | CₙH₂ₙ₊₁ | CN | H | H |
| nN.F | CₙH₂ₙ₊₁ | CN | F | H |
| nN.F.F | CₙH₂ₙ₊₁ | CN | F | F |
| nF | CₙH₂ₙ₊₁ | F | H | H |
| nCl | CₙH₂ₙ₊₁ | Cl | H | H |
| nOF | OCₙH₂ₙ₊₁ | F | H | H |
| nF.F | CₙH₂ₙ₊₁ | F | F | H |
| nF.F.F | CₙH₂ₙ₊₁ | F | F | F |
| nOCF₃ | CₙH₂ₙ₊₁ | OCF₃ | H | H |
| nOCF₃.F | CₙH₂ₙ₊₁ | OCF₃ | F | H |
| n-Vm | CₙH₂ₙ₊₁ | —CH═CH—CₘH₂ₘ₊₁ | H | H |
| nV-Vm | CₙH₂ₙ₊₁—CH═CH— | —CH═CH—CₘH₂ₘ₊₁ | H | H |

Preferred mixture components can be found in Tables A and B.

TABLE A

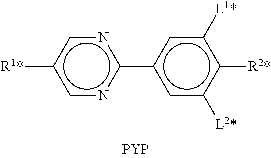

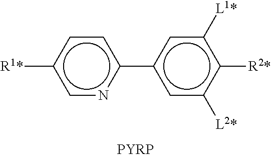

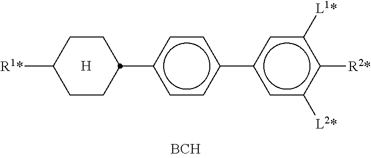

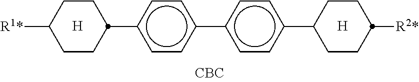

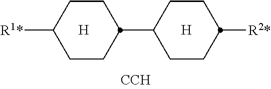

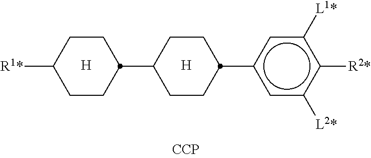

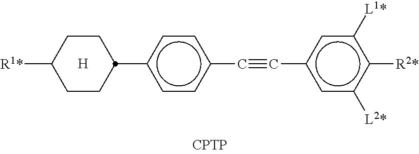

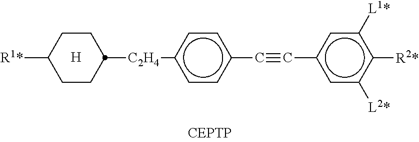

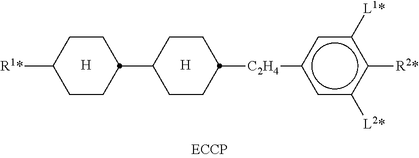

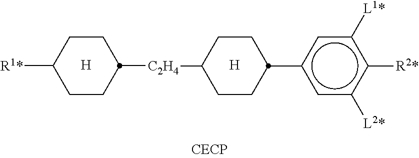

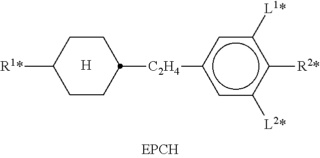

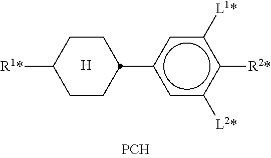

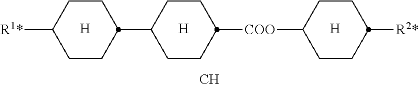

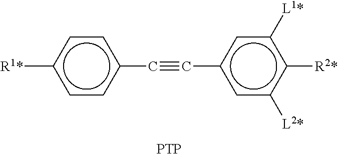

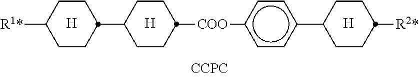

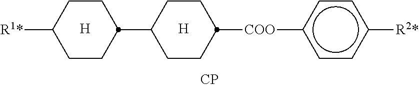

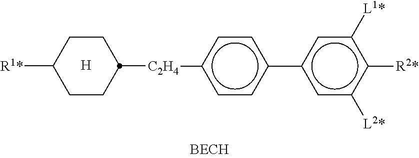

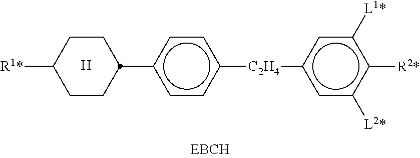

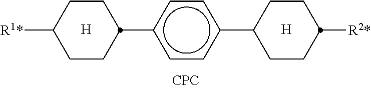

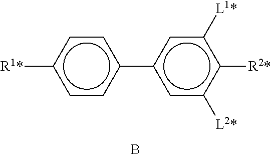

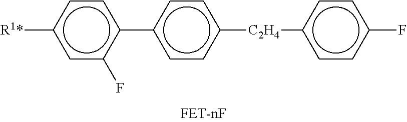

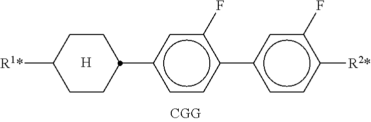

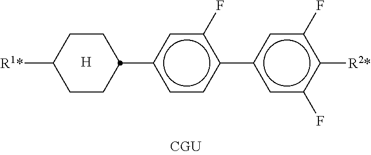

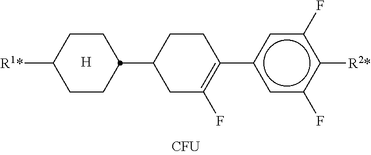

TABLE B
In the formulae which follow, n and m are each independently 0, 1, 2, 3, 4, 5,
6, 7, 8, 9, 10, 11 or 12, especially 2, 3, 5, or else 0, 4, 6, most preferably not 0.

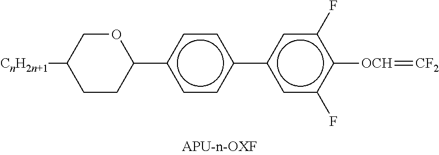

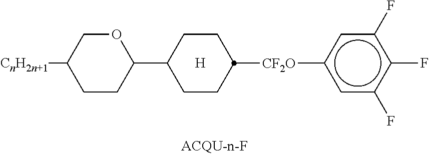

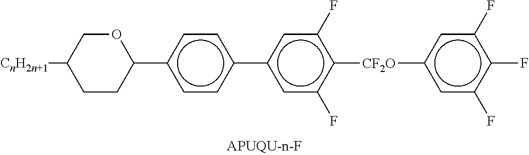

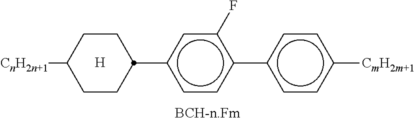

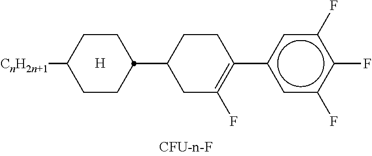

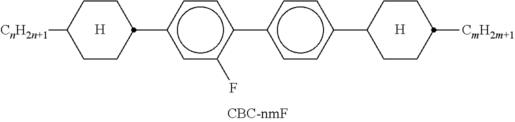

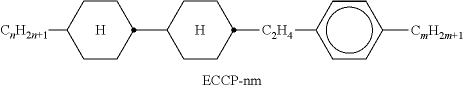

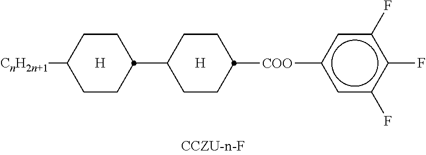

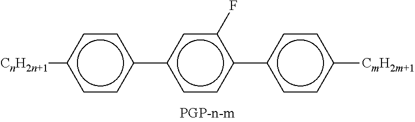

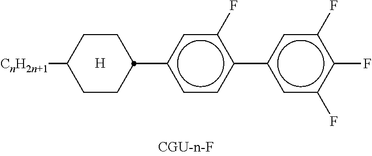

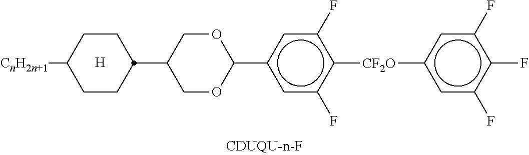

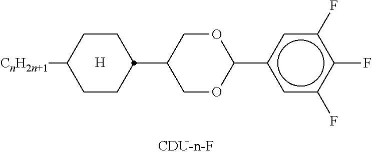

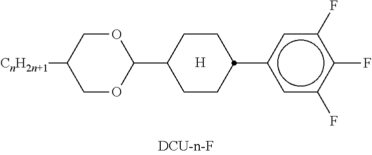

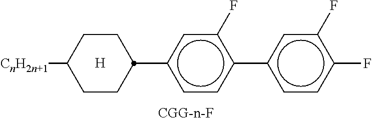

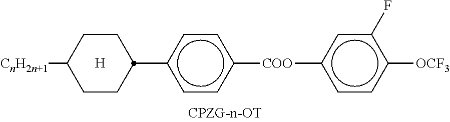

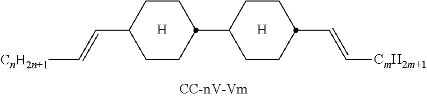

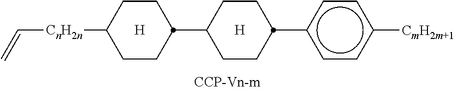

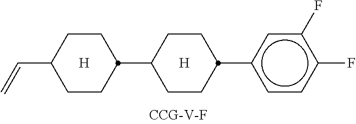

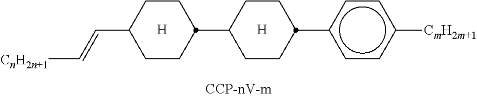

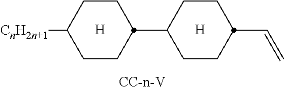

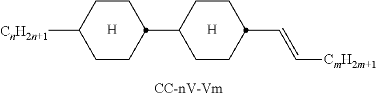

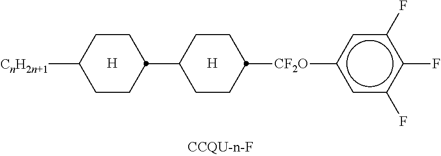

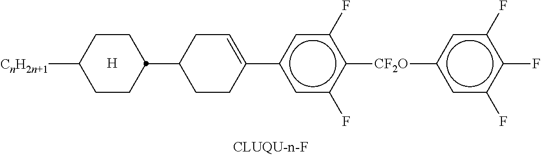

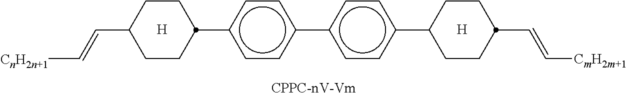

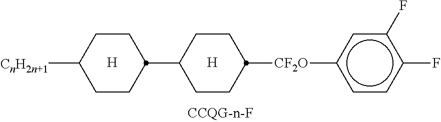

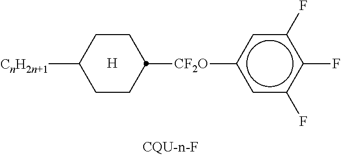

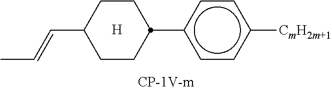

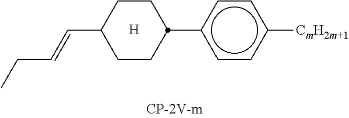

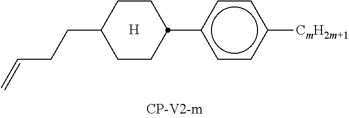

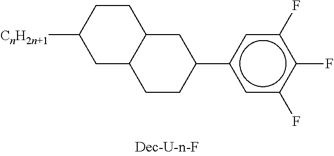

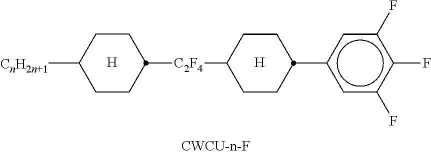

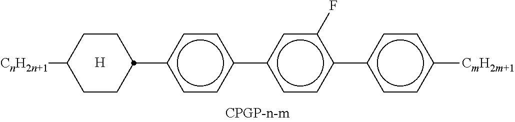

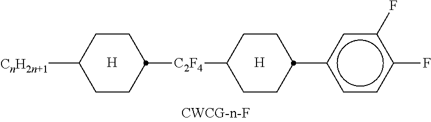

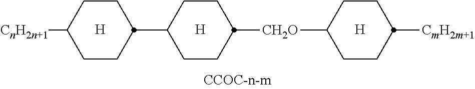

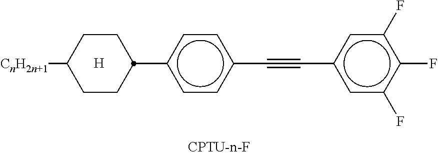

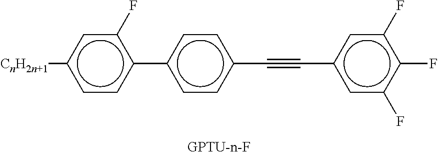

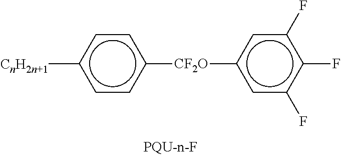

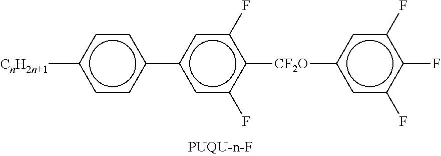

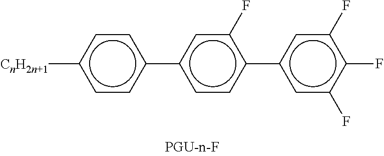

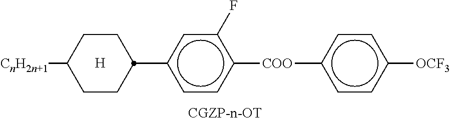

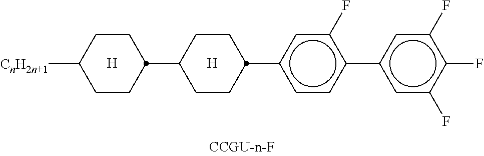

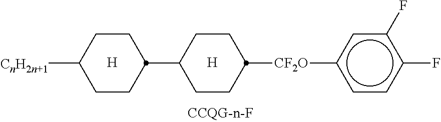

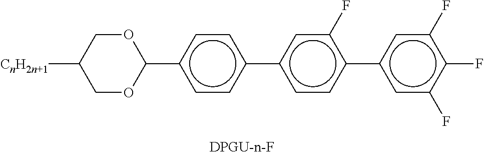

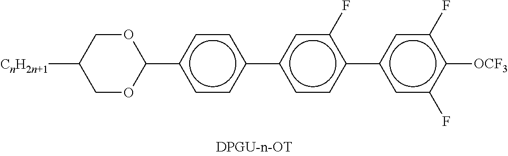

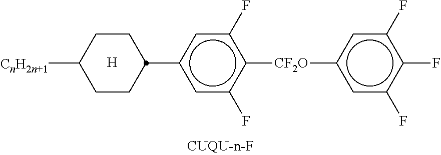

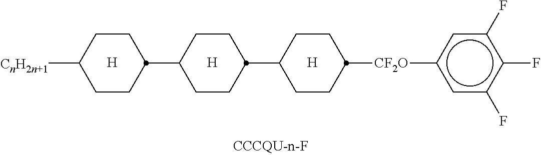

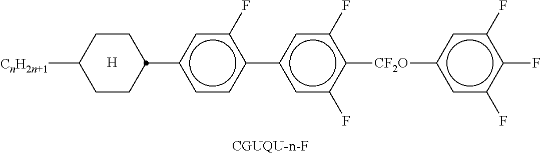

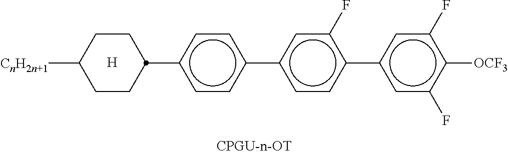

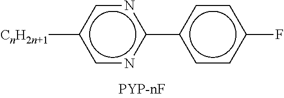

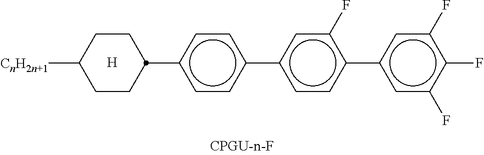

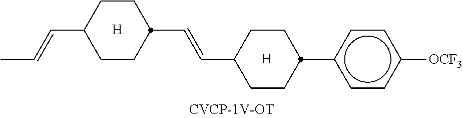

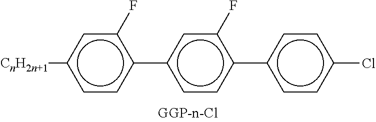

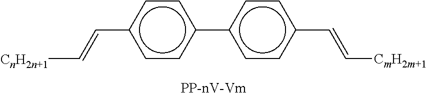

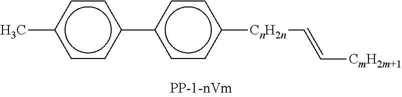

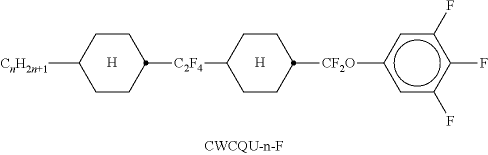

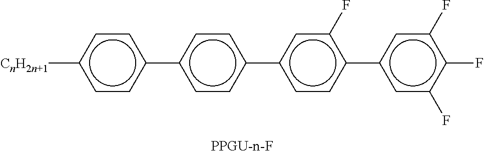

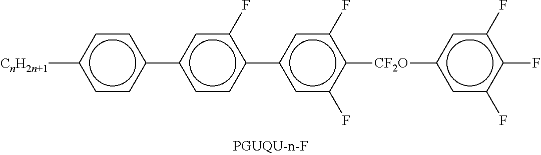

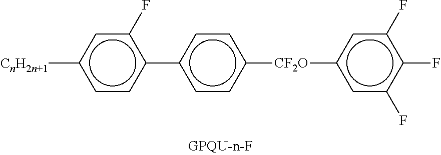

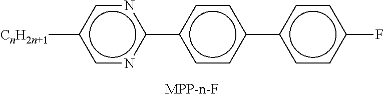

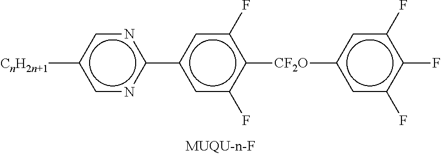

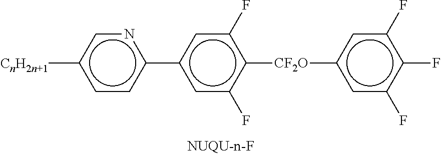

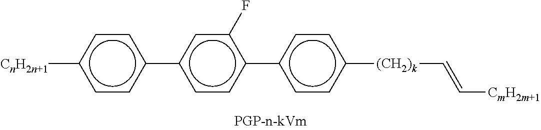

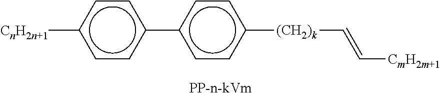

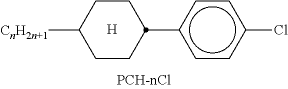

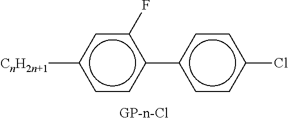

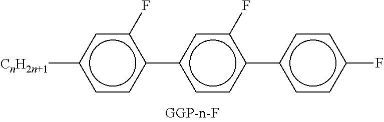

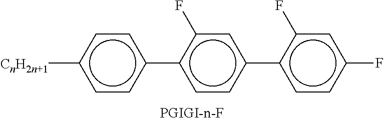

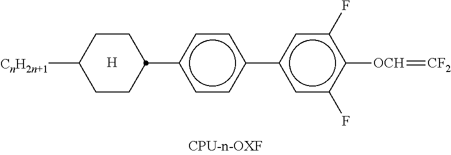

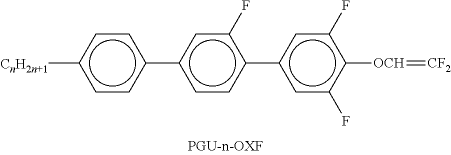

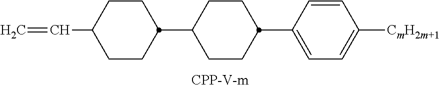

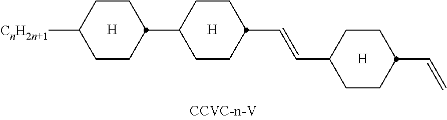

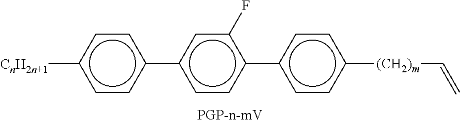

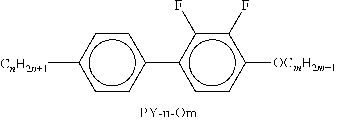

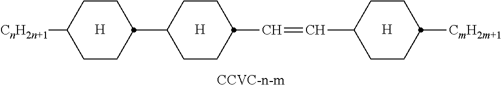

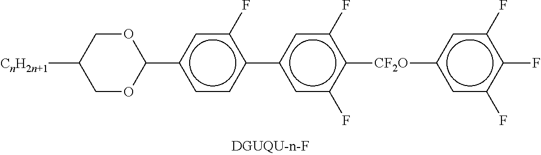

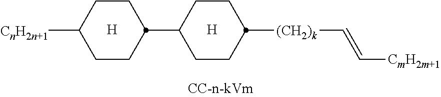

Particular preference is given to liquid-crystalline mixtures which, as well as the compounds of the formulae 1 and 2 and (3 to 5) and 6 and/or 7, comprise at least one, two, three, four or more compounds from Table B.

TABLE C
Table C specifies possible dopants which are generally added to the
mixtures according to the invention. Preferably, the mixtures comprise 0% to
10% by weight, especially 0.01% to 5% by weight and more preferably
0.01% to 3% by weight of dopants.

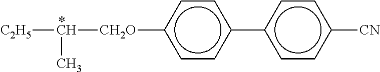

C 15

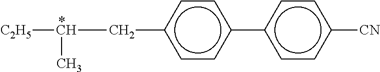

CB 15

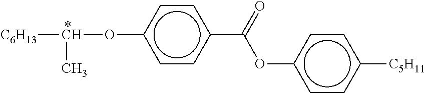

CM 21

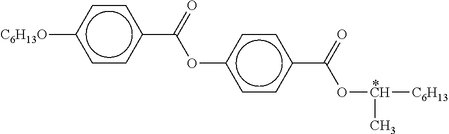

R/S-811

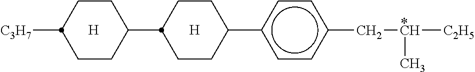

CM 44

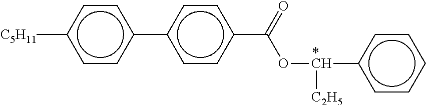

CM 45

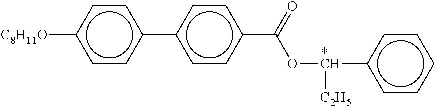

CM 47

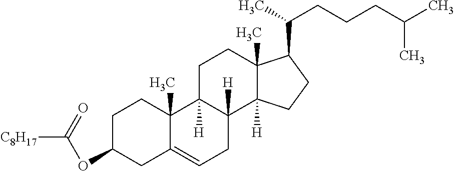

CN

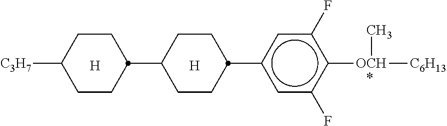

R/S-2011

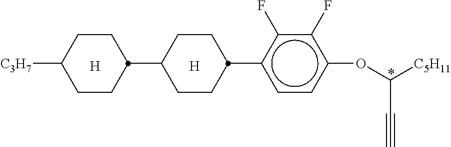

R/S-3011

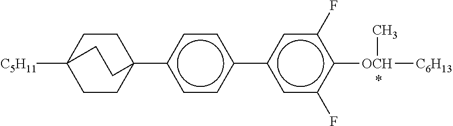

R/S-4011

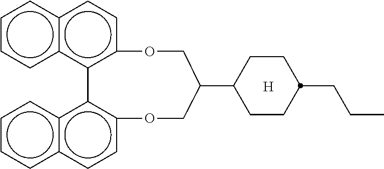

R/S-5011

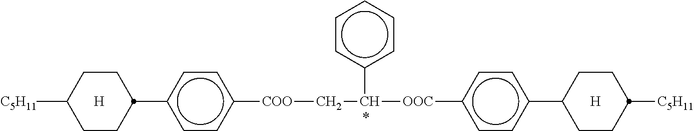

R/S-1011

TABLE D
Stabilizers which can be added, for example, to the mixtures according to
the invention in amounts of 0% to 10% by weight are specified below.

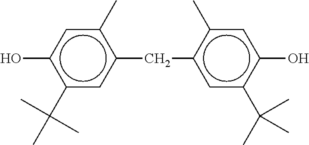

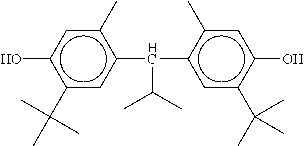

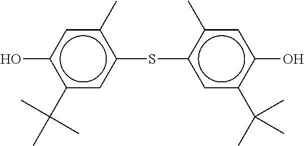

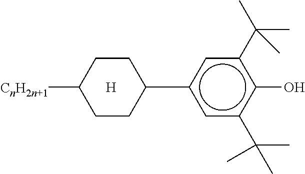

n = 1, 2, 3, 4, 5, 6 or 7

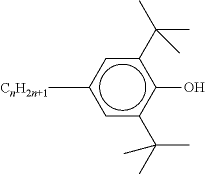

n = 1, 2, 3, 4, 5, 6 or 7

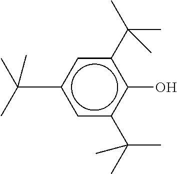

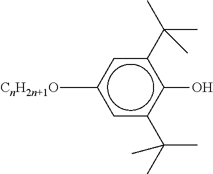

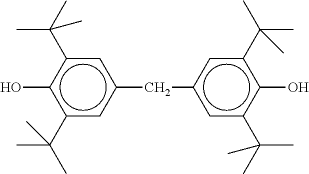

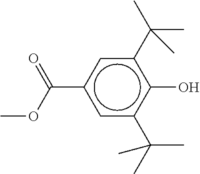

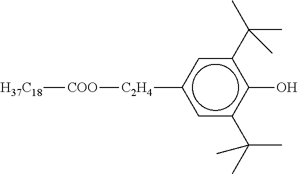

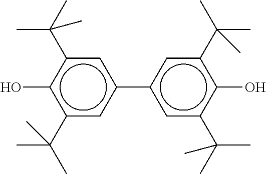

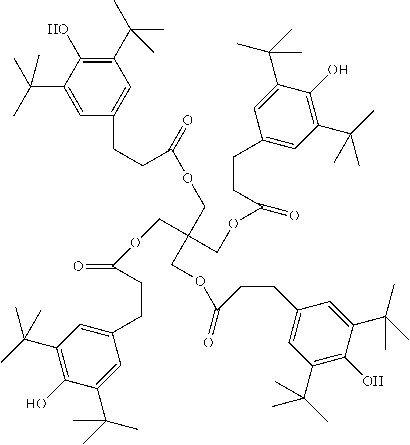 [SMILES: CC(C)(C)c1cc(CCC(=O)OCC(COC(=O)CCc2cc(C(C)(C)C)c(O)c(C(C)(C)C)c2)(COC(=O)CCc2cc(C(C)(C)C)c(O)c(C(C)(C)C)c2)COC(=O)CCc2cc(C(C)(C)C)c(O)c(C(C)(C)C)c2)cc(C(C)(C)C)c1O]

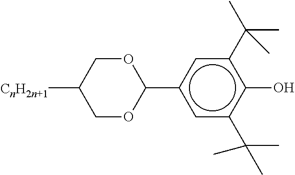

n = 1, 2, 3, 4, 5, 6 or 7

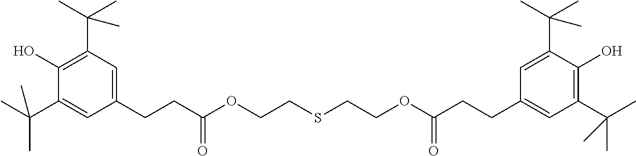 [SMILES: CC(C)(C)c1cc(CCC(=O)OCCSCCOC(=O)CCc2cc(C(C)(C)C)c(O)c(C(C)(C)C)c2)cc(C(C)(C)C)c1O]

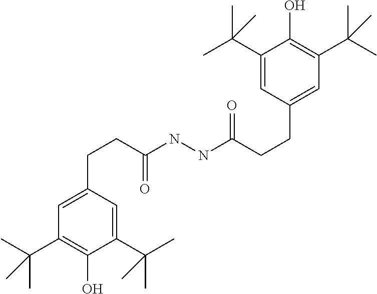 [SMILES: CC(C)(C)c1cc(CCC(=O)NNC(=O)CCc2cc(C(C)(C)C)c(O)c(C(C)(C)C)c2)cc(C(C)(C)C)c1O]

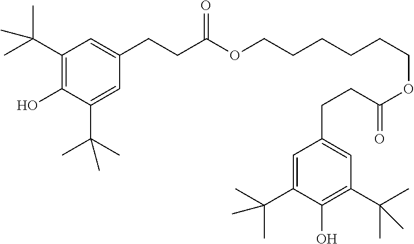 [SMILES: CC(C)(C)c1cc(CCC(=O)OCCCCCCOC(=O)CCc2cc(C(C)(C)C)c(O)c(C(C)(C)C)c2)cc(C(C)(C)C)c1O]

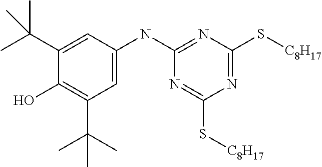

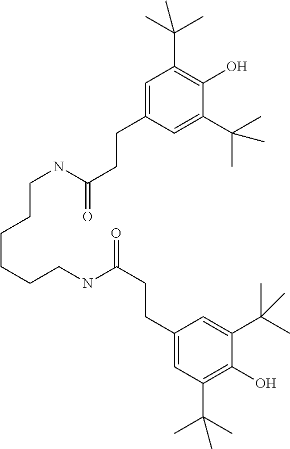 [SMILES: CC(C)(C)c1cc(CCC(=O)NCCCCCCNC(=O)CCc2cc(C(C)(C)C)c(O)c(C(C)(C)C)c2)cc(C(C)(C)C)c1O]

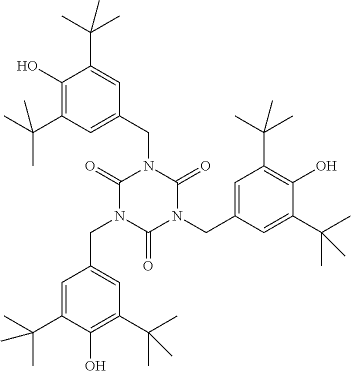 [SMILES: CC(C)(C)c1cc(Cn2c(=O)n(Cc3cc(C(C)(C)C)c(O)c(C(C)(C)C)c3)c(=O)n(Cc3cc(C(C)(C)C)c(O)c(C(C)(C)C)c3)c2=O)cc(C(C)(C)C)c1O]

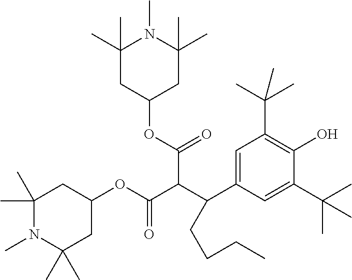 [SMILES: CCCCC(c1cc(C(C)(C)C)c(O)c(C(C)(C)C)c1)C(C(=O)OC1CC(C)(C)N(C)C(C)(C)C1)C(=O)OC1CC(C)(C)N(C)C(C)(C)C1]

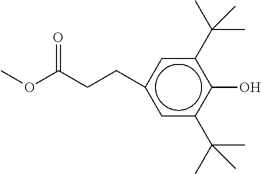

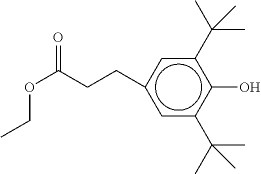

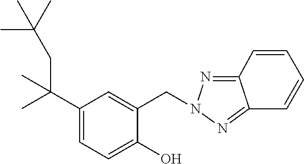 [SMILES: CC(C)(C)CC(C)(C)c1ccc(O)c(Cn2nc3ccccc3n2)c1]

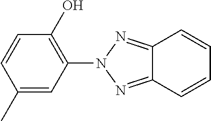 [SMILES: Cc1ccc(O)c(-n2nc3ccccc3n2)c1]

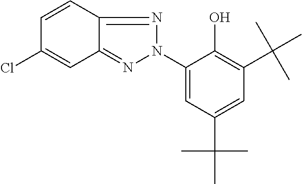 [SMILES: CC(C)(C)c1cc(-n2nc3ccc(Cl)cc3n2)c(O)c(C(C)(C)C)c1]

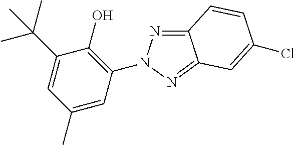 [SMILES: Cc1cc(-n2nc3ccc(Cl)cc3n2)c(O)c(C(C)(C)C)c1]

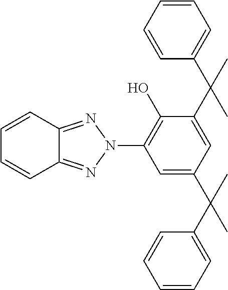 [SMILES: CC(C)(c1ccccc1)c1cc(-n2nc3ccccc3n2)c(O)c(C(C)(C)c2ccccc2)c1]

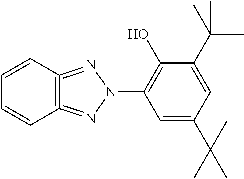

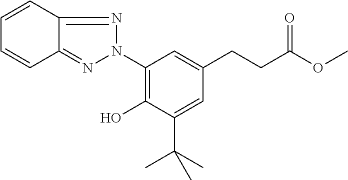 [SMILES: COC(=O)CCc1cc(-n2nc3ccccc3n2)c(O)c(C(C)(C)C)c1]

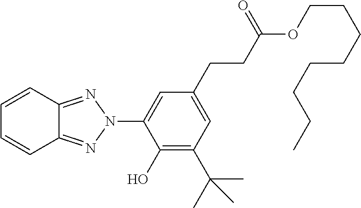 [SMILES: CCCCCCCCOC(=O)CCc1cc(-n2nc3ccccc3n2)c(O)c(C(C)(C)C)c1]

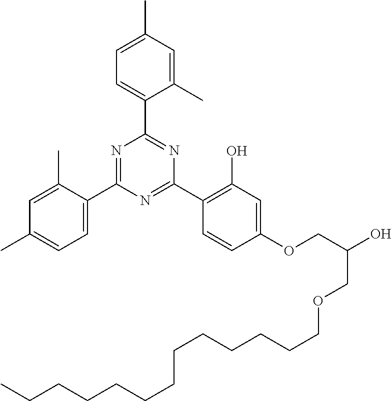 [SMILES: CCCCCCCCCCCCCOCC(O)COc1ccc(-c2nc(-c3ccc(C)cc3C)nc(-c3ccc(C)cc3C)n2)c(O)c1]

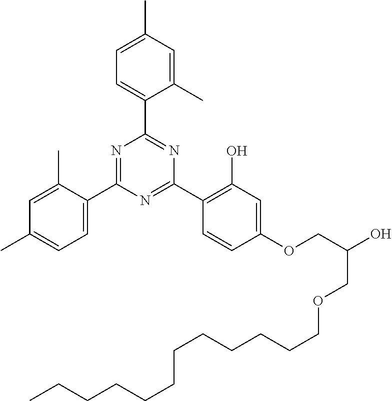 [SMILES: CCCCCCCCCCCCOCC(O)COc1ccc(-c2nc(-c3ccc(C)cc3C)nc(-c3ccc(C)cc3C)n2)c(O)c1]

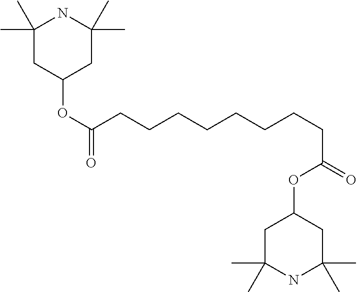

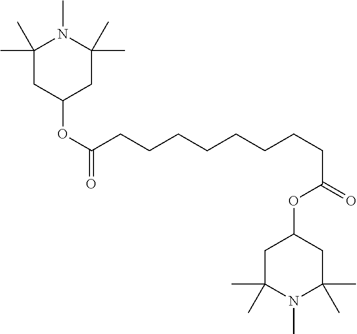

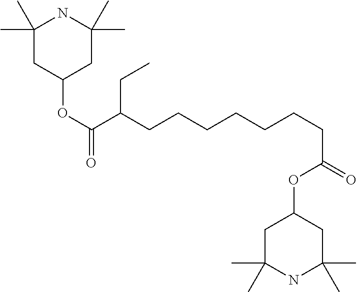

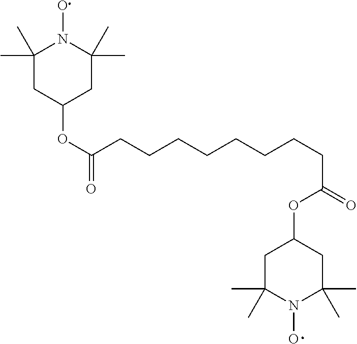

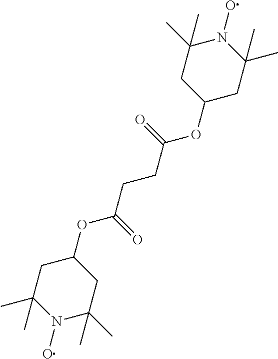

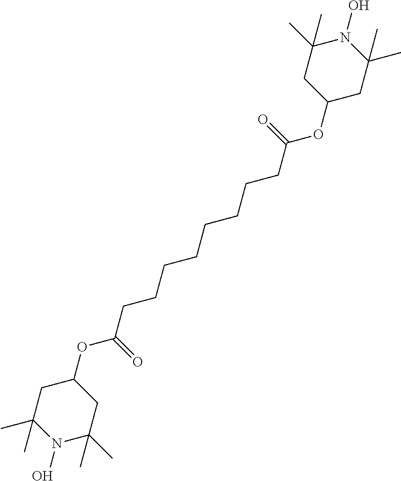

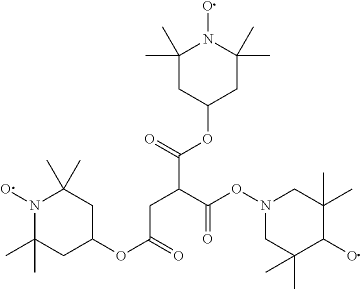

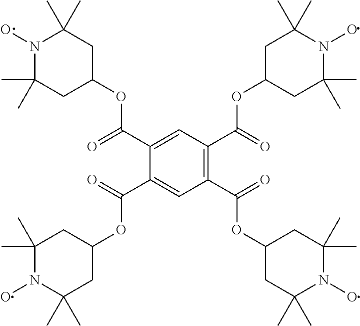

TABLE E
Table E collates example compounds which can be used in the LC media
according to the present invention, preferably as reactive mesogenic
compounds. If the mixtures according to the invention contain one or more
reactive compounds, they are preferably used in amounts of 0.01% to 5% by
weight. It may be necessary to add an initiator or a mixture of two or more
initiators for the polymerization. The initiator or initiator mixture is preferably
added in amounts of 0.001% to 2% by weight, based on the mixture. A
suitable initiator is, for example, Irgacure ®651 (from BASF).

| | |
|---|---|
| 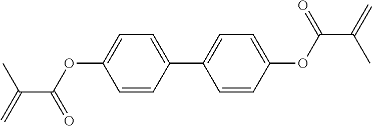 [SMILES: C=C(C)C(=O)Oc1ccc(-c2ccc(OC(=O)C(=C)C)cc2)cc1] | RM-1 |
| 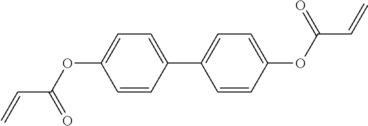 [SMILES: C=CC(=O)Oc1ccc(-c2ccc(OC(=O)C=C)cc2)cc1] | RM-2 |
| 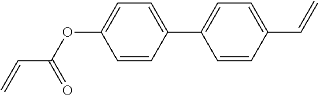 [SMILES: C=CC(=O)Oc1ccc(-c2ccc(C=C)cc2)cc1] | RM-3 |
| 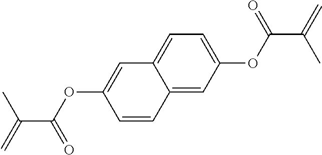 [SMILES: C=C(C)C(=O)Oc1ccc2cc(OC(=O)C(=C)C)ccc2c1] | RM-4 |
| 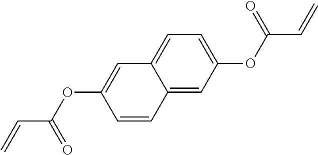 [SMILES: C=CC(=O)Oc1ccc2cc(OC(=O)C=C)ccc2c1] | RM-5 |
| 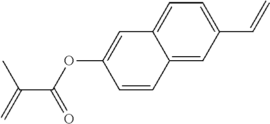 [SMILES: C=Cc1ccc2cc(OC(=O)C(=C)C)ccc2c1] | RM-6 |
| 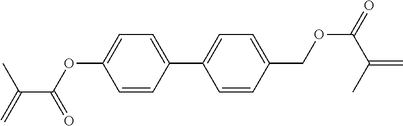 [SMILES: C=C(C)C(=O)OCc1ccc(-c2ccc(OC(=O)C(=C)C)cc2)cc1] | RM-7 |
| 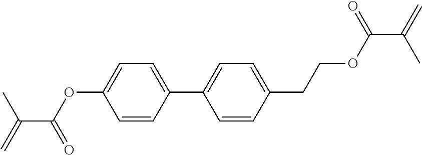 [SMILES: C=C(C)C(=O)OCCc1ccc(-c2ccc(OC(=O)C(=C)C)cc2)cc1] | RM-8 |
| 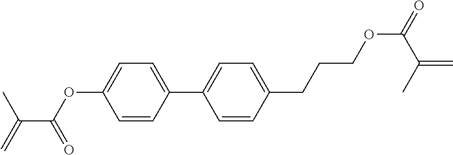 [SMILES: C=C(C)C(=O)OCCCc1ccc(-c2ccc(OC(=O)C(=C)C)cc2)cc1] | RM-9 |
| 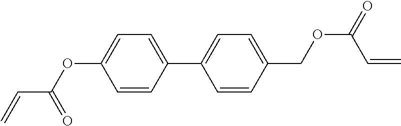 [SMILES: C=CC(=O)OCc1ccc(-c2ccc(OC(=O)C=C)cc2)cc1] | RM-10 |
| 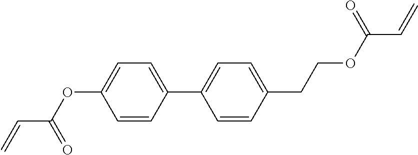 [SMILES: C=CC(=O)OCCc1ccc(-c2ccc(OC(=O)C=C)cc2)cc1] | RM-11 |
| 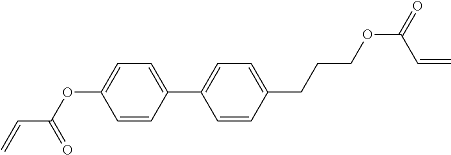 [SMILES: C=CC(=O)OCCCc1ccc(-c2ccc(OC(=O)C=C)cc2)cc1] | RM-12 |
| 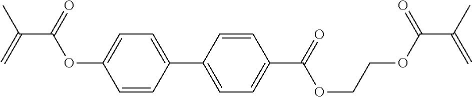 [SMILES: C=C(C)C(=O)OCCOC(=O)c1ccc(-c2ccc(OC(=O)C(=C)C)cc2)cc1] | RM-13 |
| 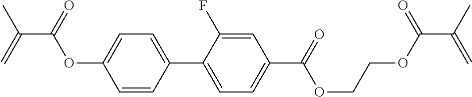 [SMILES: C=C(C)C(=O)OCCOC(=O)c1ccc(-c2ccc(OC(=O)C(=C)C)cc2)c(F)c1] | RM-14 |
| 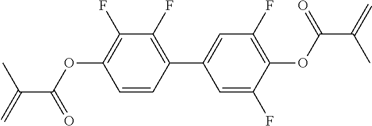 [SMILES: C=C(C)C(=O)Oc1ccc(-c2cc(F)c(OC(=O)C(=C)C)c(F)c2)c(F)c1F] | RM-15 |
| 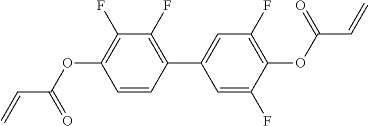 [SMILES: C=CC(=O)Oc1ccc(-c2cc(F)c(OC(=O)C=C)c(F)c2)c(F)c1F] | RM-16 |
| 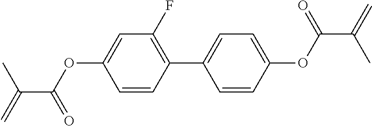 [SMILES: C=C(C)C(=O)Oc1ccc(-c2ccc(OC(=O)C(=C)C)cc2F)cc1] | RM-17 |
| 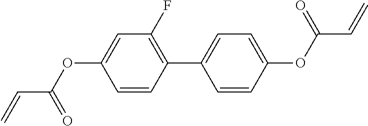 [SMILES: C=CC(=O)Oc1ccc(-c2ccc(OC(=O)C=C)cc2F)cc1] | RM-18 |
| 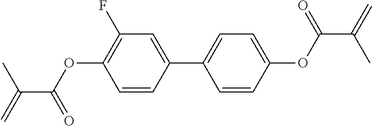 [SMILES: C=C(C)C(=O)Oc1ccc(-c2ccc(OC(=O)C(=C)C)c(F)c2)cc1] | RM-19 |
| 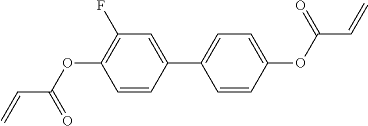 [SMILES: C=CC(=O)Oc1ccc(-c2ccc(OC(=O)C=C)c(F)c2)cc1] | RM-20 |
| 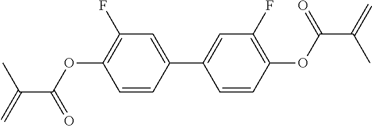 [SMILES: C=C(C)C(=O)Oc1ccc(-c2ccc(OC(=O)C(=C)C)c(F)c2)cc1F] | RM-21 |
| 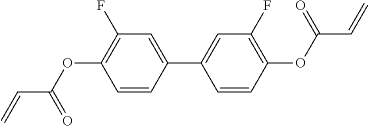 [SMILES: C=CC(=O)Oc1ccc(-c2ccc(OC(=O)C=C)c(F)c2)cc1F] | RM-22 |
| 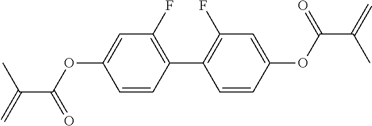 [SMILES: C=C(C)C(=O)Oc1ccc(-c2ccc(OC(=O)C(=C)C)cc2F)c(F)c1] | RM-23 |
| 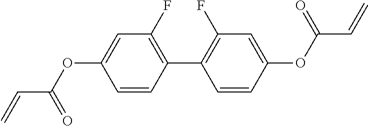 [SMILES: C=CC(=O)Oc1ccc(-c2ccc(OC(=O)C=C)cc2F)c(F)c1] | RM-24 |
| 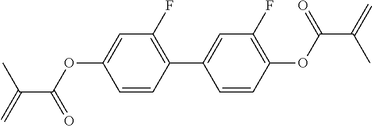 [SMILES: C=C(C)C(=O)Oc1ccc(-c2ccc(OC(=O)C(=C)C)c(F)c2)c(F)c1] | RM-25 |
| 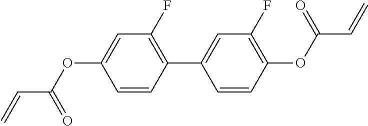 [SMILES: C=CC(=O)Oc1ccc(-c2ccc(OC(=O)C=C)c(F)c2)c(F)c1] | RM-26 |
| 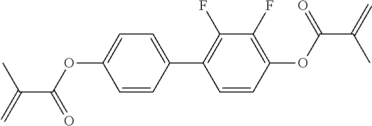 [SMILES: C=C(C)C(=O)Oc1ccc(-c2ccc(OC(=O)C(=C)C)c(F)c2F)cc1] | RM-27 |
| 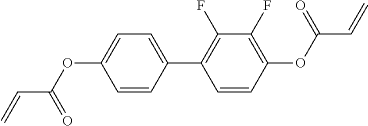 [SMILES: C=CC(=O)Oc1ccc(-c2ccc(OC(=O)C=C)c(F)c2F)cc1] | RM-28 |
| 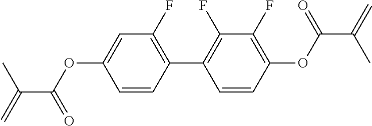 [SMILES: C=C(C)C(=O)Oc1ccc(-c2ccc(OC(=O)C(=C)C)c(F)c2F)c(F)c1] | RM-29 |
| 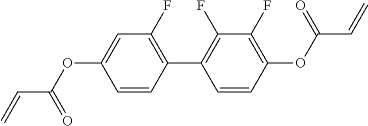 [SMILES: C=CC(=O)Oc1ccc(-c2ccc(OC(=O)C=C)c(F)c2F)c(F)c1] | RM-30 |
| 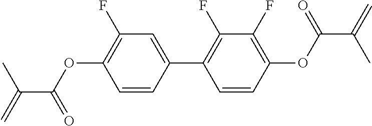 [SMILES: C=C(C)C(=O)Oc1ccc(-c2ccc(OC(=O)C(=C)C)c(F)c2F)cc1F] | RM-31 |
| 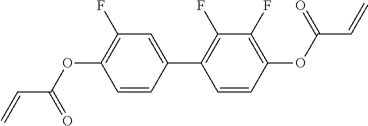 [SMILES: C=CC(=O)Oc1ccc(-c2ccc(OC(=O)C=C)c(F)c2F)cc1F] | RM-32 |
| 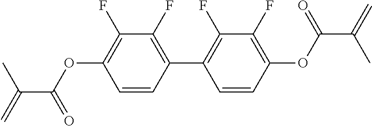 [SMILES: C=C(C)C(=O)Oc1ccc(-c2ccc(OC(=O)C(=C)C)c(F)c2F)c(F)c1F] | RM-33 |
| 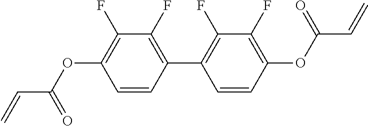 [SMILES: C=CC(=O)Oc1ccc(-c2ccc(OC(=O)C=C)c(F)c2F)c(F)c1F] | RM-34 |
| 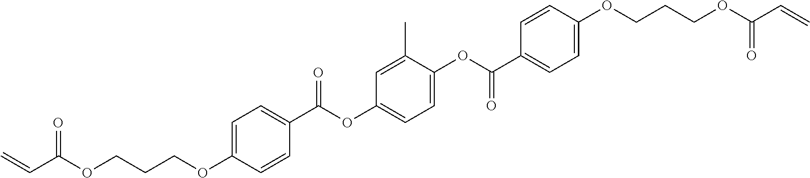 [SMILES: C=CC(=O)OCCCOc1ccc(C(=O)Oc2ccc(OC(=O)c3ccc(OCCCOC(=O)C=C)cc3)c(C)c2)cc1] | RM-35 |
| 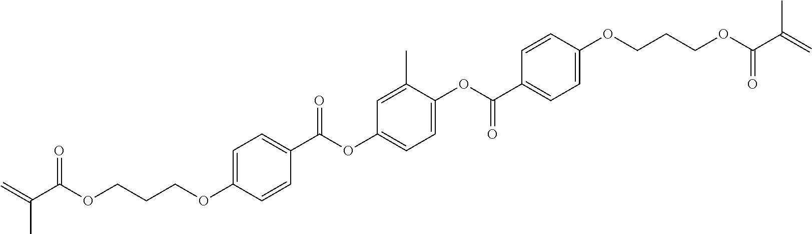 [SMILES: C=C(C)C(=O)OCCCOc1ccc(C(=O)Oc2ccc(OC(=O)c3ccc(OCCCOC(=O)C(=C)C)cc3)c(C)c2)cc1] | RM-36 |
| 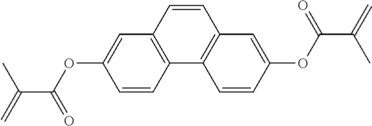 [SMILES: C=C(C)C(=O)Oc1ccc2c(ccc3cc(OC(=O)C(=C)C)ccc32)c1] | RM-37 |
| 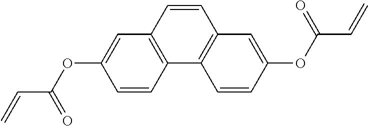 [SMILES: C=CC(=O)Oc1ccc2c(ccc3cc(OC(=O)C=C)ccc32)c1] | RM-38 |
| 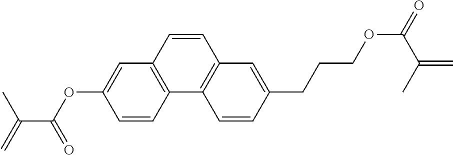 [SMILES: C=C(C)C(=O)OCCCc1ccc2c(ccc3cc(OC(=O)C(=C)C)ccc32)c1] | RM-39 |
| 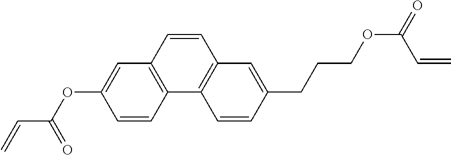 [SMILES: C=CC(=O)OCCCc1ccc2c(ccc3cc(OC(=O)C=C)ccc32)c1] | RM-40 |
| 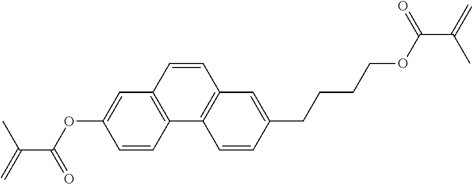 [SMILES: C=C(C)C(=O)OCCCCc1ccc2c(ccc3cc(OC(=O)C(=C)C)ccc32)c1] | RM-41 |
| 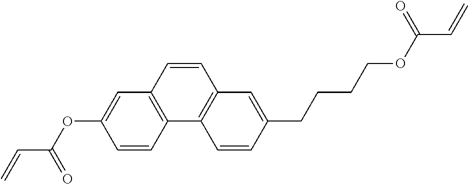 [SMILES: C=CC(=O)OCCCCc1ccc2c(ccc3cc(OC(=O)C=C)ccc32)c1] | RM-42 |
| 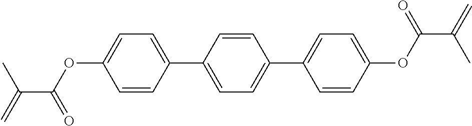 [SMILES: C=C(C)C(=O)Oc1ccc(-c2ccc(-c3ccc(OC(=O)C(=C)C)cc3)cc2)cc1] | RM-43 |
| 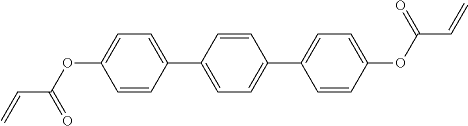 [SMILES: C=CC(=O)Oc1ccc(-c2ccc(-c3ccc(OC(=O)C=C)cc3)cc2)cc1] | RM-44 |
| 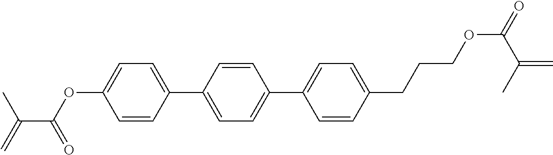 [SMILES: C=C(C)C(=O)OCCCc1ccc(-c2ccc(-c3ccc(OC(=O)C(=C)C)cc3)cc2)cc1] | RM-45 |
| 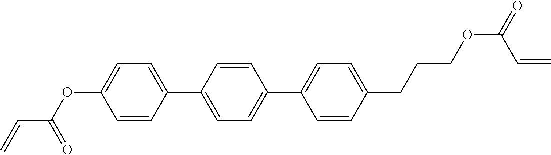 [SMILES: C=CC(=O)OCCCc1ccc(-c2ccc(-c3ccc(OC(=O)C=C)cc3)cc2)cc1] | RM-46 |
| 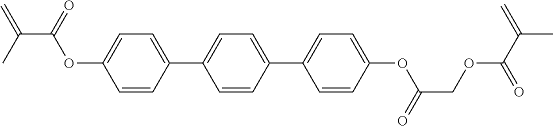 [SMILES: C=C(C)C(=O)OCC(=O)Oc1ccc(-c2ccc(-c3ccc(OC(=O)C(=C)C)cc3)cc2)cc1] | RM-47 |
| 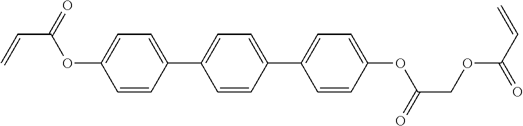 [SMILES: C=CC(=O)OCC(=O)Oc1ccc(-c2ccc(-c3ccc(OC(=O)C=C)cc3)cc2)cc1] | RM-48 |
| 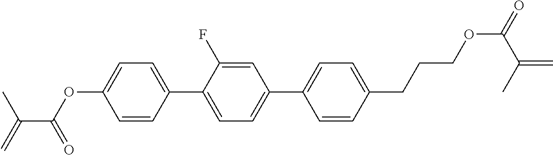 [SMILES: C=C(C)C(=O)OCCCc1ccc(-c2ccc(-c3ccc(OC(=O)C(=C)C)cc3)c(F)c2)cc1] | RM-49 |
| 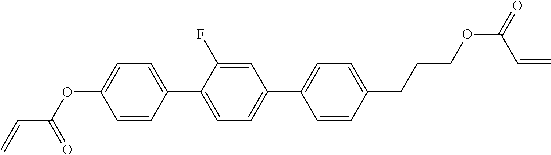 [SMILES: C=CC(=O)OCCCc1ccc(-c2ccc(-c3ccc(OC(=O)C=C)cc3)c(F)c2)cc1] | RM-50 |
| 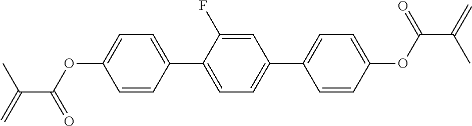 [SMILES: C=C(C)C(=O)Oc1ccc(-c2ccc(-c3ccc(OC(=O)C(=C)C)cc3)c(F)c2)cc1] | RM-51 |
| 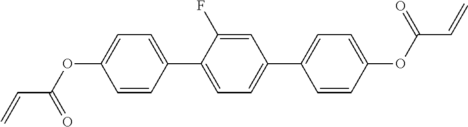 [SMILES: C=CC(=O)Oc1ccc(-c2ccc(-c3ccc(OC(=O)C=C)cc3)c(F)c2)cc1] | RM-52 |
| 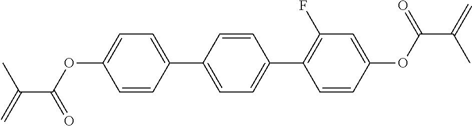 [SMILES: C=C(C)C(=O)Oc1ccc(-c2ccc(-c3ccc(OC(=O)C(=C)C)cc3F)cc2)cc1] | RM-53 |
| 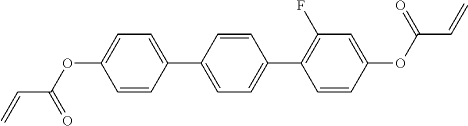 [SMILES: C=CC(=O)Oc1ccc(-c2ccc(-c3ccc(OC(=O)C=C)cc3F)cc2)cc1] | RM-54 |
| 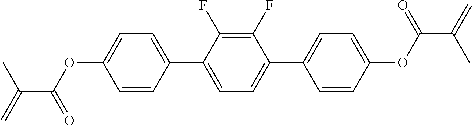 [SMILES: C=C(C)C(=O)Oc1ccc(-c2ccc(-c3ccc(OC(=O)C(=C)C)cc3)c(F)c2F)cc1] | RM-55 |
| 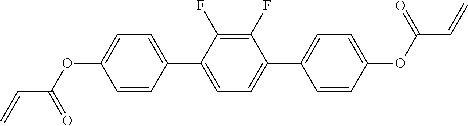 [SMILES: C=CC(=O)Oc1ccc(-c2ccc(-c3ccc(OC(=O)C=C)cc3)c(F)c2F)cc1] | RM-56 |
| 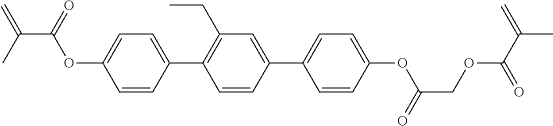 [SMILES: C=C(C)C(=O)OCC(=O)Oc1ccc(-c2ccc(-c3ccc(OC(=O)C(=C)C)cc3)c(CC)c2)cc1] | RM-57 |
| 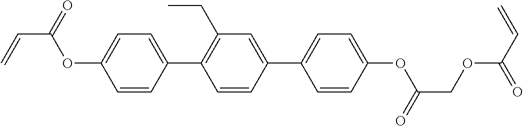 [SMILES: C=CC(=O)OCC(=O)Oc1ccc(-c2ccc(-c3ccc(OC(=O)C=C)cc3)c(CC)c2)cc1] | RM-58 |
| 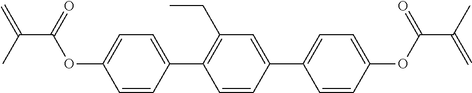 [SMILES: C=C(C)C(=O)Oc1ccc(-c2ccc(-c3ccc(OC(=O)C(=C)C)cc3)c(CC)c2)cc1] | RM-59 |
| 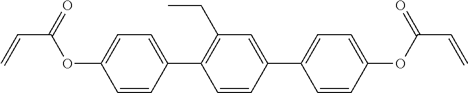 [SMILES: C=CC(=O)Oc1ccc(-c2ccc(-c3ccc(OC(=O)C=C)cc3)c(CC)c2)cc1] | RM-60 |
| 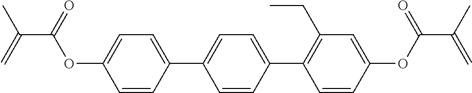 [SMILES: C=C(C)C(=O)Oc1ccc(-c2ccc(-c3ccc(OC(=O)C(=C)C)cc3CC)cc2)cc1] | RM-61 |
| 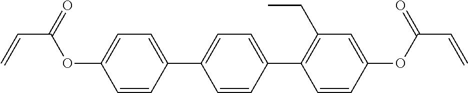 [SMILES: C=CC(=O)Oc1ccc(-c2ccc(-c3ccc(OC(=O)C=C)cc3CC)cc2)cc1] | RM-62 |
| 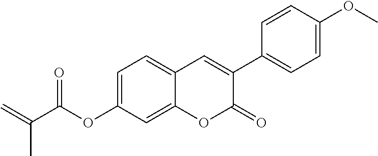 [SMILES: C=C(C)C(=O)Oc1ccc2cc(-c3ccc(OC)cc3)c(=O)oc2c1] | RM-63 |
| 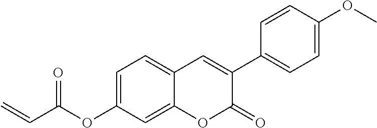 [SMILES: C=CC(=O)Oc1ccc2cc(-c3ccc(OC)cc3)c(=O)oc2c1] | RM-64 |
| 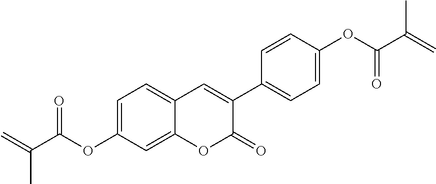 [SMILES: C=C(C)C(=O)Oc1ccc(-c2cc3ccc(OC(=O)C(=C)C)cc3oc2=O)cc1] | RM-65 |
| 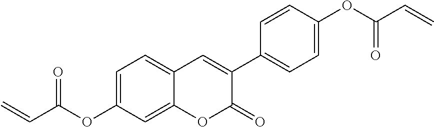 [SMILES: C=CC(=O)Oc1ccc(-c2cc3ccc(OC(=O)C=C)cc3oc2=O)cc1] | RM-66 |
| 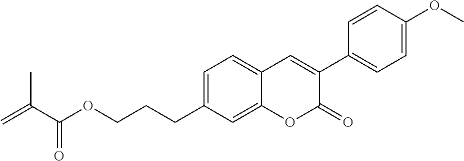 [SMILES: C=C(C)C(=O)OCCCc1ccc2cc(-c3ccc(OC)cc3)c(=O)oc2c1] | RM-67 |
| 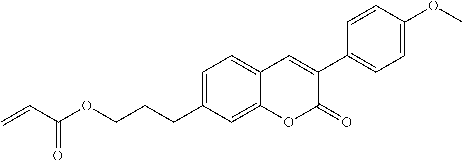 [SMILES: C=CC(=O)OCCCc1ccc2cc(-c3ccc(OC)cc3)c(=O)oc2c1] | RM-68 |
| 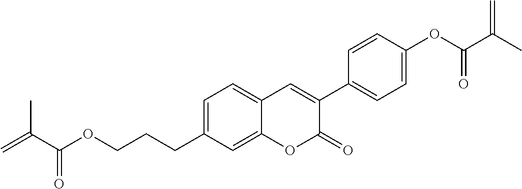 [SMILES: C=C(C)C(=O)OCCCc1ccc2cc(-c3ccc(OC(=O)C(=C)C)cc3)c(=O)oc2c1] | RM-69 |
| 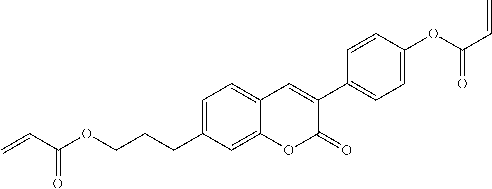 [SMILES: C=CC(=O)OCCCc1ccc2cc(-c3ccc(OC(=O)C=C)cc3)c(=O)oc2c1] | RM-70 |
| 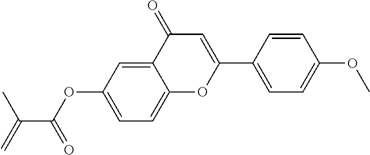 [SMILES: C=C(C)C(=O)Oc1ccc2oc(-c3ccc(OC)cc3)cc(=O)c2c1] | RM-71 |
| 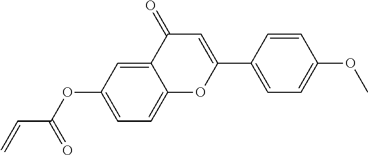 [SMILES: C=CC(=O)Oc1ccc2oc(-c3ccc(OC)cc3)cc(=O)c2c1] | RM-72 |
| 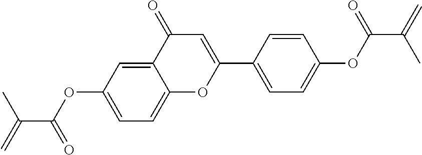 [SMILES: C=C(C)C(=O)Oc1ccc(-c2cc(=O)c3cc(OC(=O)C(=C)C)ccc3o2)cc1] | RM-73 |
| 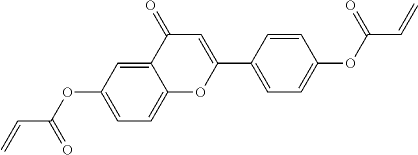 [SMILES: C=CC(=O)Oc1ccc(-c2cc(=O)c3cc(OC(=O)C=C)ccc3o2)cc1] | RM-74 |
| 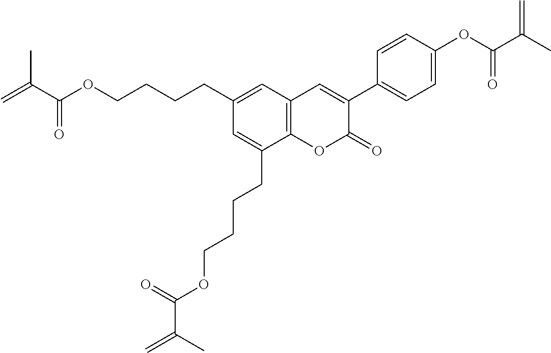 [SMILES: C=C(C)C(=O)OCCCCc1cc(CCCCOC(=O)C(=C)C)c2oc(=O)c(-c3ccc(OC(=O)C(=C)C)cc3)cc2c1] | RM-75 |
| 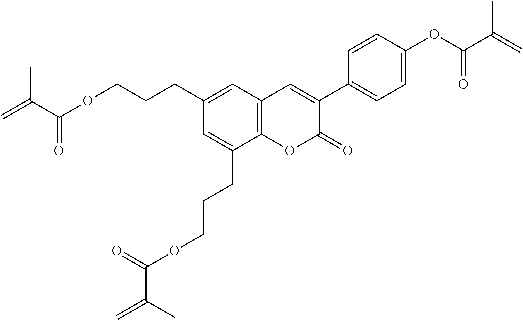 [SMILES: C=C(C)C(=O)OCCCc1cc(CCCOC(=O)C(=C)C)c2oc(=O)c(-c3ccc(OC(=O)C(=C)C)cc3)cc2c1] | RM-76 |
| 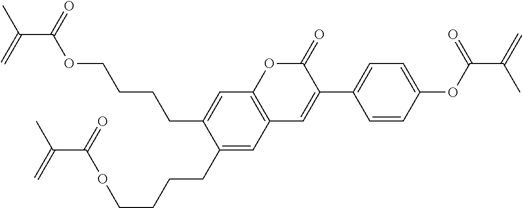 [SMILES: C=C(C)C(=O)OCCCCc1cc2cc(-c3ccc(OC(=O)C(=C)C)cc3)c(=O)oc2cc1CCCCOC(=O)C(=C)C] | RM-77 |
| 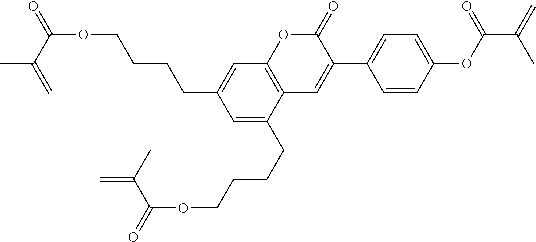 [SMILES: C=C(C)C(=O)OCCCCc1cc(CCCCOC(=O)C(=C)C)c2cc(-c3ccc(OC(=O)C(=C)C)cc3)c(=O)oc2c1] | RM-78 |
| 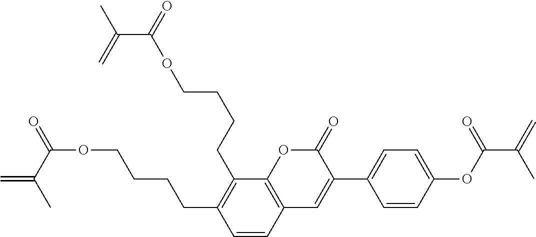 [SMILES: C=C(C)C(=O)OCCCCc1ccc2cc(-c3ccc(OC(=O)C(=C)C)cc3)c(=O)oc2c1CCCCOC(=O)C(=C)C] | RM-79 |
| 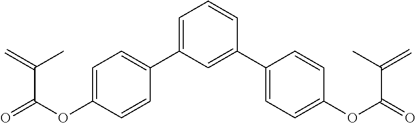 [SMILES: C=C(C)C(=O)Oc1ccc(-c2cccc(-c3ccc(OC(=O)C(=C)C)cc3)c2)cc1] | RM-80 |
| 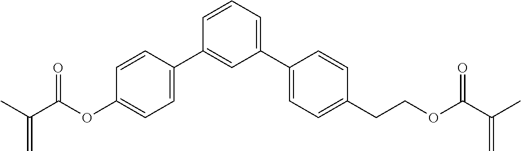 [SMILES: C=C(C)C(=O)OCCc1ccc(-c2cccc(-c3ccc(OC(=O)C(=C)C)cc3)c2)cc1] | RM-81 |
| 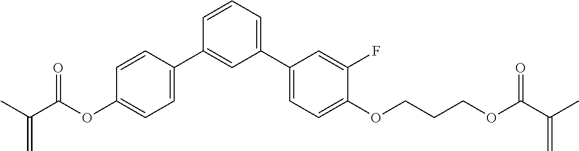 [SMILES: C=C(C)C(=O)OCCCOc1ccc(-c2cccc(-c3ccc(OC(=O)C(=C)C)cc3)c2)cc1F] | RM-82 |
| 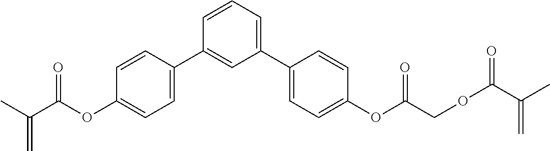 [SMILES: C=C(C)C(=O)OCC(=O)Oc1ccc(-c2cccc(-c3ccc(OC(=O)C(=C)C)cc3)c2)cc1] | RM-83 |
| 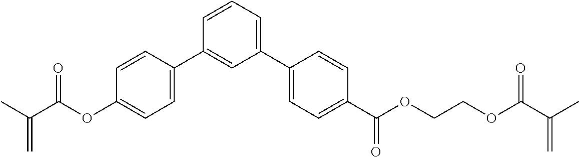 [SMILES: C=C(C)C(=O)OCCOC(=O)c1ccc(-c2cccc(-c3ccc(OC(=O)C(=C)C)cc3)c2)cc1] | RM-84 |
| 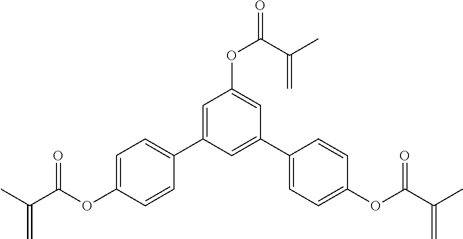 [SMILES: C=C(C)C(=O)Oc1ccc(-c2cc(OC(=O)C(=C)C)cc(-c3ccc(OC(=O)C(=C)C)cc3)c2)cc1] | RM-85 |
| 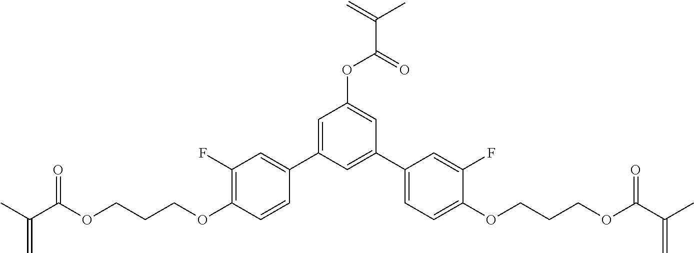 [SMILES: C=C(C)C(=O)OCCCOc1ccc(-c2cc(OC(=O)C(=C)C)cc(-c3ccc(OCCCOC(=O)C(=C)C)c(F)c3)c2)cc1F] | RM-86 |
| 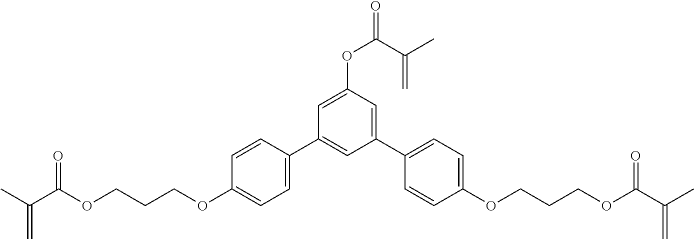 [SMILES: C=C(C)C(=O)OCCCOc1ccc(-c2cc(OC(=O)C(=C)C)cc(-c3ccc(OCCCOC(=O)C(=C)C)cc3)c2)cc1] | RM-87 |
| 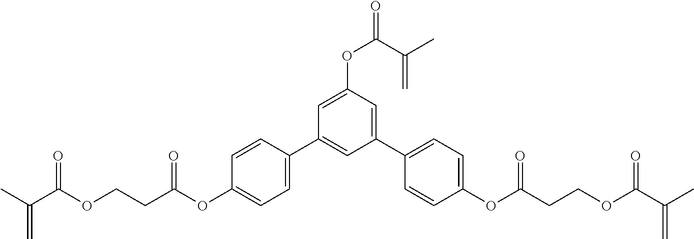 [SMILES: C=C(C)C(=O)OCCC(=O)Oc1ccc(-c2cc(OC(=O)C(=C)C)cc(-c3ccc(OC(=O)CCOC(=O)C(=C)C)cc3)c2)cc1] | RM-88 |
| 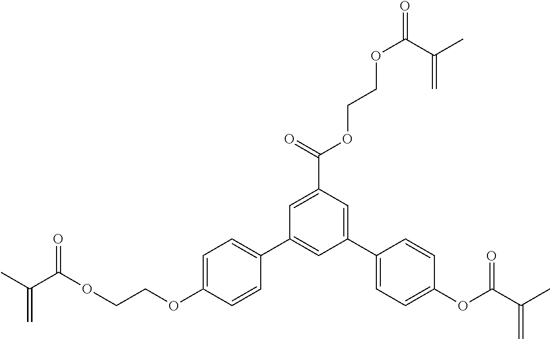 [SMILES: C=C(C)C(=O)OCCOC(=O)c1cc(-c2ccc(OCCOC(=O)C(=C)C)cc2)cc(-c2ccc(OC(=O)C(=C)C)cc2)c1] | RM-89 |
| 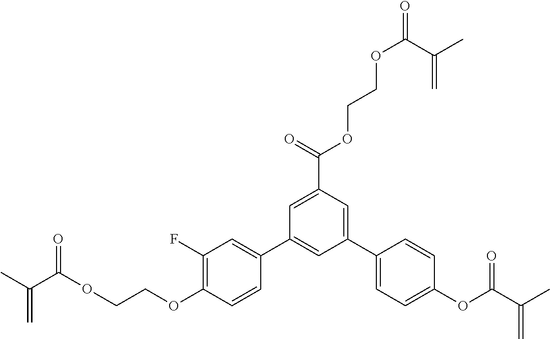 [SMILES: C=C(C)C(=O)OCCOC(=O)c1cc(-c2ccc(OC(=O)C(=C)C)cc2)cc(-c2ccc(OCCOC(=O)C(=C)C)c(F)c2)c1] | RM-90 |
| 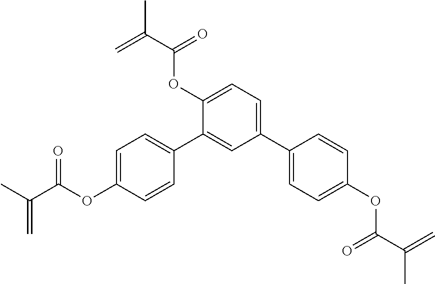 [SMILES: C=C(C)C(=O)Oc1ccc(-c2ccc(OC(=O)C(=C)C)c(-c3ccc(OC(=O)C(=C)C)cc3)c2)cc1] | RM-91 |
| 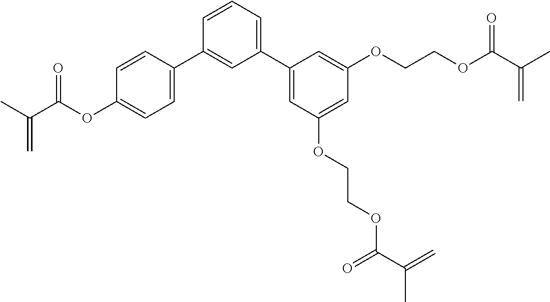 [SMILES: C=C(C)C(=O)OCCOc1cc(OCCOC(=O)C(=C)C)cc(-c2cccc(-c3ccc(OC(=O)C(=C)C)cc3)c2)c1] | RM-92 |
| 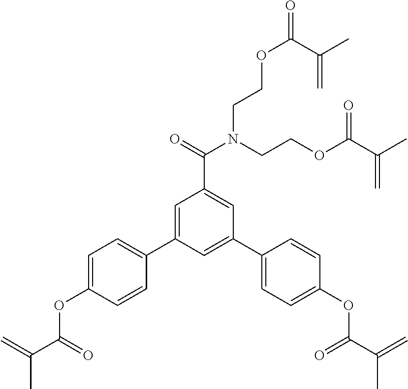 [SMILES: C=C(C)C(=O)OCCN(CCOC(=O)C(=C)C)C(=O)c1cc(-c2ccc(OC(=O)C(=C)C)cc2)cc(-c2ccc(OC(=O)C(=C)C)cc2)c1] | RM-93 |
| 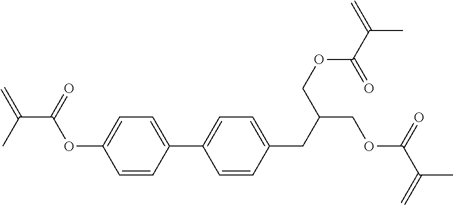 [SMILES: C=C(C)C(=O)OCC(COC(=O)C(=C)C)Cc1ccc(-c2ccc(OC(=O)C(=C)C)cc2)cc1] | RM-94 |
| 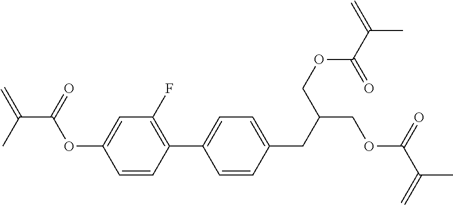 [SMILES: C=C(C)C(=O)OCC(COC(=O)C(=C)C)Cc1ccc(-c2ccc(OC(=O)C(=C)C)cc2F)cc1] | RM-95 |
| 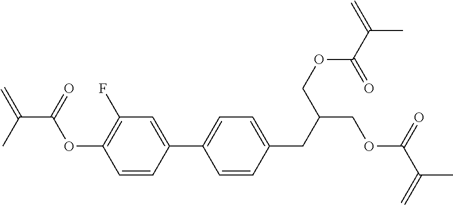 [SMILES: C=C(C)C(=O)OCC(COC(=O)C(=C)C)Cc1ccc(-c2ccc(OC(=O)C(=C)C)c(F)c2)cc1] | RM-96 |
| 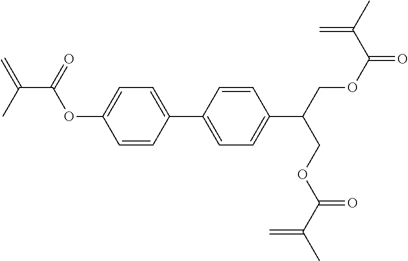 [SMILES: C=C(C)C(=O)OCC(COC(=O)C(=C)C)c1ccc(-c2ccc(OC(=O)C(=C)C)cc2)cc1] | RM-97 |
| 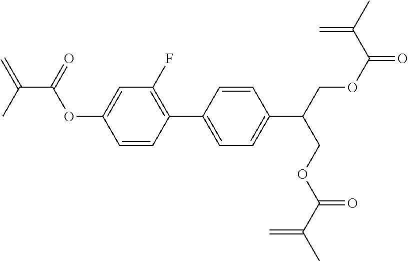 [SMILES: C=C(C)C(=O)OCC(COC(=O)C(=C)C)c1ccc(-c2ccc(OC(=O)C(=C)C)cc2F)cc1] | RM-98 |
| 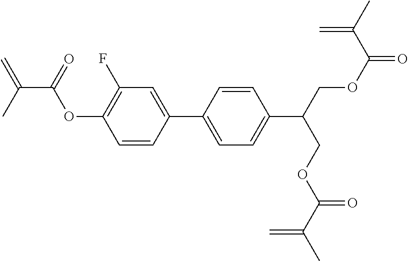 [SMILES: C=C(C)C(=O)OCC(COC(=O)C(=C)C)c1ccc(-c2ccc(OC(=O)C(=C)C)c(F)c2)cc1] | RM-99 |
| 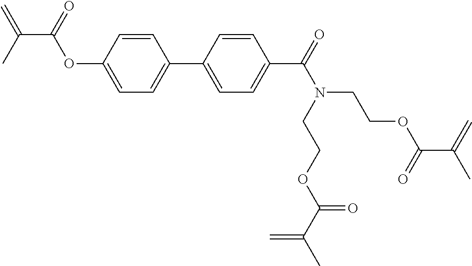 [SMILES: C=C(C)C(=O)OCCN(CCOC(=O)C(=C)C)C(=O)c1ccc(-c2ccc(OC(=O)C(=C)C)cc2)cc1] | RM-100 |
| 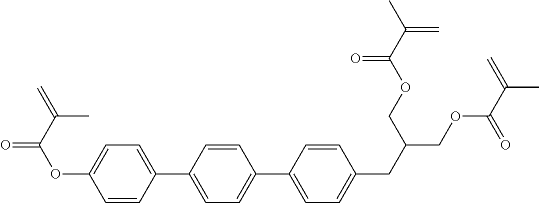 [SMILES: C=C(C)C(=O)OCC(COC(=O)C(=C)C)Cc1ccc(-c2ccc(-c3ccc(OC(=O)C(=C)C)cc3)cc2)cc1] | RM-101 |
| 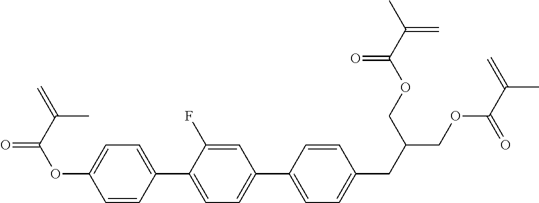 [SMILES: C=C(C)C(=O)OCC(COC(=O)C(=C)C)Cc1ccc(-c2ccc(-c3ccc(OC(=O)C(=C)C)cc3)c(F)c2)cc1] | RM-102 |
| 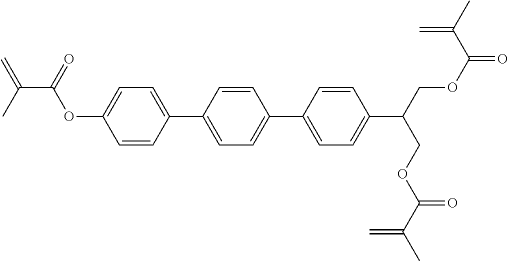 [SMILES: C=C(C)C(=O)OCC(COC(=O)C(=C)C)c1ccc(-c2ccc(-c3ccc(OC(=O)C(=C)C)cc3)cc2)cc1] | RM-103 |
| 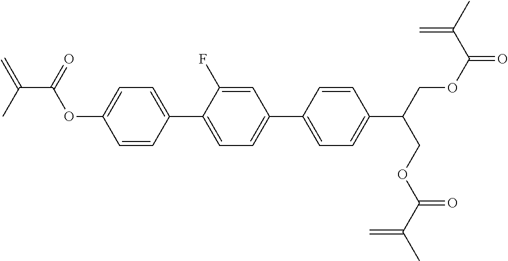 [SMILES: C=C(C)C(=O)OCC(COC(=O)C(=C)C)c1ccc(-c2ccc(-c3ccc(OC(=O)C(=C)C)cc3)c(F)c2)cc1] | RM-104 |
| 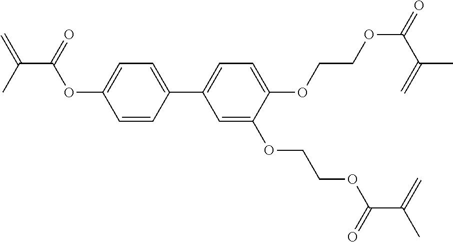 [SMILES: C=C(C)C(=O)OCCOc1ccc(-c2ccc(OC(=O)C(=C)C)cc2)cc1OCCOC(=O)C(=C)C] | RM-105 |
| 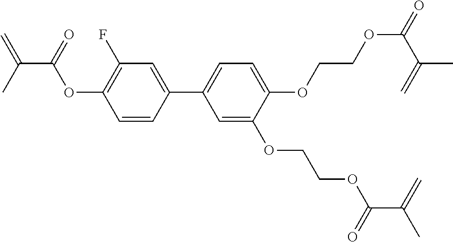 [SMILES: C=C(C)C(=O)OCCOc1ccc(-c2ccc(OC(=O)C(=C)C)c(F)c2)cc1OCCOC(=O)C(=C)C] | RM-106 |
| 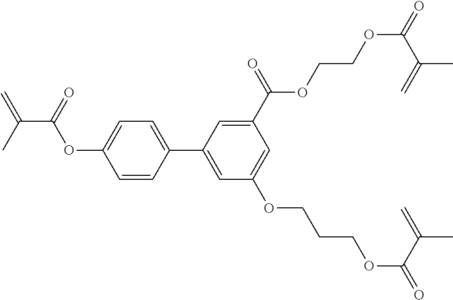 [SMILES: C=C(C)C(=O)OCCCOc1cc(C(=O)OCCOC(=O)C(=C)C)cc(-c2ccc(OC(=O)C(=C)C)cc2)c1] | RM-107 |
| 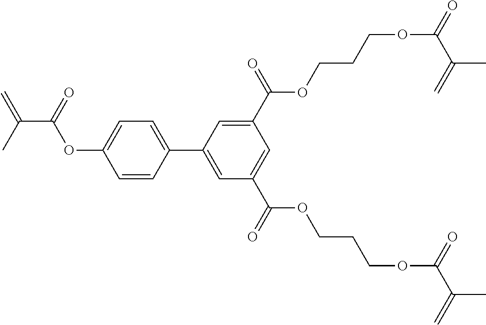 [SMILES: C=C(C)C(=O)OCCCOC(=O)c1cc(C(=O)OCCCOC(=O)C(=C)C)cc(-c2ccc(OC(=O)C(=C)C)cc2)c1] | RM-108 |
| 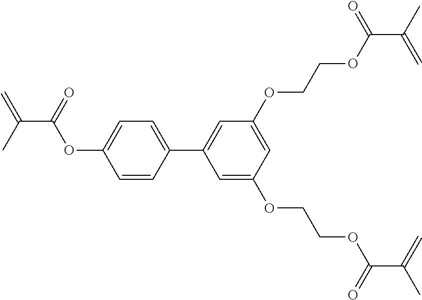 [SMILES: C=C(C)C(=O)OCCOc1cc(OCCOC(=O)C(=C)C)cc(-c2ccc(OC(=O)C(=C)C)cc2)c1] | RM-109 |
| 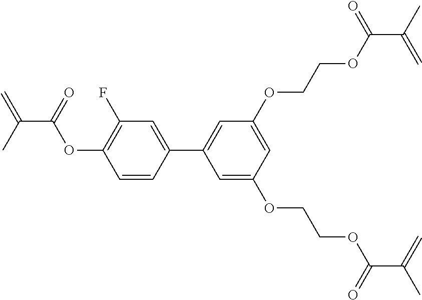 [SMILES: C=C(C)C(=O)OCCOc1cc(OCCOC(=O)C(=C)C)cc(-c2ccc(OC(=O)C(=C)C)c(F)c2)c1] | RM-110 |
| 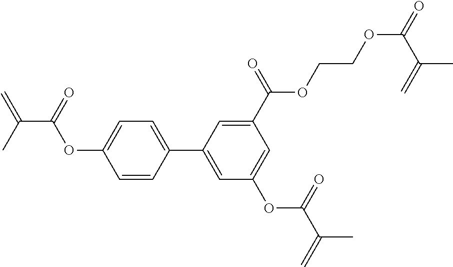 [SMILES: C=C(C)C(=O)OCCOC(=O)c1cc(OC(=O)C(=C)C)cc(-c2ccc(OC(=O)C(=C)C)cc2)c1] | RM-111 |
| 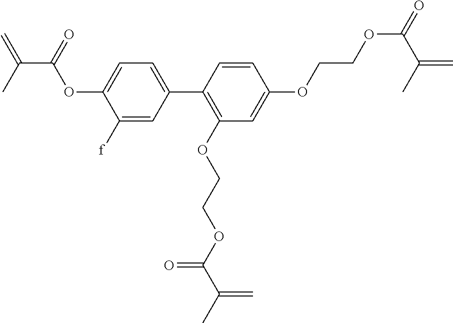 | RM-112 |
| 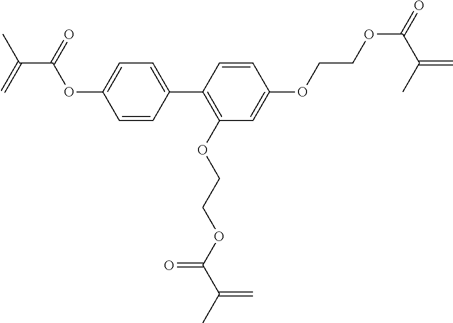 [SMILES: C=C(C)C(=O)OCCOc1ccc(-c2ccc(OC(=O)C(=C)C)cc2)c(OCCOC(=O)C(=C)C)c1] | RM-113 |
| 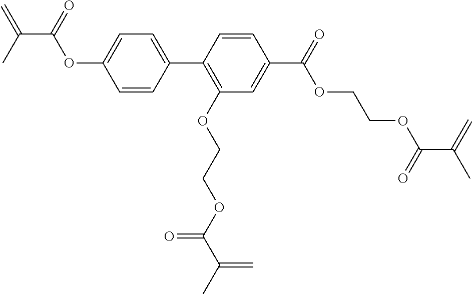 [SMILES: C=C(C)C(=O)OCCOC(=O)c1ccc(-c2ccc(OC(=O)C(=C)C)cc2)c(OCCOC(=O)C(=C)C)c1] | RM-114 |
| 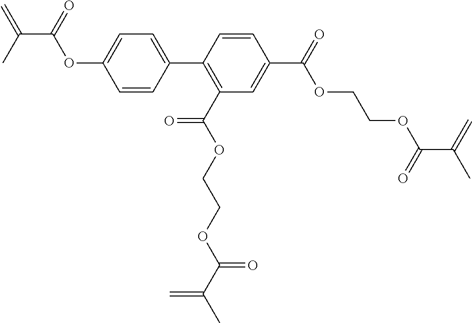 [SMILES: C=C(C)C(=O)OCCOC(=O)c1ccc(-c2ccc(OC(=O)C(=C)C)cc2)c(C(=O)OCCOC(=O)C(=C)C)c1] | RM-115 |
| 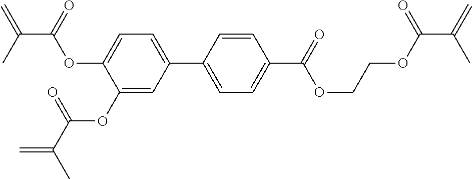 [SMILES: C=C(C)C(=O)OCCOC(=O)c1ccc(-c2ccc(OC(=O)C(=C)C)c(OC(=O)C(=C)C)c2)cc1] | RM-116 |
| 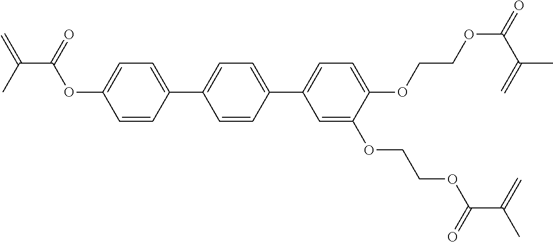 [SMILES: C=C(C)C(=O)OCCOc1ccc(-c2ccc(-c3ccc(OC(=O)C(=C)C)cc3)cc2)cc1OCCOC(=O)C(=C)C] | RM-117 |
| 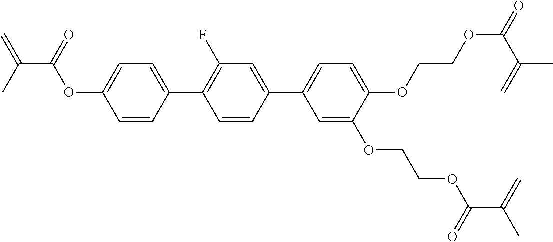 [SMILES: C=C(C)C(=O)OCCOc1ccc(-c2ccc(-c3ccc(OC(=O)C(=C)C)cc3)c(F)c2)cc1OCCOC(=O)C(=C)C] | RM-118 |
| 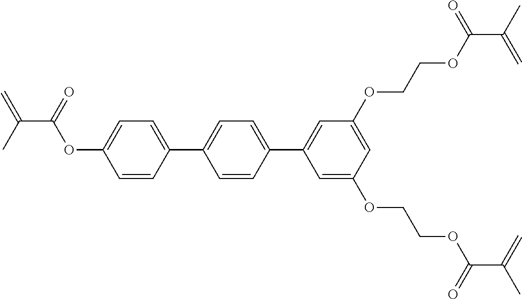 [SMILES: C=C(C)C(=O)OCCOc1cc(OCCOC(=O)C(=C)C)cc(-c2ccc(-c3ccc(OC(=O)C(=C)C)cc3)cc2)c1] | RM-119 |
| 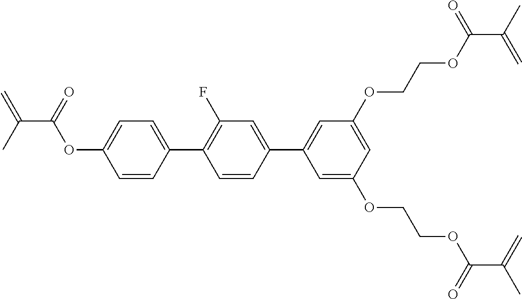 [SMILES: C=C(C)C(=O)OCCOc1cc(OCCOC(=O)C(=C)C)cc(-c2ccc(-c3ccc(OC(=O)C(=C)C)cc3)c(F)c2)c1] | RM-120 |
| 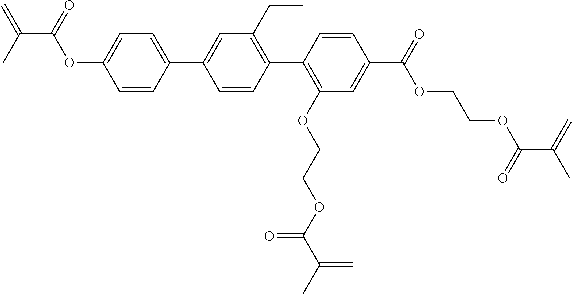 [SMILES: C=C(C)C(=O)OCCOC(=O)c1ccc(-c2ccc(-c3ccc(OC(=O)C(=C)C)cc3)cc2CC)c(OCCOC(=O)C(=C)C)c1] | RM-121 |

In a preferred embodiment of the present invention, the mesogenic media comprise one or more compounds selected from the group of the compounds from Table E.

The mixture examples which follow are intended to illustrate the invention without limiting it.

Percent figures above and below are percent by weight. All temperatures are reported in degrees Celsius. M.p. means melting point; C.p.=clearing point. In addition, C=crystalline state, N=nematic phase, S=smectic phase and I=isotropic phase. The figures between these symbols are the transition temperatures. In addition,
Δn means the optical anisotropy at 589 nm and 20° C.,
γ₁ means the rotational viscosity (mPa·s) at 20° C.,
Δ∈ means the dielectric anisotropy at 20° C. and 1 kHz (Δ∈=∈_{∥}−∈_{⊥}, where ∈₁₁ means the dielectric constant parallel to the longitudinal axes of the molecule and ∈_{⊥} means the dielectric constant at right angles thereto),
V₁₀ means the voltage (V) for 10% transmission (viewing direction at right angles to the plate surface) (threshold voltage), determined in a TN cell (90 degree twist) in the 1st minimum (i.e. at a d·Δn value of 0.5 μm) at 20° C.,
V₀ is the Fréedericksz threshold voltage determined by capacitative means in an antiparallel-rubbed cell at 20° C.

All physical properties are determined according to “Merck Liquid Crystals, Physical Properties of Liquid Crystals” Status November 1997, Merck KGaA, Germany and apply to a temperature of 20° C., unless explicitly stated otherwise.

### EXAMPLES

### Example 1

| | | | |
|---|---|---|---|
| APUQU-2-F | 4.00% | Clearing point/° C.: | 76 |
| APUQU-3-F | 7.00% | Δn (589 nm, 20° C.): | 0.1152 |
| CPGU-3-OT | 6.00% | Δε (1 kHz, 20° C.): | 4.2 |
| BCH-3F.F.F | 3.00% | γ₁ (20° C.)/mPa · s: | 53 |
| CCP-V-1 | 6.00% | V₁₀ (20° C.)/V: | 2.11 |
| PGP-2-4 | 7.00% | LTS bulk (−20° C.)/h: | >1000 |
| PGP-2-2V | 8.00% | | |
| CC-3-V | 51.00% | | |
| PP-1-2V1 | 8.00% | | |

### Comparative Example 1

| | | | |
|---|---|---|---|
| APUQU-2-F | 4.00% | Clearing point/° C.: | 75.5 |
| APUQU-3-F | 7.00% | Δn (589 nm, 20° C.): | 0.1157 |
| CPGU-3-OT | 6.00% | Δε (1 kHz, 20° C.): | 4.2 |
| BCH-3F.F.F | 3.00% | γ₁ (20° C.)/mPa · s: | 56 |
| CCP-V-1 | 6.00% | V₁₀ (20° C.)/V: | 2.10 |
| PGP-2-4 | 8.00% | LTS bulk (−20° C.)/h: | >1000 |
| PGP-2-5 | 8.00% | | |
| CC-3-V | 50.00% | | |
| PP-1-2V1 | 8.00% | | |

Compared to the mixture from Example 1, the mixture from Comparative Example 1 does not contain any compound of the formula 2 and has a higher viscosity.

### Example 2

| | | | |
|---|---|---|---|
| GGP-3-Cl | 8.00% | Clearing point/° C.: | 79 |
| CCGU-3-F | 8.00% | Δn (589 nm, 20° C.): | 0.1322 |
| CCP-V-1 | 8.00% | Δε (1 kHz, 20° C.): | 11.6 |
| CC-3-V | 26.00% | γ₁ (20° C.)/mPa · s: | 93 |
| CCQU-3-F | 9.00% | V₁₀ (20° C.)/V: | 1.30 |
| PUQU-3-F | 17.00% | LTS bulk (−20° C.)/h: | >1000 |
| PGP-2-4 | 5.00% | | |
| PGP-2-2V | 5.00% | | |
| PP-1-2V1 | 4.00% | | |
| APUQU-2-F | 10.00% | | |

### Comparative Example 2

| | | | |
|---|---|---|---|
| GGP-3-Cl | 8.00% | Clearing point/° C.: | 79 |
| CCGU-3-F | 8.00% | Δn (589 nm, 20° C.): | 0.1335 |
| CCP-V-1 | 8.00% | Δε (1 kHz, 20° C.): | 11.6 |
| CC-3-V | 25.00% | γ₁ (20° C.)/mPa · s: | 96 |
| CCQU-3-F | 9.00% | V₁₀ (20° C.)/V: | 1.32 |
| PUQU-3-F | 17.00% | LTS bulk (−20° C.)/h: | >1000 |
| PGP-2-4 | 6.00% | | |
| PGP-2-5 | 5.00% | | |
| PP-1-2V1 | 4.00% | | |
| APUQU-2-F | 10.00% | | |

Compared to the mixture from Example 2, the mixture from Comparative Example 2 does not contain any compound of the formula 2 and has a higher viscosity.

### Example 3

| | | | |
|---|---|---|---|
| CPGU-3-F | 6.00% | Clearing point/° C.: | 76.5 |
| CC-3-V | 32.50% | Δn (589 nm, 20° C.): | 0.1243 |
| CC-3-V1 | 6.00% | Δε (1 kHz, 20° C.): | 4.4 |
| CCP-V-1 | 18.00% | γ₁ (20° C.)/mPa · s: | 58 |
| PGP-2-4 | 6.00% | V₁₀ (20° C.)/V: | 2.04 |
| PGP-2-2V | 10.00% | LTS bulk (−20° C.)/h: | >1000 |
| PP-1-2V1 | 5.50% | | |
| PUQU-3-F | 14.00% | | |
| GP-2-Cl | 2.00% | | |

### Comparative Example 3

| | | | |
|---|---|---|---|
| CPGU-3-F | 6.00% | Clearing point/° C.: | 77.5 |
| CC-3-V | 32.00% | Δn (589 nm, 20° C.): | 0.1254 |
| CC-3-V1 | 6.00% | Δε (1 kHz, 20° C.): | 4.4 |
| CCP-V-1 | 18.00% | γ₁ (20° C.)/mPa · s: | 61 |
| PGP-2-3 | 6.00% | V₁₀ (20° C.)/V: | 2.06 |
| PGP-2-4 | 6.00% | LTS bulk (−20° C.)/h: | >1000 |
| PGP-2-5 | 6.00% | | |
| PP-1-2V1 | 4.00% | | |
| PUQU-3-F | 14.00% | | |
| GP-2-Cl | 2.00% | | |

Compared to the mixture from Example 3, the mixture from Comparative Example 3 does not contain any compound of the formula 2 and has a higher viscosity.

### Example 4

| | | | |
|---|---|---|---|
| CC-3-V | 35.00% | Clearing point/° C.: | 74 |
| CC-3-V1 | 8.00% | Δn (589 nm, 20° C.): | 0.1316 |
| CCP-V2-1 | 8.00% | Δε (1 kHz, 20° C.): | 4.4 |
| CPGU-3-OT | 5.50% | γ₁ (20° C.)/mPa · s: | 57 |
| PGP-2-3 | 4.00% | V₁₀ (20° C.)/V: | 2.13 |
| PGP-2-4 | 5.00% | LTS bulk (−20° C.)/h: | >1000 |
| PGP-2-2V | 6.50% | | |
| PGUQU-3-F | 8.00% | | |
| PP-1-2V1 | 8.00% | | |
| PP-2-2V1 | 7.00% | | |
| PUQU-3-F | 5.00% | | |

### Comparative Example 4

| | | | |
|---|---|---|---|
| CC-3-V | 34.00% | Clearing point/° C.: | 74 |
| CC-3-V1 | 8.00% | Δn (589 nm, 20° C.): | 0.1327 |
| CCP-V2-1 | 8.00% | Δε (1 kHz, 20° C.): | 4.4 |
| CPGU-3-OT | 5.50% | γ₁ (20° C.)/mPa · s: | 58 |
| PGP-2-3 | 4.00% | V₁₀ (20° C.)/V: | 2.14 |
| PGP-2-4 | 5.00% | LTS bulk (−20° C.)/h: | >1000 |
| PGP-2-5 | 7.50% | | |
| PGUQU-3-F | 8.00% | | |
| PP-1-2V1 | 8.00% | | |
| PP-2-2V1 | 7.00% | | |
| PUQU-3-F | 5.00% | | |

Compared to the mixture from Example 4, the mixture from Comparative Example 4 does not contain any compound of the formula 2 and has a higher viscosity.

### Example 5

| | | | |
|---|---|---|---|
| CC-3-V | 41.00% | Clearing point/° C.: | 75.4 |
| CC-3-V1 | 9.50% | Δn (589 nm, 20° C.): | 0.1370 |
| PP-1-2V1 | 5.00% | Δε (1 kHz, 20° C.): | 5.4 |
| PGU-3-F | 11.00% | γ₁ (20° C.)/mPa · s: | 58 |
| PGP-2-3 | 4.00% | V₁₀ (20° C.)/V: | 1.92 |
| PGP-2-4 | 4.00% | | |
| PGP-2-5 | 5.00% | | |
| PGP-1-2V | 7.50% | | |
| CPGU-3-OT | 4.00% | | |
| PGUQU-3-F | 9.00% | | |

### Example 6

| | | | |
|---|---|---|---|
| CC-3-V | 41.50% | Clearing point/° C.: | 74 |
| CC-3-V1 | 9.00% | Δn (589 nm, 20° C.): | 0.1356 |
| PP-1-2V1 | 5.00% | Δε (1 kHz, 20° C.): | 5.3 |
| PGU-3-F | 11.00% | γ₁ (20° C.)/mPa · s: | 56 |
| PGP-2-3 | 4.00% | V₁₀ (20° C.)/V: | 1.91 |
| PGP-2-4 | 4.00% | | |
| PGP-2-5 | 5.00% | | |
| PGP-2-2V | 7.50% | | |
| CPGU-3-OT | 4.00% | | |
| PGUQU-3-F | 9.00% | | |

### Example 7

| | | | |
|---|---|---|---|
| CC-3-V | 41.50% | Clearing point/° C.: | 74.5 |
| CC-3-V1 | 9.00% | Δn (589 nm, 20° C.): | 0.1356 |
| PP-1-2V1 | 5.00% | Δε (1 kHz, 20° C.): | 5.3 |
| PGU-3-F | 11.00% | γ₁ (20° C.)/mPa · s: | 57 |
| PGP-2-3 | 4.00% | V₁₀ (20° C.)/V: | 1.94 |
| PGP-2-4 | 4.00% | | |
| PGP-2-5 | 5.50% | | |
| PGP-2-2V | 7.00% | | |
| CPGU-3-OT | 4.00% | | |
| PGUQU-3-F | 9.00% | | |

### Example 8

| | | | |
|---|---|---|---|
| CC-3-V | 42.00% | Clearing point/° C.: | 76 |
| CC-3-V1 | 10.00% | Δn (589 nm, 20° C.): | 0.1357 |
| PP-1-2V1 | 5.00% | Δε (1 kHz, 20° C.): | 5.2 |
| PGU-3-F | 11.00% | γ₁ (20° C.)/mPa · s: | 55 |
| PGP-1-2V | 6.00% | V₁₀ (20° C.)/V: | 1.93 |
| PGP-2-2V | 6.00% | | |
| PGP-3-2V | 8.00% | | |
| CPGU-3-OT | 3.00% | | |
| PGUQU-3-F | 9.00% | | |

### Example 9

| | | | |
|---|---|---|---|
| CC-3-V | 40.00% | Clearing point/° C.: | 75 |
| CC-3-V1 | 10.00% | Δn (589 nm, 20° C.): | 0.1378 |
| PP-1-2V1 | 5.00% | Δε (1 kHz, 20° C.): | 5.4 |
| PGU-3-F | 11.00% | γ₁ (20° C.)/mPa · s: | 57 |
| PGP-2-3 | 6.00% | V₁₀ (20° C.)/V: | 1.96 |
| PGP-2-4 | 6.00% | | |
| PGP-2-2V | 9.00% | | |
| CPGU-3-OT | 4.00% | | |
| PGUQU-3-F | 9.00% | | |

### Example 10

| | | | |
|---|---|---|---|
| APUQU-3-F | 5.00% | Clearing point/° C.: | 109.7 |
| CC-3-V | 29.50% | Δn (589 nm, 20° C.): | 0.1215 |
| CC-3-V1 | 2.00% | Δε (1 kHz, 20° C.): | 6.9 |
| CCP-3-1 | 5.00% | γ₁ (20° C.)/mPa · s: | 110 |
| CCP-3OCF3 | 5.00% | V₀ (20° C.)/V: | 1.60 |
| CCP-V-1 | 15.00% | LTS bulk (−20° C.): | |
| CCPC-33 | 2.00% | | |
| CCPC-34 | 3.00% | | |
| CPGP-5-2 | 2.00% | | |
| CPGP-5-3 | 3.00% | | |
| CPGU-3-OT | 4.50% | | |
| PGP-2-2V | 7.00% | | |
| PPGU-3-F | 1.00% | | |
| PUQU-2-F | 5.00% | | |
| PUQU-3-F | 11.00% | | |

0.04% of the following compound is added as stabilizer to the mixture from Example 10:

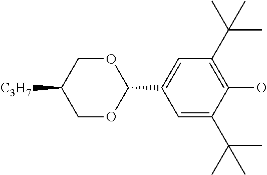

### Example 11

| | | | |
|---|---|---|---|
| CC-3-V | 47.00% | Clearing point/° C.: | 75.5 |
| PP-1-2V1 | 6.00% | Δn (589 nm, 20° C.): | 0.1334 |
| PGP-1-2V | 5.00% | Δε (1 kHz, 20° C.): | 7.8 |
| PGP-2-2V | 8.00% | γ₁ (20° C.)/mPa · s: | 59 |
| PGP-3-2V | 5.00% | V₁₀ (20° C.)/V: | 1.38 |
| PGUQU-3-F | 13.00% | | |
| CPGU-3-OT | 4.00% | | |
| APUQU-3-F | 6.50% | | |
| PUQU-3-F | 5.50% | | |

### Example 12

| | | | |
|---|---|---|---|
| CC-3-V | 42.00% | Clearing point/° C.: | 73.5 |
| CC-3-V1 | 7.00% | Δn (589 nm, 20° C.): | 0.1334 |
| PGP-1-2V | 4.00% | Δε (1 kHz, 20° C.): | 8.4 |
| PGP-2-2V | 7.00% | γ₁ (20° C.)/mPa · s: | 61 |
| PGP-3-2V | 8.00% | | |
| PGUQU-3-F | 14.00% | | |
| CPGU-3-OT | 4.00% | | |
| APUQU-3-F | 6.00% | | |
| PUQU-3-F | 8.00% | | |

### Example 13

| | | | |
|---|---|---|---|
| CC-3-V | 44.50% | Clearing point/° C.: | 76.5 |
| PP-1-2V1 | 5.50% | Δn (589 nm, 20° C.): | 0.1367 |
| PGP-1-2V | 5.00% | Δε (1 kHz, 20° C.): | 8.4 |
| PGP-2-2V | 8.00% | γ₁ (20° C.)/mPa · s: | 64 |
| PGP-3-2V | 6.00% | | |
| PGUQU-3-F | 10.00% | | |
| CPGU-3-OT | 5.00% | | |
| APUQU-3-F | 8.00% | | |
| PUQU-3-F | 8.00% | | |

### Example 14

| | | | |
|---|---|---|---|
| APUQU-2-F | 8.50% | Clearing point/° C.: | 80 |
| APUQU-3-F | 8.00% | Δn (589 nm, 20° C.): | 0.1086 |
| CC-3-V | 44.50% | Δε (1 kHz, 20° C.): | 9.7 |
| CCP-3OCF3 | 7.50% | ε_{∥} (1 kHz, 20° C.): | 13.2 |
| CCP-V-1 | 7.00% | γ₁ (20° C.)/mPa · s: | 65 |
| DPGU-4-F | 3.50% | V₀ (20° C.)/V: | 1.20 |
| PGP-2-2V | 8.00% | K₁ (20° C.)/pN: | 12.7 |
| PGUQU-4-F | 4.50% | K₃ (20° C.)/pN: | 14.0 |
| PUQU-3-F | 8.50% | | |

### Example 15

| | | | |
|---|---|---|---|
| APUQU-2-F | 10.00% | Clearing point/° C.: | 78.5 |
| APUQU-3-F | 9.50% | Δn (589 nm, 20° C.): | 0.1087 |
| CC-3-V | 41.50% | Δε (1 kHz, 20° C.): | 9.5 |
| CCP-3OCF3 | 10.00% | ε_{∥} (1 kHz, 20° C.): | 13.7 |
| CCP-V-1 | 4.50% | γ₁ (20° C.)/mPa · s: | 71 |
| DPGU-4-F | 7.50% | V₀ (20° C.)/V: | 1.23 |
| PGP-2-2V | 4.00% | K₁ (20° C.)/pN: | 12.9 |
| PGUQU-4-F | 2.00% | K₃ (20° C.)/pN: | 13.0 |
| PUQU-3-F | 3.00% | | |
| PY-3-O2 | 8.00% | | |

### Example 16

| | | | |
|---|---|---|---|
| APUQU-3-F | 4.50% | Clearing point/° C.: | 79.5 |
| CC-3-V | 46.00% | Δn (589 nm, 20° C.): | 0.1101 |
| CCP-V-1 | 4.00% | Δε (1 kHz, 20° C.): | 10.2 |
| PGP-2-2V | 5.00% | ε_{∥} (1 kHz, 20° C.): | 13.6 |
| PGUQU-3-F | 5.00% | γ₁ (20° C.)/mPa · s: | 67 |
| PGUQU-4-F | 6.00% | V₀ (20° C.)/V: | 1.15 |
| PGUQU-5-F | 5.00% | K₁ (20° C.)/pN: | 12.2 |
| PUQU-3-F | 11.50% | K₃ (20° C.)/pN: | 13.5 |
| CCP-3OCF3 | 4.00% | | |
| CCVC-3-V | 5.00% | | |
| DPGU-4-F | 4.00% | | |

### Example 17

| | | | |
|---|---|---|---|
| APUQU-2-F | 5.50% | Clearing point/° C.: | 80.5 |
| APUQU-3-F | 3.00% | Δn (589 nm, 20° C.): | 0.1017 |
| CC-3-V | 36.00% | Δε (1 kHz, 20° C.): | 9.2 |
| CC-3-V1 | 6.50% | ε_{∥} (1 kHz, 20° C.): | 12.9 |
| CCP-3OCF3 | 8.00% | γ₁ (20° C.)/mPa · s: | 53 |
| CCP-V-1 | 11.50% | V₀ (20° C.)/V: | 1.20 |
| CDUQU-3-F | 5.00% | | |
| DPGU-4-F | 5.50% | | |
| PGP-2-2V | 2.00% | | |
| PGU-2-F | 7.50% | | |
| PUQU-3-F | 9.50% | | |

0.04% of the following compound is added as stabilizer to the mixture from Example 17:

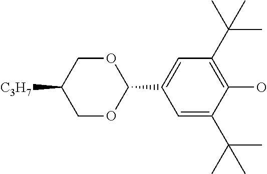

0.4% of the following compound is added as reactive mesogen to the resulting mixture:

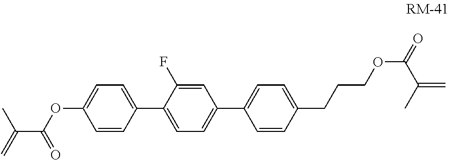 [SMILES: C=C(C)C(=O)OCCCc1ccc(-c2ccc(-c3ccc(OC(=O)C(=C)C)cc3)c(F)c2)cc1]

### Example 18

| | | | |
|---|---|---|---|
| APUQU-3-F | 6.50% | Clearing point/° C.: | 100.1 |
| CC-3-V | 28.00% | Δn (589 nm, 20° C.): | 0.1312 |
| CC-3-V1 | 7.00% | Δε (1 kHz, 20° C.): | 5.6 |
| CCP-V-1 | 15.00% | ε_{∥} (1 kHz, 20° C.): | 8.6 |
| CCP-V2-1 | 9.00% | γ₁ (20° C.)/mPa · s: | 86 |
| CPGP-5-2 | 3.00% | V₀ (20° C.)/V: | 1.80 |
| PGP-1-2V | 6.00% | K₁ (20° C.)/pN: | 16.2 |
| PGP-2-2V | 6.00% | K₃ (20° C.)/pN: | 17.7 |
| PGP-2-3 | 2.00% | | |
| PGUQU-3-F | 5.50% | | |
| PP-1-2V1 | 3.00% | | |
| PPGU-3-F | 1.00% | | |
| PUQU-3-F | 8.00% | | |

0.04% of the following compound is added as stabilizer to the mixture from Example 18:

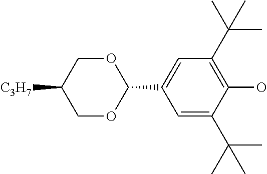

### Example 19

| | | | |
|---|---|---|---|
| CC-3-V | 26.00% | Clearing point/° C.: | 93.4 |
| CCP-V-1 | 6.50% | Δn (589 nm, 20° C.): | 0.1077 |
| CCP-3-1 | 10.00% | Δε (1 kHz, 20° C.): | 4.9 |
| CCP-3OCF3 | 7.00% | ε_{∥} (1 kHz, 20° C.): | 9.1 |
| APUQU-3-F | 7.00% | γ₁ (20° C.)/mPa · s: | 98 |
| CCQU-3-F | 10.00% | V₀ (20° C.)/V: | 1.90 |
| CCQU-5-F | 7.50% | K₁ (20° C.)/pN: | 16.0 |
| CPGU-3-OT | 5.00% | K₃ (20° C.)/pN: | 16.2 |
| PGP-1-2V | 3.00% | | |
| CCGU-3-F | 3.00% | | |
| PY-3-O2 | 15.00% | | |

### Example 20

| | | | |
|---|---|---|---|
| CC-3-V | 13.00% | Clearing point/° C.: | 99.9 |
| CPGP-5-2 | 4.00% | Δn (589 nm, 20° C.): | 0.1942 |
| CPGP-5-3 | 4.00% | Δε (1 kHz, 20° C.): | 8.9 |
| DGUQU-4-F | 2.50% | γ₁ (20° C.)/mPa · s: | 151 |
| PCH-3O1 | 10.00% | V₀ (20° C.)/V: | 1.48 |
| PGP-1-2V | 11.00% | K₁ (20° C.)/pN: | 17.5 |
| PGP-2-2V | 12.00% | K₃ (20° C.)/pN: | 19.2 |
| PGP-2-5 | 3.50% | | |
| PGP-3-2V | 10.00% | | |
| PGUQU-3-F | 6.00% | | |
| PGUQU-4-F | 7.00% | | |
| PP-1-2V1 | 7.00% | | |
| PUQU-3-F | 10.00% | | |

0.04% of the following compound is added as stabilizer to the mixture from Example 20:

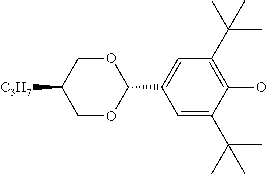

### Example 21

| | | | |
|---|---|---|---|
| CC-3-V | 14.00% | Clearing point/° C.: | 76 |
| CCH-3O1 | 8.00% | Δn (589 nm, 20° C.): | 0.1798 |
| PCH-3O1 | 10.00% | Δε (1 kHz, 20° C.): | 4.8 |
| PGP-1-2V | 9.00% | ε_{∥} (1 kHz, 20° C.): | 8.3 |
| PGP-2-2V | 16.00% | γ₁ (20° C.)/mPa · s: | 82 |
| PGP-2-3 | 6.00% | V₀ (20° C.)/V: | 1.79 |
| PGP-3-2V | 9.00% | K₁ (20° C.)/pN: | 14.2 |
| PGU-2-F | 7.00% | K₃ (20° C.)/pN: | 13.2 |
| PGUQU-3-F | 6.00% | | |
| PP-1-2V1 | 9.50% | | |
| PPGU-3-F | 0.50% | | |
| PUQU-3-F | 5.00% | | |

0.05% of the following compound is added as stabilizer to the mixture from Example 21:

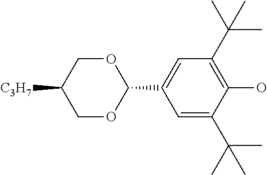

### Example 22

| | | | |
|---|---|---|---|
| APUQU-2-F | 2.50% | Clearing point/° C.: | 100.2 |
| APUQU-3-F | 4.00% | Δn (589 nm, 20° C.): | 0.1144 |
| CDUQU-3-F | 6.00% | Δε (1 kHz, 20° C.): | 4.5 |
| DGUQU-4-F | 3.00% | ε_{∥} (1 kHz, 20° C.): | 7.5 |
| CCP-3OCF3 | 3.00% | γ₁ (20° C.)/mPa · s: | 77 |
| CCP-V-1 | 15.00% | V₀ (20° C.)/V: | 2.00 |
| CCVC-3-V | 5.00% | K₁ (20° C.)/pN: | 16.4 |
| PGP-1-2V | 4.00% | K₃ (20° C.)/pN: | 18.3 |
| PGP-2-2V | 7.00% | | |
| PGP-3-2V | 5.50% | | |
| CC-3-2V1 | 2.00% | | |
| CC-3-V | 32.00% | | |
| CC-3-V1 | 6.00% | | |
| PCH-302 | 3.00% | | |
| PP-1-2V1 | 2.00% | | |

### Example 23

| | | | |
|---|---|---|---|
| APUQU-3-F | 4.00% | Clearing point/° C.: | 74.5 |
| CC-3-V | 57.95% | Δn (589 nm, 20° C.): | 0.1181 |
| CCP-V-1 | 5.00% | Δε (1 kHz, 20° C.): | 2.3 |
| PGP-1-2V | 7.50% | ε_{∥} (1 kHz, 20° C.): | 5.1 |
| PGP-2-2V | 11.00% | γ₁ (20° C.)/mPa · s: | 50 |
| PGP-3-2V | 3.00% | V₀ (20° C.)/V: | 2.48 |
| PGP-2-3 | 5.00% | K₁ (20° C.)/pN: | 13.1 |
| PGU-3-F | 3.00% | K₃ (20° C.)/pN: | 13.1 |
| PPGU-3-F | 0.50% | | |
| PUQU-3-F | 3.00% | | |
| CDU-3-F | 0.05% | | |

0.05% of the following compound is added as stabilizer to the mixture from Example 23:

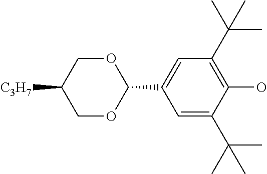

### Example 24

| | | | |
|---|---|---|---|
| CC-3-V | 28.00% | Clearing point/° C.: | 79.5 |
| PUQU-3-F | 10.00% | Δn (589 nm, 20° C.): | 0.1153 |
| PGU-3-F | 5.50% | Δε (1 kHz, 20° C.): | 13.8 |
| CCGU-3-F | 5.00% | ε_{∥} (1 kHz, 20° C.): | 17.7 |
| APUQU-2-F | 3.50% | γ₁ (20° C.)/mPa · s: | 95 |
| APUQU-3-F | 12.50% | V₀ (20° C.)/V: | 0.96 |
| PGUQU-3-F | 2.00% | K₁ (20° C.)/pN: | 11.5 |
| BCH-3F.F.F | 10.00% | K₃ (20° C.)/pN: | 12.3 |
| CCQU-3-F | 12.00% | | |
| CCP-V-1 | 7.50% | | |
| PGP-2-2V | 4.00% | | |

0.05% of the following compound is added as stabilizer to the mixture from Example 24:

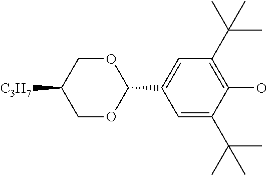

Without further elaboration, it is believed that one skilled in the art can, using the preceding description, utilize the present invention to its fullest extent. The preceding preferred specific embodiments and examples are, therefore, to be construed as merely illustrative, and not limitative of the remainder of the disclosure in any way whatsoever.

From the foregoing description, one skilled in the art can easily ascertain the essential characteristics of this invention and, without departing from the spirit and scope thereof, can make various changes and modifications of the invention to adapt it to various usages and conditions.

The entire disclosures of all applications, patents and publications, cited herein and of corresponding German Application No. 102015010197.8, filed Aug. 7, 2015, are incorporated by reference herein.

1. A liquid-crystalline medium comprising:
one or more compounds of the formula 1 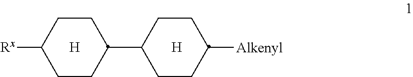
and one or more compounds of the formula 2 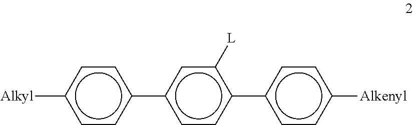
and one or more compounds selected from formulae 3, 4 and 5 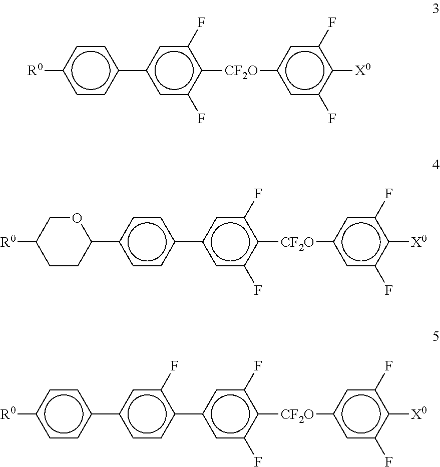
and one or more compounds selected from formulae 6 and 7 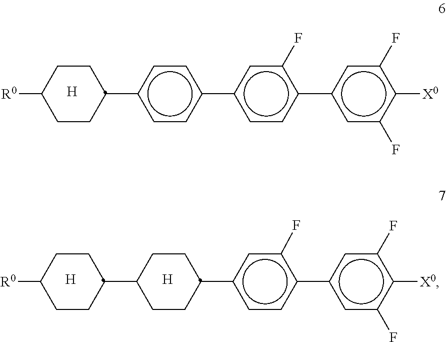
in which the individual radicals are the same or different at each instance and are each independently defined as follows:
“Alkenyl” is alkenyl having 2 to 6 carbon atoms,
R^{x} is alkyl having 1 to 6 carbon atoms or alkenyl having 2 to 6 carbon atoms,
“Alkyl” is alkyl having 1 to 6 carbon atoms,
L is H or F,
R⁰ is unsubstituted or halogenated alkyl or alkoxy having 1 to 15 carbon atoms, where one or more CH₂ groups in these radicals may each independently also be replaced by —C≡C—, —CF₂O—, —CH═CH—, 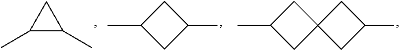
—O—, —CO—O— or —O—CO—, such that no oxygen atoms are bonded directly to one another, and
X⁰ is F, Cl, halogenated alkyl, halogenated alkoxy, halogenated alkenyl or halogenated alkenyloxy each having up to 6 carbon atoms.

2. The liquid-crystalline medium according to claim 1, wherein said one or more compounds of the formula 1 are selected from the following formulae: 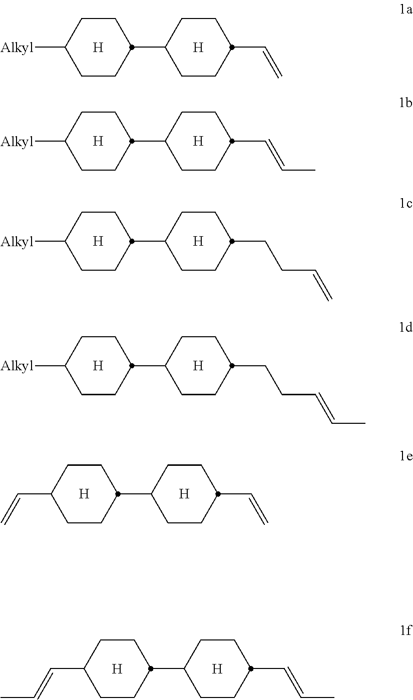
in which “Alkyl” is alkyl having 1 to 6 carbon atoms.

3. The liquid-crystalline medium according to claim 1, wherein said one or more compounds of the formula 2 are selected from the following formulae:

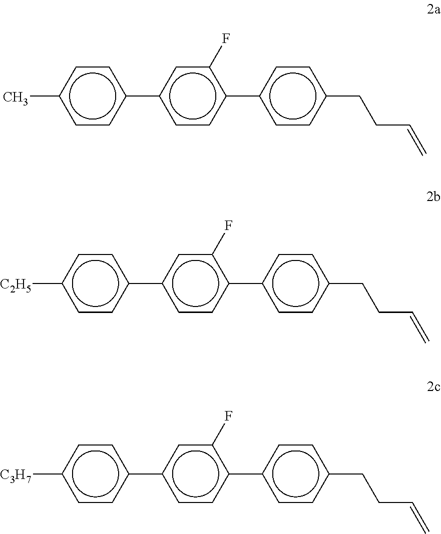

4. The liquid-crystalline medium according to claim 1, wherein said one or more compounds of the formula 3 are selected from the following formulae:

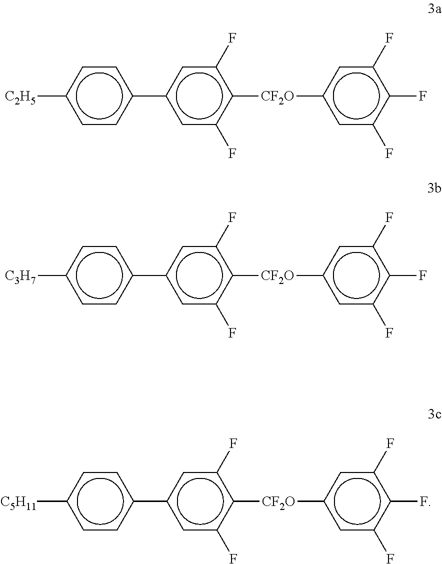

5. The liquid-crystalline medium according to claim 1, wherein said one or more compounds of the formula 4 are selected from the following formulae:

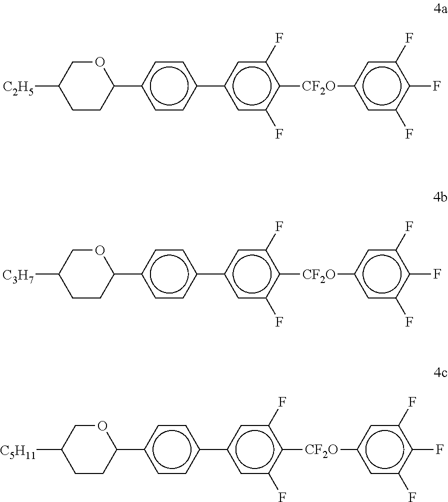

6. The liquid-crystalline medium according to claim 1, wherein said one or more compounds of the formula 5 are selected from the following formulae:

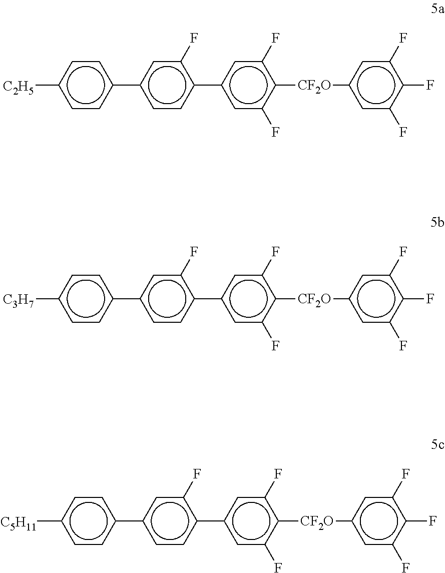

7. The liquid-crystalline medium according to claim 1, wherein said one or more compounds of the formula 6 are selected from the following formulae:

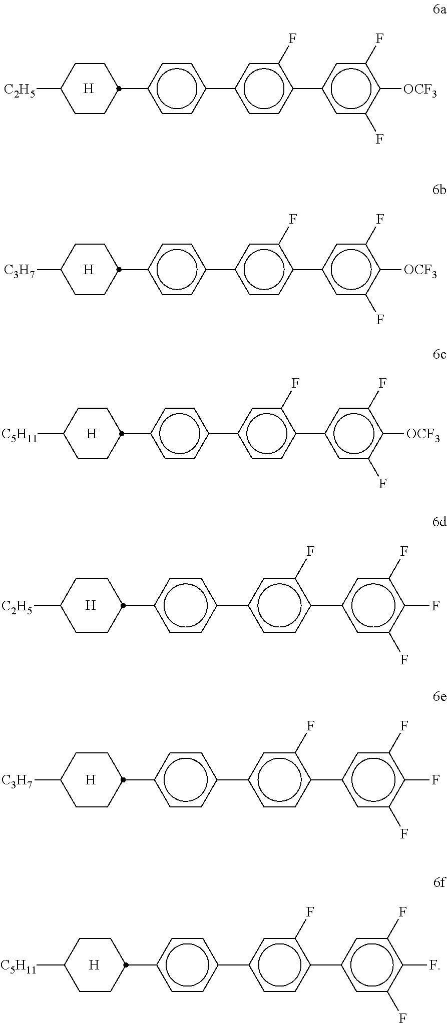

8. The liquid-crystalline medium according to claim 1, wherein said one or more compounds of the formula 7 are selected from the following formulae:

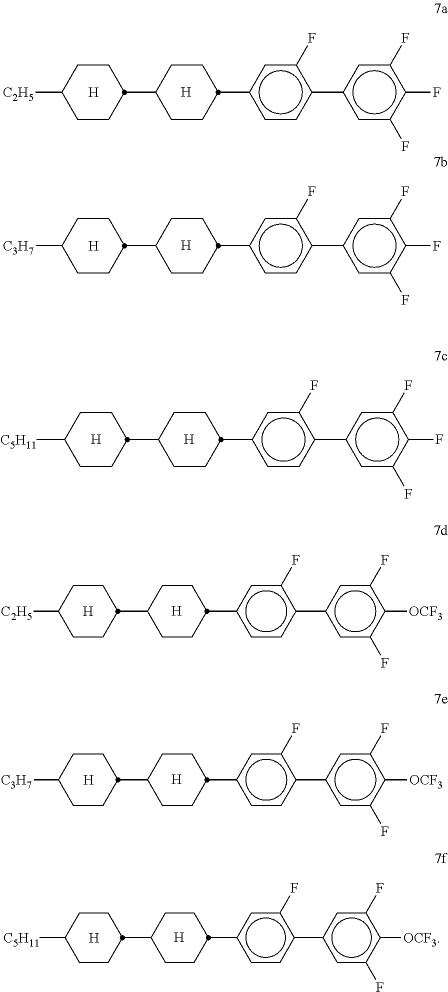

9. The liquid-crystalline medium according to claim 1, further comprising, other than compounds of formulae 1 to 7, one or more compounds selected from formulae II and/or III: 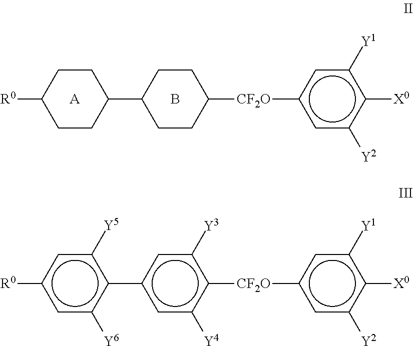
wherein
R⁰ is unsubstituted or halogenated alkyl or alkoxy having 1 to 15 carbon atoms, where one or more CH₂ groups in these radicals may each independently also be replaced by —C≡C—, —CF₂O—, —CH═CH—, 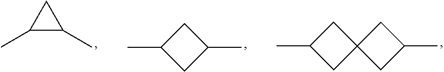
—O—, —CO—O— or —O—CO—, such that no oxygen atoms are bonded directly to one another,
X⁰ is F, Cl, halogenated alkyl, halogenated alkoxy, halogenated alkenyl or halogenated alkenyloxy each having up to 6 carbon atoms,
Y¹ to Y⁶ are each independently H or F, and 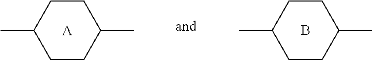
are each independently 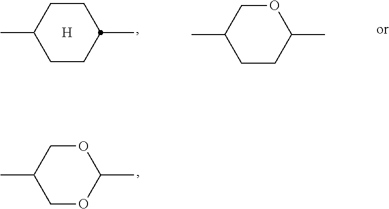
with exclusion of the compounds of formula 3 from the compounds of the formula III.

10. The liquid-crystalline medium according to claim 1, further comprising, other than the formulae 1 to 7, one or more compounds selected from formulae IV to VIII 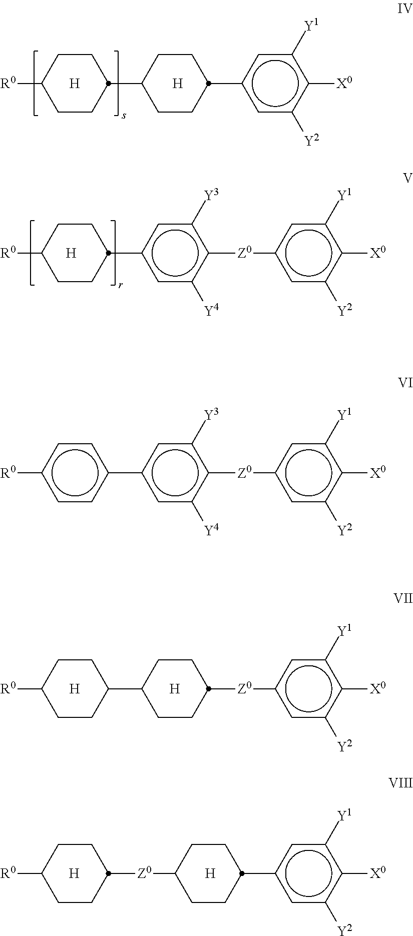
wherein
R⁰ is unsubstituted or halogenated alkyl or alkoxy having 1 to 15 carbon atoms, where one or more CH₂ groups in these radicals may each independently also be replaced by —C≡C—, —CF₂O—, —CH═CH—, 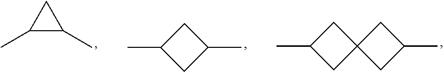
—O—, —CO—O— or —O—CO—, such that no oxygen atoms are bonded directly to one another,
X⁰ is F, Cl, halogenated alkyl, halogenated alkoxy, halogenated alkenyl or halogenated alkenyloxy each having up to 6 carbon atoms, and
Y¹ to Y⁴ are each independently H or F,
Z⁰ is —C₂H₄—, —(CH₂)₄—, —CH═CH—, —CF═CF—, —C₂F₄—, —CH₂CF₂—, —CF₂CH₂—, —CH₂O—, —OCH₂—, —COO— or —OCF₂—, and in formulae V and VI a single bond as well, and in formulae V and VIII —CF₂O— as well,
is 0 or 1, and
is 0 or 1.

11. The liquid-crystalline medium according to claim 1, further comprising, other than the formulae 1 to 7, one or more compounds selected from formulae IX to XII 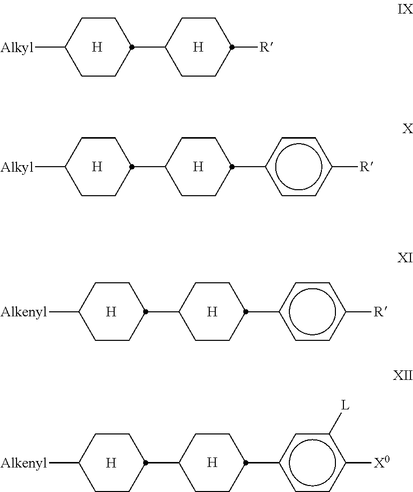
wherein
X⁰ is F, Cl, halogenated alkyl, halogenated alkoxy, halogenated alkenyl or halogenated alkenyloxy each having up to 6 carbon atoms,
is H or F,
“Alkyl” is alkyl having 1 to 6 carbon atoms,
R′ is alkyl having 1 to 6 carbon atoms, alkoxy having 1 to 6 carbon atoms or alkenyl having 2 to 6 carbon atoms, and
“Alkenyl” is alkenyl having 1 to 6 carbon atoms.

12. The liquid-crystalline medium according to claim 1, further comprising one or more compounds of formula XIII 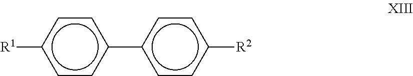
wherein
R¹ and R² are each independently n-alkyl, alkoxy, oxaalkyl, fluoroalkyl or alkenyl, each having up to 6 carbon atoms.

13. The liquid-crystalline medium according to claim 1, further comprising, other than the formulae 1 to 7, one or more compounds selected from formulae XV and XVI 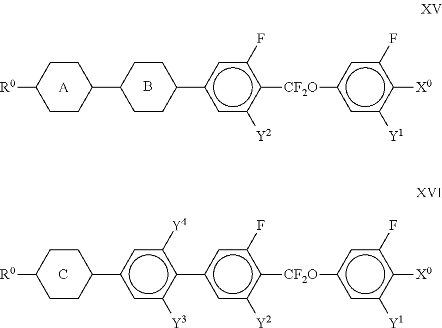
wherein
R⁰ is unsubstituted or halogenated alkyl or alkoxy having 1 to 15 carbon atoms, where one or more CH₂ groups in these radicals may each independently also be replaced by —C≡C—, —CF₂O—, —CH═CH—, 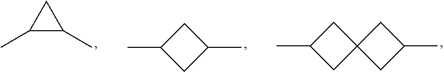
—O—, —CO—O— or —O—CO—, such that no oxygen atoms are bonded directly to one another,
X⁰ is F, Cl, halogenated alkyl, halogenated alkoxy, halogenated alkenyl or halogenated alkenyloxy each having up to 6 carbon atoms,
Y¹ to Y⁴ are each independently H or F, 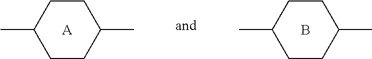
are each independently 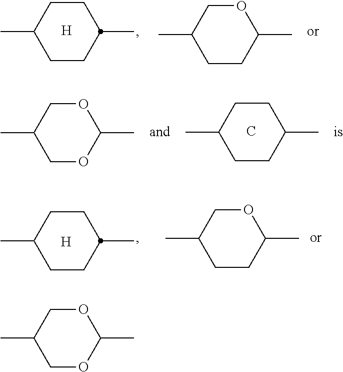
with exclusion of the compounds of formula 4 from the compounds of formula XVI.

14. The liquid-crystalline medium according to claim 1, further comprising, other than the formulae 1 to 7, one or more compounds of formula XVII 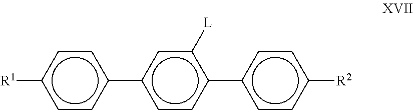
wherein
R¹ and R² are each independently n-alkyl, alkoxy, oxaalkyl, fluoroalkyl or alkenyl each having up to 6 carbon atoms, and
L is H or F.

15. The liquid-crystalline medium according to claim 1, further comprising, other than the formulae 1 to 7, one or more compounds of the following formulae: 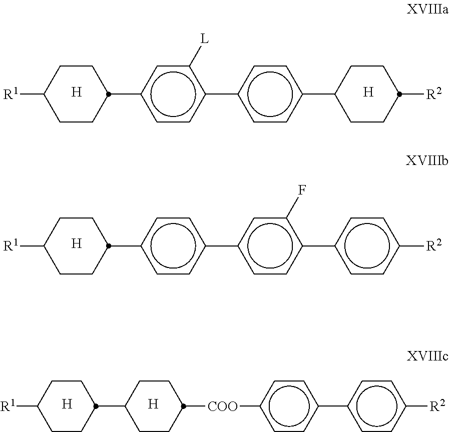
in which
R¹ and R² are each independently n-alkyl, alkoxy, oxaalkyl, fluoroalkyl or alkenyl each having up to 6 carbon atoms, and
L is H or F.

16. The liquid-crystalline medium according to claim 1, further comprising, other than the formulae 1 to 7, one or more compounds selected from the compounds of formulae XIX, XX, XXI, XXII, XXIII and XIV 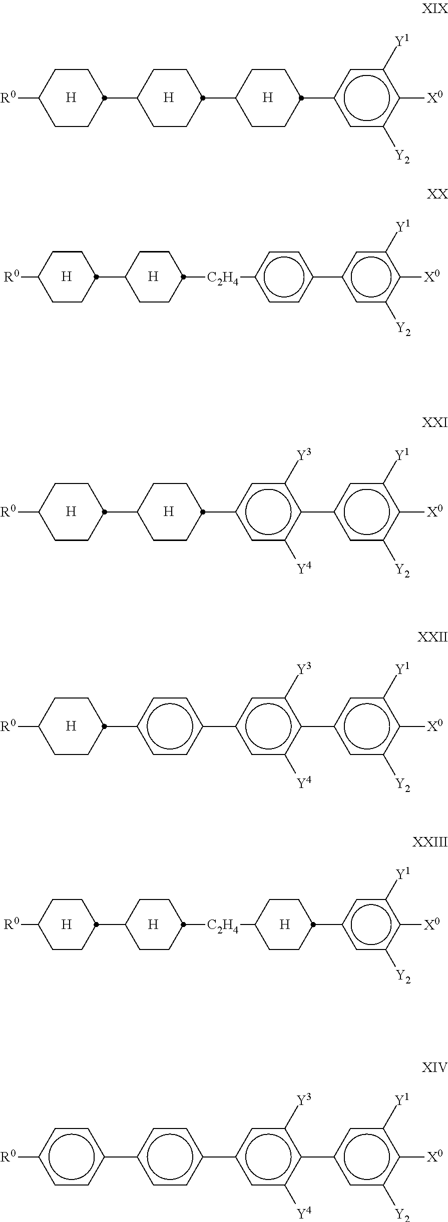
wherein
R⁰ is unsubstituted or halogenated alkyl or alkoxy having 1 to 15 carbon atoms, where one or more CH₂ groups in these radicals may each independently also be replaced by —C≡C—, —CF₂O—, —CH═CH—, 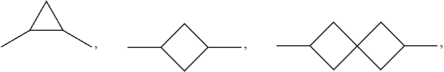
—O—, —CO—O— or —O—CO—, such that no oxygen atoms are bonded directly to one another,
X⁰ is F, Cl, halogenated alkyl, halogenated alkoxy, halogenated alkenyl or halogenated alkenyloxy each having up to 6 carbon atoms, and
Y¹ to Y⁴ are each independently H or F,
with exclusion of the compounds of formulae 6 and 7 from the compounds of formulae XXI and XXII.

17. The liquid-crystalline medium according to claim 1, wherein said medium contains:
20% to 65% by weight of one or more compounds of formula 1,
2% to 15% by weight of one or more compounds of the formula 2,
5% to 30% by weight of one or more compounds selected from formulae 3, 4 and 5, and
2% to 20% by weight of one or more compounds selected from formulae 6 and 7.

18. The liquid-crystalline medium according to claim 1, wherein said medium contains one or more compounds of each of formula 1, formula 2, and formula 3, and one or more compounds selected from formulae 6 and 7.

19. The liquid-crystalline medium according to claim 1, further comprising one or more additive(s) selected from UV stabilizers, dopants and antioxidants.

20. The liquid-crystalline medium according to claim 1, further comprising one or more polymerizable compounds.

21. A process for producing a liquid-crystalline medium according to claim 1, comprising:
mixing one or more compounds of formulae 1 to 7 with further mesogenic compounds and optionally with one or more additives and/or at least one polymerizable compound.

22. A method of generating an electrooptical effect comprising applying a voltage across a liquid-crystalline medium according to claim 1.

23. A shutter glass for 3D applications, or in TN, PS-TN, STN, ECB, OCB, IPS, PS-IPS, FFS, PS-FFS or positive-VA displays, comprising a liquid-crystalline medium according to claim 1.

24. An electrooptical liquid-crystal display comprising a liquid-crystalline medium, wherein said medium is a medium according to claim 1.

25. An electrooptical liquid-crystal display according to claim 24, wherein said display is a TN, PS-TN, STN, ECB, OCB, FFS, PS-FFS, or positive-VA display.
